(19) United States
(12) Patent Application Publication
(10) Pub. No.: US 2011/0208950 A1
(43) Pub. Date: Aug. 25, 2011

(54) PROCESSES, CIRCUITS, DEVICES, AND SYSTEMS FOR SCOREBOARD AND OTHER PROCESSOR IMPROVEMENTS

(75) Inventors: Thang Minh Tran, Austin, TX (US); Raul A. Garibay, JR., Austin, TX (US); James Nolan Hardage, Austin, TX (US)

(73) Assignee: TEXAS INSTRUMENTS INCORPORATED, Dallas, TX (US)

(21) Appl. No.: 13/053,000

(22) Filed: Mar. 21, 2011

Related U.S. Application Data
(62) Division of application No. 11/133,870, filed on May 18, 2005, now abandoned.
(60) Provisional application No. 60/611,437, filed on Sep. 20, 2004.
(60) Provisional application No. 60/605,838, filed on Aug. 30, 2004.

(51) Int. Cl. G06F 9/30

(52) U.S. Cl. 712/214; 712/E09.016

(57) ABSTRACT

A method of instruction issue (3200) in a microprocessor (1100, 1400, or 1500) with execution pipestages (E1, E2, etc.) and that executes a producer instruction Ip and issues a candidate instruction I0 (3245) having a source operand dependency on a destination operand of instruction Ip. The method includes issuing the candidate instruction I0 as a function (1720, 1950, 1958, 3235) of a pipestage EN(I0) of first need by the candidate instruction for the source operand, a pipestage EA(Ip) of first availability of the destination operand from the producer instruction, and the one execution pipestage E(Ip) currently associated with the producer instruction. A method of data forwarding (3300) in a microprocessor (1100, 1400, or 1500) having a pipeline (1640) having pipestages (E1, E2, etc.), wherein the method includes scoreboarding information E(Ip) (1710, 2220) to represent a changing pipestage position for data from a producer instruction Ip, and selectively forwarding (2310, 3360) the data from the pipestage having the represented pipestage position E(Ip), based on the information (1710), to a receiving pipestage (1682, E1) for a dependent instruction. Wireless communications devices (1010, 1010′, 1040, 1050, 1060, 1080), systems, circuits, devices, scoreboards (1700.N), processes and methods of operation, processes and articles of manufacture (FIGS. 13-16), are also disclosed.

### CROSS-REFERENCE TO RELATED APPLICATIONS

This application is related to provisional U.S. Patent Application No. 60/605,838, filed Aug. 30, 2004, titled “Operand Scoreboard Organization For High Frequency Operation,” and to provisional U.S. Patent Application No. 60/611,437, filed Sep. 20, 2004, also titled “Operand Scoreboard Organization For High Frequency Operation,” Priority under 35 U.S.C. 119(e)(1) is hereby claimed for both said provisional U.S. patent applications.

### STATEMENT REGARDING FEDERALLY SPONSORED RESEARCH OR DEVELOPMENT

Not applicable.

### BACKGROUND OF THE INVENTION

This invention is in the field of information and communications, and is more specifically directed to improved processes, circuits, devices, and systems for information and communication processing, and processes of operating and making them. Without limitation, the background is further described in connection with wireless communications processing.

Wireless communications, of many types, have gained increasing popularity in recent years. The mobile wireless (or “cellular”) telephone has become ubiquitous around the world. Mobile telephony has recently begun to communicate video and digital data, in addition to voice. Wireless devices, for communicating computer data over a wide area network, using mobile wireless telephone channels and techniques are also available.

Wireless data communications in wireless local area networks (WLAN), such as that operating according to the well-known IEEE 802.11 standard, has become especially popular in a wide range of installations, ranging from home networks to commercial establishments. Short-range wireless data communication according to the “Bluetooth” technology permits computer peripherals to communicate with a personal computer or workstation within the same room.

Improved security of retail and other business commercial transactions in electronic commerce and the security of communications wherever personal and/or commercial privacy is desirable. Security is important in both wireline and wireless communications. Added features and security add further processing tasks to the communications system. These potentially mean added software and hardware in systems where cost and power dissipation are already important concerns.

Improved processors, such as RISC (Reduced Instruction Set Computing) processors and digital signal processing (DSP) chips and/or other integrated circuit devices are essential to these systems and applications. Reducing the cost of manufacture, increasing the efficiency of executing more instructions per cycle, and addressing power dissipation without compromising performance are important goals in RISC processors, DSPs, integrated circuits generally and system-on-a-chip (SOC) design. These goals become even more important in hand held/mobile applications where small size is so important, to control the cost and the power consumed.

Microprocessors execute some set of instructions. Circuitry is provided to regulate the instruction issuance process. Some unit, typically called the instruction decode or instruction dispatch unit, should somehow monitor the instructions already executing and determine whether to send another instruction to be executed. This process is called instruction dispatch or instruction issue.

These instructions are preferably sequenced correctly to provide consistent or meaningful results. That is, an instruction that uses a certain operand should be deferred or delayed from issue for execution if that operand will not be available when the instruction will need to use the operand or when the instruction expects the operand to be available.

As microprocessor clock frequency has increased, execution pipelines have lengthened (deepened), and multiple instructions are issued to multiple pipelines. In consequence, the result of these considerations is thereby increasing the complexity of regulating the issuance process in an efficient manner.

Furthermore, some issued instructions in an execution pipeline need data from at least one other instruction in the execution pipeline even before the other instruction has reached the end of the pipeline. This process is called “data forwarding.”

Among other problems, it would be highly desirable to solve problems of how to efficiently and economically determine whether to issue an instruction in the first place. Also, solutions to problems of how to forward data to an instruction in the pipeline from another instruction in the pipeline in an optimized manner would be highly desirable. All these problems need to be solved with respect to CPI (cycles per instruction) efficiency and operating frequency in superscalar, deeply pipelined microprocessors and other microprocessors.

### SUMMARY OF THE INVENTION

Generally a form of the invention involves a scoreboard for issue control of a candidate instruction for issue to a pipeline with pipestages, and for use when a producer instruction is in the pipeline and the candidate instruction has a consumer operand dependent on the producer instruction. The scoreboard includes counting bit register circuitry operable for representing a successive count from bits representing a pipestage of availability of data from the producer instruction, and instruction issue logic circuitry responsive to the successive count, as a function of a pipestage of first need of the consumer operand of the candidate instruction, to generate an instruction issue signal.

Generally, another form of the invention involves a microprocessor for executing a producer instruction Ip and issuing a candidate instruction I0. The microprocessor includes a register file including a plurality of register file registers, an execution pipeline including a plurality of execution pipestages, the producer instruction Ip associated with one execution pipestage at a time and the producer instruction Ip having a destination operand identified to one of the register file registers, and an instruction issue circuit operable, when the candidate instruction has a source operand identified to the same one of the register file registers, to issue or not issue the candidate instruction I0 as a function of a pipestage EN(I0) of first need by the candidate instruction for the source operand, a pipestage EA(Ip) of first availability of the destination operand from the producer instruction, and the one execution pipestage E(Ip) currently associated with the producer instruction.

Generally, a further form of the invention involves a microprocessor including a pipeline having pipestages and operable to make data available in a said pipestage from executing a producer instruction, the pipeline further operable to execute a dependent instruction in a receiving pipestage, the dependent instruction being dependent on the data from the producer instruction, scoreboard circuitry having at least one register with register elements for holding information to represent a changing pipestage position for the producer instruction, and forwarding control circuitry coupled to said register to selectively forward the data available in the said pipestage to the receiving pipestage.

Generally, an additional method form of the invention for operating an integrated circuit involves data forwarding in a microprocessor having a pipeline having pipestages. The method includes scoreboarding of information to represent a changing pipestage position for data from a producer instruction, and selectively forwarding the data from the pipestage having the represented pipestage position, based on the information, to a receiving pipestage for a dependent instruction.

Generally, another form of the invention involves a processor including an issue logic circuit, a scoreboard circuit coupled to the issue logic circuit and having a first portion and a second portion of the scoreboard circuit placed substantially symmetrically opposite each other so that the issue logic circuit lies between said first portion and said second portion, and an instruction queue circuit having a multiplexer coupled to the scoreboard circuit, the multiplexer placed substantially next to the issue logic circuitry, the issue logic circuit coupled to drive the multiplexer.

Other forms of the invention involve wireless communications devices, systems, circuits, devices, scoreboards, processes and methods of operation, processes of manufacture, and articles of manufacture, as disclosed and claimed.

### BRIEF DESCRIPTION OF THE DRAWINGS

FIG. 1 is a pictorial diagram of a communications system including a cellular base station, two cellular telephone handsets, a WLAN AP (wireless local area network access point), a WLAN gateway, a personal computer (PC), a WLAN station on the PC, and any one, some or all of the foregoing improved according to the invention.

FIG. 2 is a block diagram of an inventive integrated circuit chip with any subset or all of the chip circuits for use in the blocks of the communications system of FIG. 1.

FIG. 3 is a block diagram of an improved processor of the invention for use in the integrated circuits of FIG. 2 and includes a pipeline diagram of inventive circuitry and sequence of operations in FIG. 3, with upper rows from a scoreboard of FIG. 4.

FIG. 4 is a diagram of bits in a pair of rows of a unit of an inventive scoreboard, replicated with the bits updated in a next-subsequent clock cycle.

FIG. 5 is a block diagram of one inventive circuitry embodiment for the scoreboard of FIG. 4 showing rows of circuits for ResultValid (lower row), Current Position (upper row), and Type row (non-shifting part of upper row) of the scoreboard of FIG. 4.

FIG. 6 is a block diagram of inventive circuitry for an instruction issue loop including an issue logic scoreboard (lower row in FIG. 4), an issue queue and muxing.

FIGS. 7A, 7B-1, 7B-2 and 7C are four portions of one composite, partially-block, partially-schematic diagram of inventive circuitry for a go/nogo issue (lower row) part of the scoreboard of FIG. 4 and instruction issue logic controlled by the lower row part of the scoreboard.

FIG. 8 is a schematic diagram of one block out of eight blocks of an inventive intradependency and forwarding control circuit for use with the scoreboard of FIG. 4 and FIGS. 7A and 7B.

FIGS. 9A, 9B, 10, 11, 12A and 12B together form a composite partially-block, partially-schematic diagram of inventive data forwarding circuitry including and controlled by the upper row of the scoreboard of FIG. 4.

FIGS. 9A and 9B together form a partially-block, partially-schematic diagram of inventive circuitry for the upper row of the scoreboard of FIG. 4 and its writing and reading logic and multiplexers.

FIG. 10 is a partially-block, partially-schematic diagram of inventive data forwarding multiplexers for coupling various pipestages in pipelines as controlled by the upper row of the scoreboard of FIGS. 4, 9A and 9B.

FIG. 11 is a block diagram of inventive circuitry for pipelining entries from the upper row of the scoreboard of FIGS. 4 and 9A and 9B.

FIGS. 12A and 12B together form a partially-block, partially-schematic diagram of inventive data forwarding circuitry in an execution pipeline having data forwarding controlled by the upper row of the scoreboard of FIGS. 4, 9A, 9B, 10, and 11.

FIG. 13 is a partially-block, partially schematic, partially physical diagram of a loop of circuitry in high speed scoreboard (lower row) issue logic in FIGS. 6, 7A and 7B.

FIG. 14 is a partially-block, mostly-schematic, partially-physical diagram of circuit elements in the loop of inventive circuitry in the high speed scoreboard (lower row) issue logic in FIG. 13, together with a dotted inset box showing an example of some alternative elements.

FIG. 15 is a partially-block, mostly-physical layout diagram of an inventive layout of circuitry for the instruction decode pending queue shift loop and high speed scoreboard (lower row) issue logic of FIGS. 6, 7A and 7B, with arrows forming a loop corresponding to the issue loop of FIGS. 6, 13 and 14.

FIG. 16 is a partially-block, partially-physical diagram of magnified inventive layout in FIG. 15.

FIG. 17 is a process diagram of inventive instruction issue control.

FIG. 18 is a process diagram of inventive data forwarding.

Corresponding numerals ordinarily identify corresponding parts in the various Figures of the drawing except where the context indicates otherwise. A Figure number without a suffix identifies the figures collectively that have suffixes to that Figure number. A circuit element numeral in a Figure without suffixes, collectively identifies all circuit elements having suffixes to that same numeral. When “x” or “i” or “y” is used in place of an index, it stands for any one value or letter which the index can have.

### DETAILED DESCRIPTION OF EMBODIMENTS

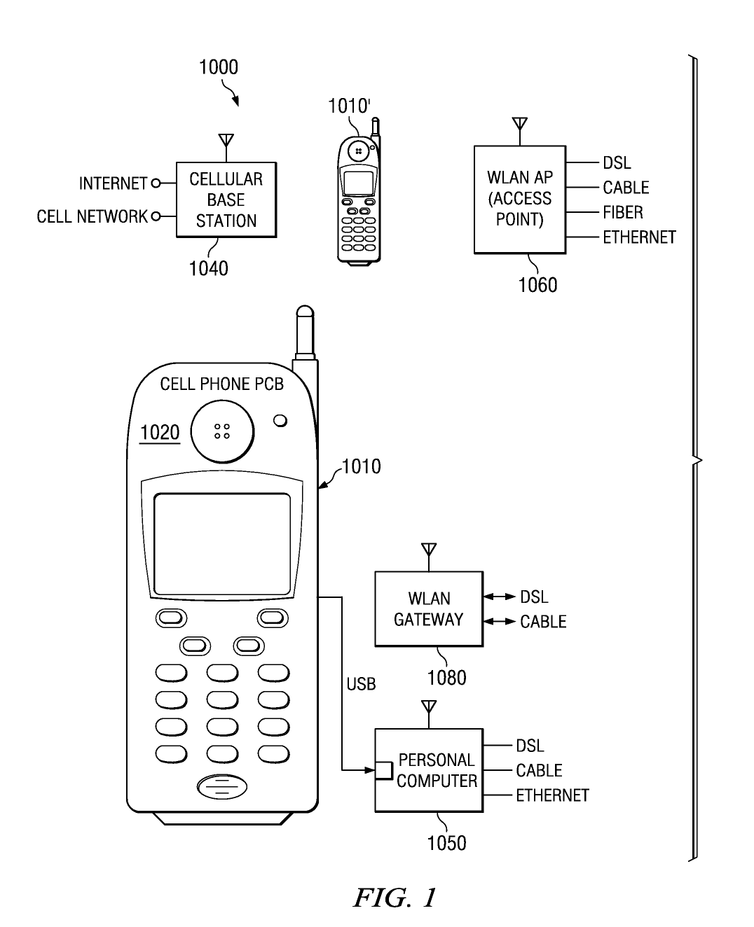

In FIG. 1, an improved communications system 1000 has system blocks with increased metrics of features per watt of power dissipation, cycles per watt, features per unit cost of manufacture, and greater throughput of instructions per cycle, among other advantages.

Any or all of the system blocks, such as cellular mobile telephone and data handsets 1010 and 1010′, a cellular (telephony and data) base station 1040, a WLAN AP (wireless local area network access point, IEEE 802.11 or otherwise) 1060, a Voice WLAN gateway 1080 with user voice over packet telephone, and a voice enabled personal computer (PC) 1050 with another user voice over packet telephone, communicate with each other in communications system 1000. Each of the system blocks 1010, 1010′, 1040, 1050, 1060, 1080 are provided with one or more PHY physical layer blocks and interfaces as selected by the skilled worker in various products, for DSL (digital subscriber line broadband over twisted pair copper infrastructure), cable (DOCSIS and other forms of coaxial cable broadband communications), premises power wiring, fiber (fiber optic cable to premises), and Ethernet wideband network. Cellular base station 1040 two-way communicates with the handsets 1010, 1010′, with the Internet, with cellular communications networks and with PSTN (public switched telephone network).

In this way, advanced networking capability for services, software, and content, such as cellular telephony and data, audio, music, voice, video, e-mail, gaming, security, e-commerce, file transfer and other data services, internet, world wide web browsing, TCP/IP (transmission control protocol/Internet protocol), voice over packet and voice over Internet protocol (VoP/VoIP), and other services accommodates and provides security for secure utilization and entertainment appropriate to the just-listed and other particular applications, while recognizing market demand for different levels of security.

The embodiments, applications and system blocks disclosed herein are suitably implemented in fixed, portable, mobile, automotive, seaborne, and airborne, communications, control, set top box, and other apparatus. The personal computer (PC) is suitably implemented in any form factor such as desktop, laptop, palmtop, organizer, mobile phone handset, PDA personal digital assistant, internet appliance, wearable computer, personal area network, or other type.

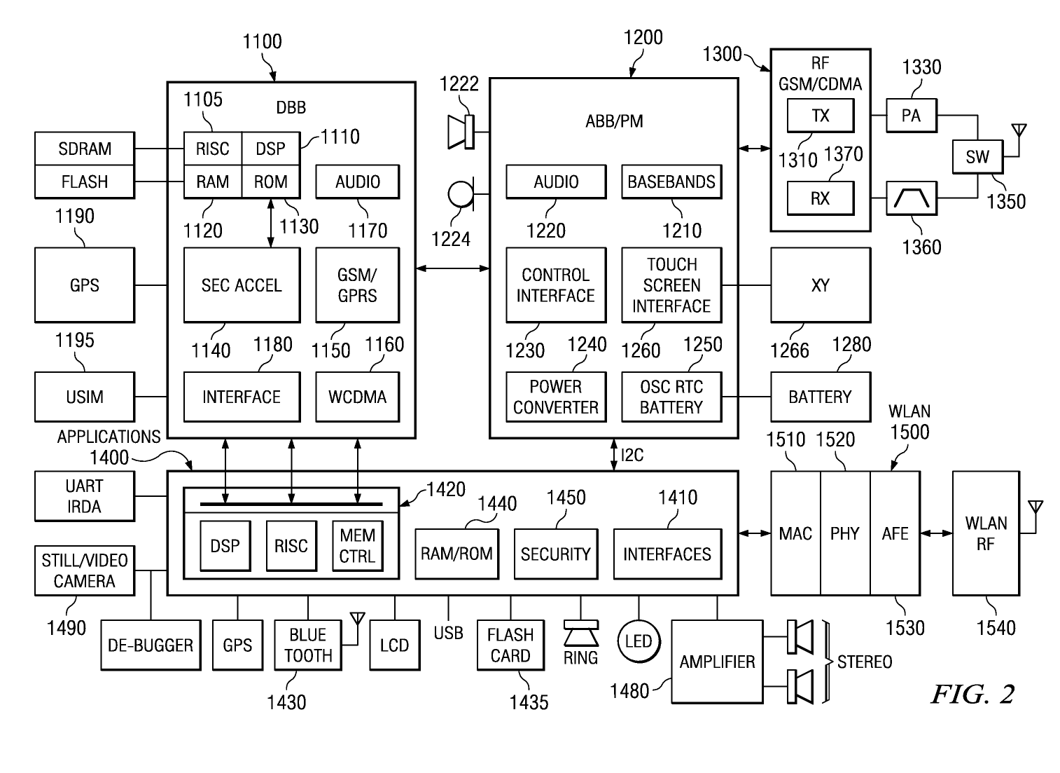

For example, handset 1010 is improved and remains interoperable and able to communicate with all other similarly improved and unimproved system blocks of communications system 1000. On a cell phone printed circuit board (PCB) 1020 in handset 1010, FIGS. 1 and 2 show a processor integrated circuit and a serial interface such as a USB interface connected by a USB line to the personal computer 1050. Reception of software, intercommunication and updating of information are provided between the personal computer 1050 (or other originating sources external to the handset 1010) and the handset 1010. Such intercommunication and updating also occur automatically and/or on request via WLAN, Bluetooth, or other wireless circuitry.

FIG. 2 illustrates inventive integrated circuit chips including chips 1100, 1200, 1300, 1400, 1500 for use in the blocks of the communications system 1000 of FIG. 1. The skilled worker uses and adapts the integrated circuits to the particular parts of the communications system 1000 as appropriate to the functions intended. For conciseness of description, the integrated circuits are described with particular reference to use of all of them in the cellular telephone handsets 1010 and 1010′ by way of example.

It is contemplated that the skilled worker uses each of the integrated circuits shown in FIG. 2, or such selection from the complement of blocks therein provided into appropriate other integrated circuit chips, in a manner optimally combined or partitioned between the chips, to the extent needed by any of the applications supported by the cellular telephone base station 1040, personal computer(s) 1050 equipped with WLAN, WLAN access point 1060 and Voice WLAN gateway 1080, as well as radios and televisions, fixed and portable entertainment units, routers, pagers, personal digital assistants (PDA), organizers, scanners, faxes, copiers, household appliances, office appliances, combinations thereof, and other application products now known or hereafter devised in which there is desired increased, partitioned or selectively determinable advantages next described.

In FIG. 2, an integrated circuit 1100 includes a digital baseband (DBB) block 1110 that has a RISC processor (such as MIPS core, ARM processor, or other suitable processor) 1105, a digital signal processor (DSP) 1110, communications software and security software for any such processor or core, security accelerators 1140, and a memory controller. The memory controller interfaces the RISC and the DSP to Flash memory and SDRAM (synchronous dynamic random access memory). The memories are improved by any one or more of the processes herein. On chip RAM 1120 and on-chip ROM 1130 also are accessible to the processors 1105 and 1110 for providing sequences of software instructions and data thereto.

Digital circuitry 1150 on integrated circuit 1100 supports and provides wireless interfaces for any one or more of GSM, GPRS, EDGE, UMTS, and OFDMA/MIMO (Global System for Mobile communications, General Packet Radio Service, Enhanced Data Rates for Global Evolution, Universal Mobile Telecommunications System, Orthogonal Frequency Division Multiple Access and Multiple Input Multiple Output Antennas) wireless, with or without high speed digital data service, via the analog baseband chip 1200 and GSM transmit/receive chip 1300. Digital circuitry 1150 includes ciphering processor CRYPT for GSM ciphering and/or other encryption/decryption purposes. Blocks TPU (Time Processing Unit real-time sequencer), TSP (Time Serial Port), GEA (GPRS Encryption Algorithm block for ciphering at LLC logical link layer), RIF (Radio Interface), and SPI (Serial Port Interface) are included in digital circuitry 1150.

Digital circuitry 1160 provides codec for CDMA (Code Division Multiple Access), CDMA2000, and/or WCDMA (wideband CDMA) wireless with or without an HSDPA/HSUPA (High Speed Downlink Packet Access, High Speed Uplink Packet Access) (or 1xEV-DV, 1xEV-DO or 3xEV-DV) data feature via the analog baseband chip 1200 and the CDMA chip 1300. Digital circuitry 1160 includes blocks MRC (maximal ratio combiner for multipath symbol combining), ENC (encryption/decryption), RX (downlink receive channel decoding, de-interleaving, viterbi decoding and turbo decoding) and TX (uplink transmit convolutional encoding, turbo encoding, interleaving and channelizing). Block ENC has blocks for uplink and downlink supporting confidentiality processes of WCDMA.

Audio/voice block 1170 supports audio and voice functions and interfacing. Applications interface block 1180 couples the digital baseband 1110 to the applications processor 1400. Also, a serial interface in block 1180 interfaces from parallel digital busses on chip 1100 to USB (Universal Serial Bus) of a PC (personal computer) 1050. The serial interface includes UARTs (universal asynchronous receiver/transmitter circuit) for performing the conversion of data between parallel and serial lines. Chip 1100 is coupled to location-determining circuitry 1190 for GPS (Global Positioning System). Chip 1100 is also coupled to a USIM (UMTS Subscriber Identity Module) 1195 or other SIM for user insertion of an identifying plastic card, or other storage element, or for sensing biometric information to identify the user and activate features.

In FIG. 2, a mixed-signal integrated circuit 1200 includes an analog baseband (ABB) block 1210 for GSM/GPRS/EDGE/UMTS which includes SPI (Serial Port Interface), digital-to-analog/analog-to-digital conversion DAC/ADC block, and RF (radio frequency) Control pertaining to GSM/GPRS/EDGE/UMTS and coupled to RF (GSM etc.) chip 1300. Block 1210 suitably provides an analogous ABB for WCDMA wireless and any associated HSDPA data (or 1xEV-DV, 1xEV-DO or 3xEV-DV data and/or voice) with its respective SPI (Serial Port Interface), digital-to-analog conversion DAC/ADC block, and RF Control pertaining to WCDMA and coupled to RF (WCDMA) chip 1300.

An audio block 1220 has audio I/O (input/output) circuits to a speaker 1222, a microphone 1224, and headphones (not shown). Audio block 1220 is coupled to a voice codec and a stereo DAC (digital to analog converter), which in turn have the signal path coupled to the baseband block 1210 with suitable encryption/decryption activated or not.

A control interface 1230 has a primary host interface (I/F) and a secondary host interface to DBB-related integrated circuit 1100 of FIG. 2 for the respective GSM and WCDMA paths. The integrated circuit 1200 is also interfaced to an I2C port of applications processor chip 1400 of FIG. 2. Control interface 1230 is also coupled via access arbitration circuitry to the interfaces in circuits 1250 and the baseband 1210.

A power conversion block 1240 includes buck voltage conversion circuitry for DC-to-DC conversion, and low-dropout (LDO) voltage regulators for power management/sleep mode of respective parts of the chip regulated by the LDOs. Power conversion block 1240 provides information to and is responsive to a power control state machine shown between the power conversion block 1240 and circuits 1250.

Circuits 1250 provide oscillator circuitry for clocking chip 1200. The oscillators have frequencies determined by respective crystals. Circuits 1250 include a RTC real time clock (time/date functions), general purpose I/O, a vibrator drive (supplement to cell phone ringing features), and a USB On-The-Go (OTG) transceiver. A touch screen interface 1260 is coupled to a touch screen XY 1266 off-chip.

Batteries such as a lithium-ion battery 1280 and backup battery provide power to the system and battery data to circuit 1250 on suitably provided separate lines from the battery pack. When needed, the battery 1280 also receives charging current from the Battery Charge Controller in analog circuit 1250 which includes MADC (Monitoring ADC and analog input multiplexer such as for on-chip charging voltage and current, and battery voltage lines, and off-chip battery voltage, current, temperature) under control of the power control state machine.

In FIG. 2 an RF integrated circuit 1300 includes a GSM/GPRS/EDGE/UMTS/CDMA RF transmitter block 1310 supported by oscillator circuitry with off-chip crystal (not shown). Transmitter block 1310 is fed by baseband block 1210 of chip 1200. Transmitter block 1310 drives an off-chip dual band RF power amplifier (PA) 1330. On-chip voltage regulators maintain appropriate voltage under conditions of varying power usage. Off-chip switchplexer 1350 couples wireless antenna and switch circuitry to both the transmit portion 1310, 1330 and the receive portion next described. Switchplexer 1350 is coupled via band-pass filters 1360 to receiving LNAs (low noise amplifiers) for 850/900 MHz, 1800 MHz, 1900 MHz and other frequency bands as appropriate. Depending on the band in use, the output of LNAs couples to GSM/GPRS/EDGE/UMTS/CDMA demodulator 1370 to produce the I/Q or other outputs thereof (in-phase, quadrature) to the GSM/GPRS/EDGE/UMTS/CDMA baseband block 1210.

Further in FIG. 2, an integrated circuit chip 1400 is provided for applications processing and more off-chip peripherals. On chip 1400 are found a high-speed WLAN 802.11a/b/g interface circuit 1410 coupled to a WLAN chip 1500. Further provided on chip 1400 is an applications processing section 1420 which includes a RISC processor (such as MIPS core, ARM processor, or other suitable processor), a digital signal processor (DSP), and a shared memory controller with DMA (direct memory access), and a 2D (two-dimensional display) graphic accelerator.

The RISC processor and the DSP have access via an on-chip extended memory interface (EMIF/CF) to off-chip memory resources 1435 including as appropriate, mobile DDR (double data rate) DRAM, and flash memory of any of NAND Flash, NOR Flash, and Compact Flash. On chip 1400, the shared memory controller in circuitry 1420 interfaces the RISC processor and the DSP via an on-chip bus to on-chip memory 1440 with RAM and ROM. A 2D graphic accelerator is coupled to frame buffer internal SRAM (static random access memory) in block 1440. A security block 1450 includes secure hardware accelerators having security features and provided for accelerating encryption and decryption of any one or more types known in the art or hereafter devised.

On-chip peripherals and additional interfaces 1410 include UART data interface and MCSI (Multi-Channel Serial Interface) voice wireless interface for an off-chip IEEE 802.15 (“Bluetooth” and high and low rate piconet and personal network communications) wireless circuit 1430. Debug messaging and serial interfacing are also available through the UART. A JTAG emulation interface couples to an off-chip emulator Debugger for test and debug. Further in peripherals 1410 are an I2C interface to analog baseband ABB chip 1200, and an interface to applications interface 1180 of integrated circuit chip 1100 having digital baseband DBB.

Interface 1410 includes a MCSI voice interface, a UART interface for controls, and a multi-channel buffered serial port (McBSP) for data. Timers, interrupt controller, and RTC (real time clock) circuitry are provided in chip 1400. Further in peripherals 1410 are a MicroWire (u-wire 4 channel serial port) and multi-channel buffered serial port (McBSP) to off-chip Audio codec, a touch-screen controller, and audio amplifier 1480 to stereo speakers. External audio content and touch screen (in/out) are suitably provided. Additionally, an on-chip USB OTG interface couples to off-chip Host and Client devices. These USB communications are suitably directed outside handset 1010 such as to PC 1050 (personal computer) and/or from PC 1050 to update the handset 1010.

An on-chip UART/IrDA (infrared data) interface in interfaces 1410 couples to off-chip GPS (global positioning system) and Fast IrDA infrared wireless communications device. An interface provides EMT9 and Camera interfacing to one or more off-chip still cameras or video cameras 1490, and/or to a CMOS sensor of radiant energy. Such cameras and other apparatus all have additional processing performed with greater speed and efficiency in the cameras and apparatus and in mobile devices coupled to them with improvements as described herein. Further in FIG. 2, an on-chip LCD controller and associated PWL (Pulse-Width Light) block in interfaces 1410 are coupled to a color LCD display and its LCD light controller off-chip.

Further, on-chip interfaces 1410 are respectively provided for off-chip keypad and GPIO (general purpose input/output). On-chip LPG (LED Pulse Generator) and PWT (Pulse-Width Tone) interfaces are respectively provided for off-chip LED and buzzer peripherals. On-chip MMC/SD multimedia and flash interfaces are provided for off-chip MMC Flash card, SD flash card and SDIO peripherals.

In FIG. 2, a WLAN integrated circuit 1500 includes MAC (media access controller) 1510, PHY (physical layer) 1520 and AFE (analog front end) 1530 for use in various WLAN and UMA (Unlicensed Mobile Access) modem applications. PHY 1520 includes blocks for BARKER coding, CCK, and OFDM. PHY 1520 receives PHY Clocks from a clock generation block supplied with suitable off-chip host clock, such as at 13, 16.8, 19.2, 26, or 38.4 MHz. These clocks are often found in cell phone systems and the host application is suitably a cell phone or any other end-application. AFE 1530 is coupled by receive (Rx), transmit (Tx) and CONTROL lines to WLAN RF circuitry 1540. WLAN RF 1540 includes a 2.4 GHz (and/or 5 GHz) direct conversion transceiver and power amplifier and has low noise amplifier LNA in the receive path. Bandpass filtering couples WLAN RF 1540 to a WLAN antenna. In MAC 1510, Security circuitry supports any one or more of various encryption/decryption processes such as WEP (Wired Equivalent Privacy), RC4, TKIP, CKIP, WPA, AES (advanced encryption standard), 802.11i and others. Further in WLAN 1500, a processor comprised of an embedded CPU (central processing unit) is connected to internal RAM and ROM and coupled to provide QoS (Quality of Service) IEEE 802.11e operations WME, WSM, and PCF (packet control function). Security block in WLAN 1500 has busing for data in, data out, and controls interconnected with the CPU. Interface hardware and internal RAM in WLAN 1500 couples the CPU with interface 1410 of applications processor integrated circuit 1400 thereby providing an additional wireless interface for the system of FIG. 2. Still other additional wireless interfaces such as for wideband wireless such as IEEE 802.16 “WiMAX” mesh networking and other standards are suitably provided and coupled to the applications processor integrated circuit 1400 and other processors in the system.

The description now turns more specifically to scoreboard-based improvements applicable in any one or more of the processors and systems hereinabove and such other processor and system technologies now or in the future to which such improvements commend their use.

Regulating the instruction issuance process is performed by logic to compare the destination operands of each executing instruction with the source (consuming) operands of the instruction that is a candidate to issue. If a data hazard or dependency exists, the candidate instruction is stalled until the hazard or dependency is resolved. If microprocessor clock frequency is increased, execution pipelines are suitably lengthened thereby increasing the number of comparisons. The number of comparisons is also directly affected by the number of execution units or pipelines that are in parallel, as in superscalar architectures. These comparisons and the logic to combine them and make decisions based on them are provided in a manner that is quite compatible with considerations of minimum cycle time and area of the microprocessor.

Various embodiments disclosed herein solve problems including the problem of how to perform the calculation of whether to dispatch an instruction in the first place as well as how to forward data to an instruction in the pipeline from another instruction in the pipeline in an improved manner with respect to CPI (cycles per instruction) and operating frequency in superscalar, deeply pipelined microprocessors and other microprocessors.

To solve these and other problems, a centralized scoreboard lookup as described herein somewhat increases in size but is not affected in its organization by an increase in execution stages in a microprocessor pipeline or set of pipelines. The scoreboard is minimally affected by parallel or superscalar execution, in that only a number of read and write ports change. Furthermore, the centralized scoreboard creatively organizes and partitions the information needed for determining whether an instruction can be issued. This improvement allows instruction dispatch logic to operate at advantageously high frequency for high overall performance of the microprocessor.

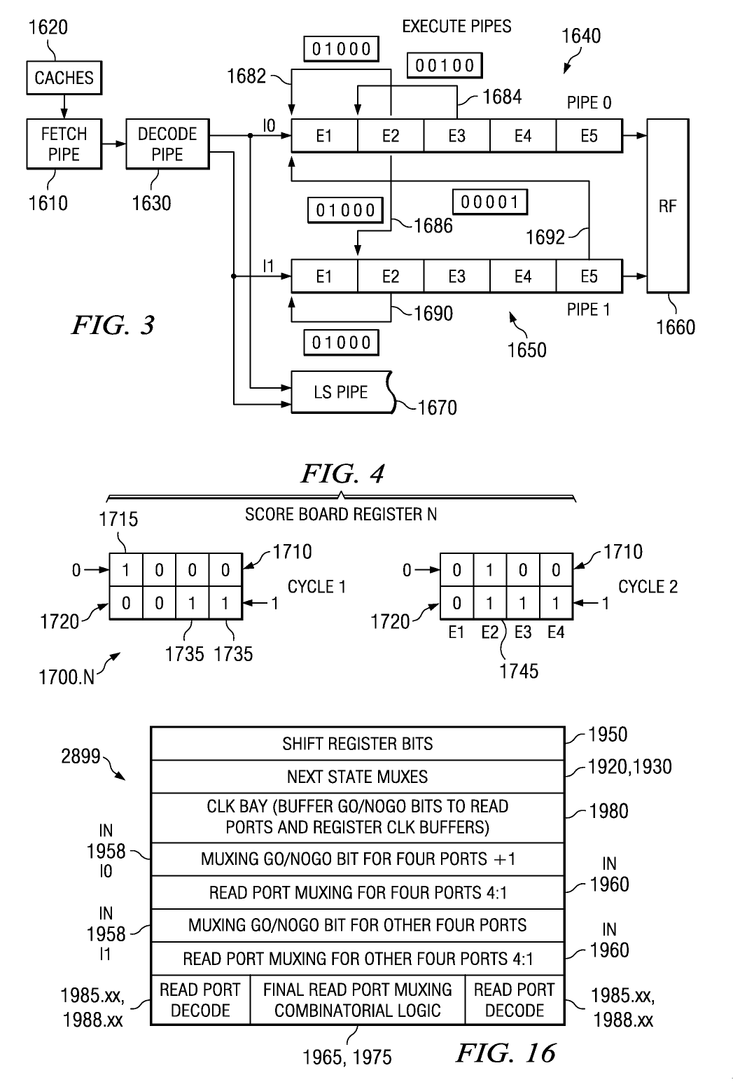

Turning to FIG. 3, this illustration shows a fetch pipe 1610 obtaining instructions from one or more caches 1620 such as a level 1 and level 2 cache. Fetched instructions from fetch pipe 1610 are passed to an instruction decode pipe 1630. Instruction decode pipe 1630 issues instructions at appropriate times defined by clock cycles. Pipes 1610 and 1630 suitably each have one or more pipestages in each of these pipes depending on the clock frequency and performance requirements of the application.

Zero, one or two instructions are issued in any given clock cycle in this embodiment, and more than two instructions are issued in other embodiments. Decode Pipe 1630 in this embodiment issues an instruction I0 to a first execute pipe Pipe0 1640, and may issue a second instruction I1 to a second execute pipe Pipe1 1650. Prior to issue, instructions I0 and I1 are called candidate instructions, herein.

Pipe0 1640 and Pipe1 1650 each have five execute pipestages E1, E2, E3, E4, E5 as illustrated, and suitably are provided with more, fewer, or unequal numbers of pipestages depending on the clock frequency and performance requirements of the application. Further pipelines are suitably added in parallel with or appended to particular pipelines or pipestages therein in various embodiments. In addition Decode pipe 1630 can issue instructions to a Load-Store pipe PipeLS 1670 for load and/or store operations on cache(s) for either unified memory or memory specifically reserved for data.

FIG. 3 further illustrates forwarding of data from sourcing pipestages to consuming pipestages in pipelines Pipe0 and Pipe1. Each pipestage is either occupied by a distinct instruction different from an instruction in any other pipestage, or the pipestage is empty. Multiple data forwarding operations advantageously can occur simultaneously in one pipeline or between pipelines, all in the same clock cycle, as portrayed in FIG. 3.

When a first pipestage requires data that is available from a second pipestage, the second pipestage forwards the data to the first pipestage directly without accessing a register file 1660. Forwarding is using the result data (before the result is written back into register file) as the source operand for subsequent instruction. This embodiment is time-efficient, and makes the register file 1660 circuitry simpler by having the register coupled to the last (WB) pipestage and not several other pipestages, as in alternative embodiments. Also, there is no need for revisions to the register file data that might otherwise arise through branch misprediction, exception, and miss in data cache because writes to the register file from anywhere in the pipeline are prevented under those circumstances.

The forwarding of data between pipestages is controlled by multi-bit entries in shift registers herein respectively called an “upper row” shift register of a respective “scoreboard unit.” The upper row of some scoreboard units are diagrammatically shown in FIG. 3 controlling the data forwarding between pipestages.

For illustrative purposes, FIG. 3 shows a recently-issued instruction in pipeline Pipe0 stage E1 accessing and obtaining data forwarded along a path 1682 by an older instruction in Pipe0 stage E2 using a scoreboard upper row “01000” identifying the second pipestage E2 as the sourcing pipestage.

Another recently-issued instruction in pipeline Pipe1 stage E1 accesses data forwarded along a path 1686 by that same older instruction in Pipe0 stage E2 using the same scoreboard unit upper row and the same bits “01000” identifying the second pipestage E2 as the sourcing pipestage. Instruction Type Data in the scoreboard identifies Pipe0 as the sourcing pipe.

In the illustration see also a forwarding operation along a path 1690 from Pipe1 stage E2 to Pipe1 stage E1. Note that in Pipe1 a scoreboard upper row entry has the same bits “01000” but entered into a different scoreboard upper shift register than the bits “01000” in the scoreboard upper shift register pertaining to Pipe0 E2 forwarding to Pipe0 E1.

Further in FIG. 3, the instruction in Pipe0 stage E2 accesses data forwarded along a path 1684 by an instruction in Pipe0 stage E3 using another upper row entry “00100” identifying pipestage E3. Additionally, the instruction in Pipe0 stage E1 is also accessing data forwarded along a path 1692 from Pipe1 writeback stage E5 by means of an upper scoreboard row entry “00001”.

When an instruction in a respective Pipe0 or Pipe1 is at writeback pipestage E5, the data output of that instruction is finally written into a register file RF 1660. The register file RF 1660 illustratively has a number of registers, often a power-of-two in number, such as R0-R15. The scoreboard units are indexed and identified for use relative to particular instruction source and destination operands by reference to these destination registers in the register file RF 1660 to which a particular source or destination operand is coded to pertain.

One embodiment of an improved scoreboard has respective units corresponding to each register in a register file of the microprocessor. Each scoreboard unit includes at least two (2) sets of bits—an upper row set and a lower row set; see FIG. 4.

### Upper Row

The first set of bits is set up as a shift register (initial singleton one shifted right with zero (0) input). This is the upper row 1710 in FIG. 4. One bit for each execution pipeline stage indicates the location of the issued instruction. The first set of bits has a singleton one 1715 used to control forwarding the result of an issued instruction.

Thus, one function of a scoreboard unit is to indicate by the upper row 1710 that the issued instruction will write at write back pipeline stage into the particular register of the register file to which that scoreboard unit corresponds. A second function of a scoreboard unit is to indicate by the upper row singleton one 1715 the pipestage in which the issued instruction resides at any given time. This facilitates the control of forwarding of data generated by execution of the issued instruction. Accordingly, data is forwarded to another pipestage where a dependent instruction requires the data so generated.

### Lower Row

A second set of bits 1720 for each lower register file register are set up for a reverse-shift (shift left with one (1) input) to indicate if, or to predetermine that a candidate instruction is valid for issuing. The scoreboard units (corresponding to all the register file registers into which producer instruction operand write and consuming instruction operands read) have the second set of bits of each of those scoreboard units checked, to determine whether or not a candidate instruction can be issued for execution from a data dependency hazard point of view.

If the candidate instruction cannot be issued for execution because of data dependency, then it is delayed one or more clock cycles before being issued for execution. In this way, the producer destination operand data will be ready when the decoded instruction once issued reaches the pipestage where the consuming source operand data will be needed. Thus, data hazards are prevented and resolved. Advantageously, issuance of a candidate decoded instruction is regulated under control of the information in the scoreboard units so that the instruction is either 1) issued or 2) suitably delayed and then rechecked and issued at the right time into the pipeline with confidence that the data dependencies are or will be resolved.

Advantageously, issue of the candidate instruction can and does take place before the producer instruction has left the pipeline, and even before the producer instruction has reached the pipestage of availability so that the candidate instruction when issued reaches its pipestage of need when the producer instruction has at least reached the pipestage of availability.

Advantageously, in some embodiments only those stages of a pipeline are scoreboarded starting with the first pipestage into which a candidate instruction is issued and including each pipestage thereafter and ending with the last pipestage from which any instruction in the whole instruction set forwards data to another pipestage. In some other embodiments the scoreboarding ends with the pipestage from which writeback to the register file occurs. Some embodiments provide only the lower row of the scoreboard, while other embodiments provide the upper row only. Advantageously both rows of the scoreboard are used together as described herein.

In FIG. 4, a scoreboard unit N corresponding to one register N in a register file has a first set of bits with a singleton one in the upper left, indicating that a sourcing instruction is at issue stage (just inserted into the pipeline). Except for the singleton one, the upper shift register is a shift right zeroes shift register, meaning that successive zeroes are shifted in behind the singleton one on succeeding clock cycles.

In FIG. 4, the scoreboard for register file register N has upper row 1710 of shift register cells. Upper row 1710 holds a single logic bit or level one (1) designated 1715 representative of the most advanced execution pipestage which an issued Instruction currently has reached. All the other cells of upper row 1710 hold the complementary logic level zero (0). The logic level 1715 is entered from the left of upper row 1710 to represent pipestage E1. Clock cycle by clock cycle, logic level 1715 is shifted one column to the right in upper row 1710, as shown in FIG. 4, clock cycle 2, so that the logic level 1715 progresses column-wise E1 to E2, E2 to E3, E3 to E4, E4 to E5.

In FIG. 4, Logic level 1715 after a while reaches the first execution pipestage from which results are produced by the producer instruction destination operand represented by that scoreboard unit. The column position (e.g. E3) of logic level 1715 at the clock cycle wherein that pipestage is reached, signifies and represents that execution pipestage. In each subsequent clock cycle the corresponding column position of logic level 1715 at such cycle represents the execution pipestage from which the results of the instruction can be obtained at that time.

It is emphasized that the upper row 1710 and logic level 1715 do not in themselves represent the first execution pipestage from which results of the Instruction are achieved in this embodiment. Advantageously, a second shift register shown as second row 1720 together with control circuitry driving the second row 1720 together perform this function.

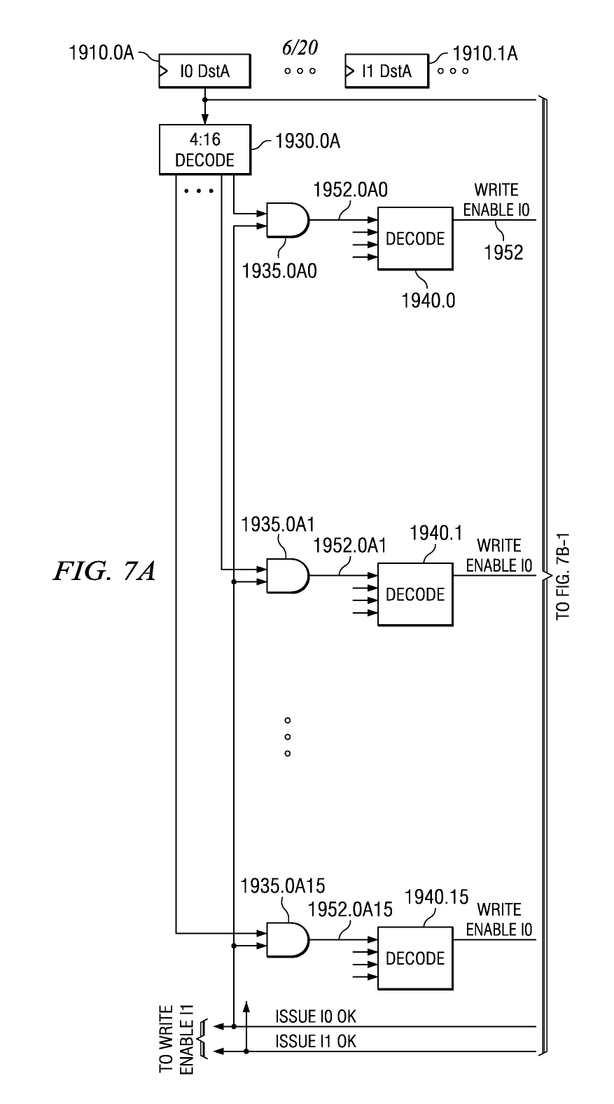

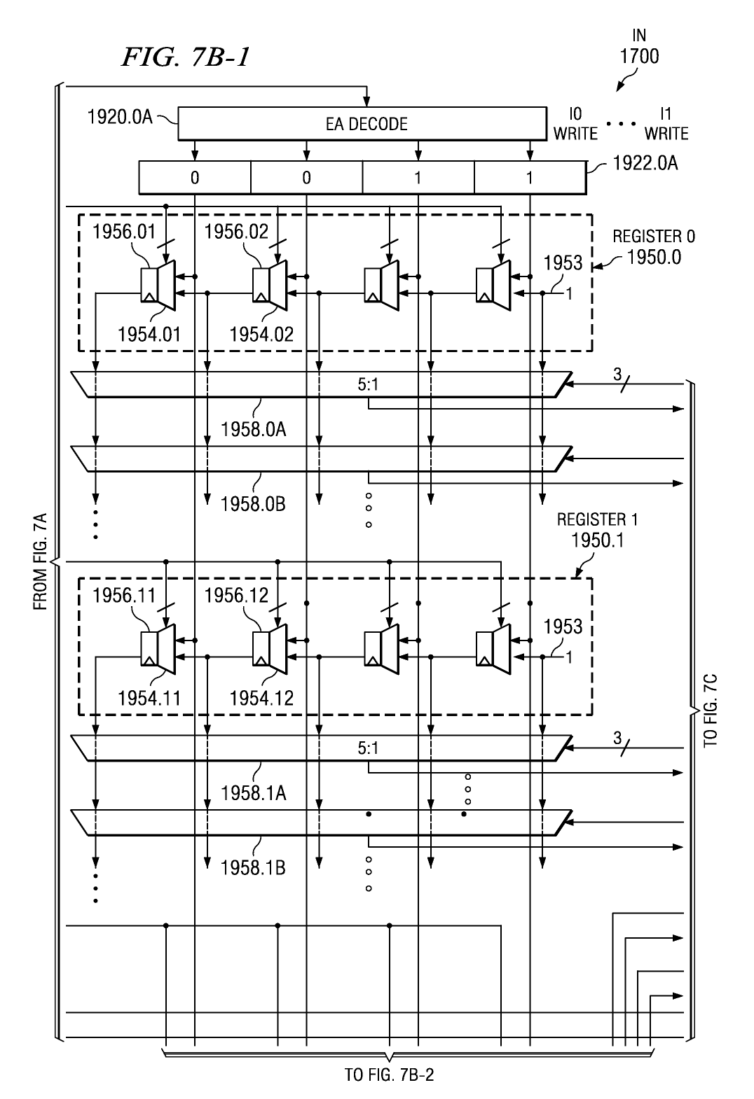

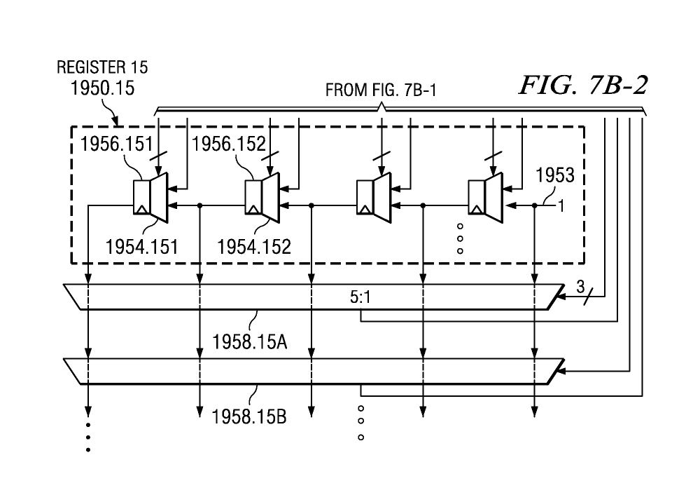

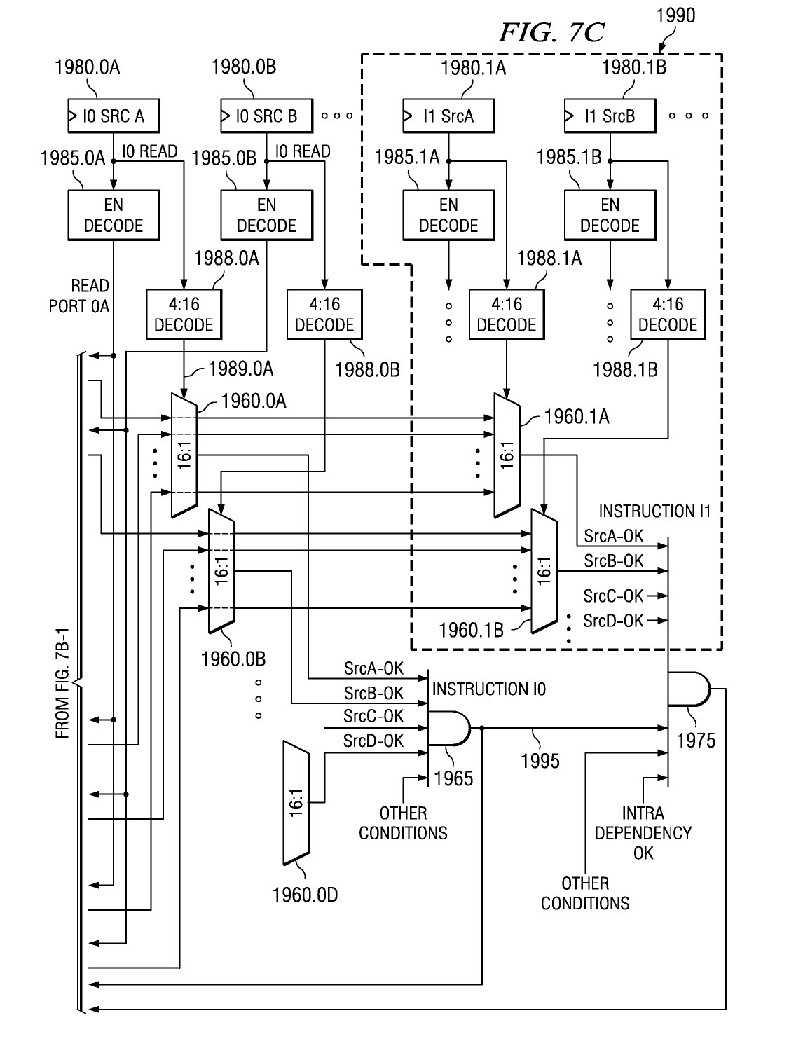

In FIG. 4, consider clock cycle 1, when bit 1715 is introduced to column E1 of upper row 1710. Concurrently, control circuitry (FIG. 7A) loads a series of second row 1720 column cells simultaneously with logic bits 1735 (e.g. logic ones (1) in column cells E3, E4). The column cells that are initially simultaneously loaded with ones (1) are precisely those corresponding to particular execution pipe stages from which generation of results of the just-issued Instruction will be available by the execution pipe when that particular instruction type passes through the execution pipe. The identity of those pipestages depends on the nature of the instruction itself. The circuitry suitably identifies those pipestages such as by using a field from the Instruction, or decoding of the Instruction, or doing a table lookup based on the Instruction.

The producer instruction has its result illustratively first occurring in the third (3^{rd}) pipestage. Correspondingly, the second set of bits has a row of ones terminating initially in a leftmost one in the third (3^{rd}) column from left in the lower shift register as diagrammed. All bits left of the leftmost one are initialized to zero. On succeeding clock cycles, the row of ones in the second set of bits of the lower shift register is shifted left clock cycle by clock cycle, and successive ones are shifted in from right to grow the row of ones. The lower shift register is a shift left ones shift register.

In FIG. 4, clock cycle 2, logic bits 1735 are shifted one column to the left in second row 1720, and thus opposite in direction to the direction of shift in upper row 1710. In this way, logic bits 1735 progress column-wise (E3,E4) to (E2,E3,E4) to E1,E2,E3,E4. The producer instruction is moving through the pipeline.

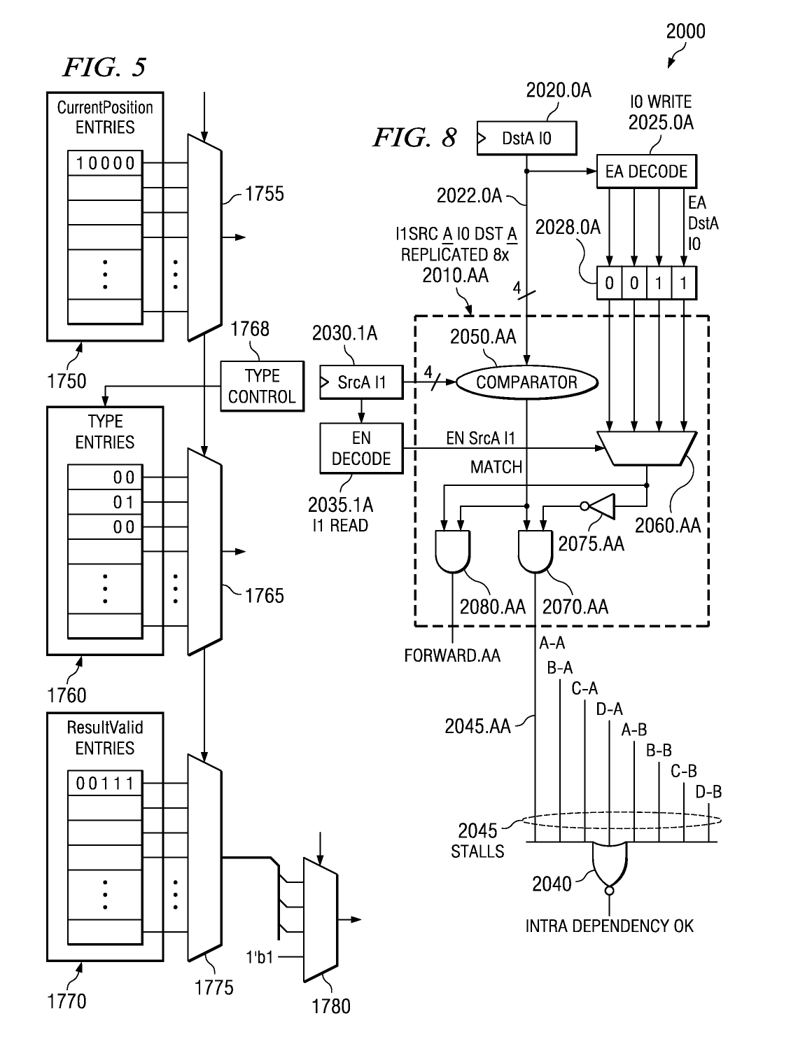

In FIG. 5, a scoreboard embodiment includes circuitry corresponding to a three-dimensional array having a first dimension number of columns equal to the number of execution pipestages, a second dimension pair of rows of FIG. 4 called the upper row 1710 and the second row 1720 herein, and a third dimension number of pages (repeated row-columns) equal to the number of registers in the register file 1660 (FIG. 3). Among other advantages, the scoreboard enables issuance of the Dependent Instruction only when the operand required from register RN by the Dependent Instruction will have already been provided as an output of the Previous Instruction to that register RN. In other words, the scoreboard also prevents premature issuance of the Dependent Instruction if the Previous Instruction will not have provided the output to the register RN on which the Dependent Instruction depends, by the time when the Dependent Instruction requires the operand value from register RN.

In FIG. 5, an illustration of a logical implementation of the scoreboard is shown. The scoreboard is comprised of three sections in this embodiment: ResultValid Entries 1770 (shift-left-one), CurrentPosition Entries 1750, (shift right zero), and Type Entries 1760 (non-shifting).

ResultValid Entries 1770 tabulate for an Issuing Instruction: The cycle data will be valid for a specific register. (The shifting ResultValid Entries vector provides the lower row 1720 second-set-of-bits information.) A mux 1775 to the ResultValid Entries is controlled by the Issuing Instruction: Query scoreboard for each register operand needed, e.g., initiate queries to the respective scoreboard units for the register file registers corresponding to each register operand needed so that the lower row 1720 (second set of bits) in each of those scoreboard units is queried. A next mux 1780 is controlled by the Issuing Instruction: Shift the ResultValid if the register operand can be provided in a cycle later than the cycle before the first execute stage. That next mux 1780 has a 1′b1 input used to force ResultValid when a specific operand is not used by an instruction. That next-mux 1780 has an output ResultValid which is used to determine whether the candidate instruction can successfully be issued without data hazard.

CurrentPosition Entries 1750 tabulate for an Issuing Instruction: the cycle where the specific register's producer instruction resides. (The shifting CurrentPosition Entries vector provides the upper row 1710 first-set-of-bits information.) A mux 1755 to the CurrentPosition Entries is controlled by the Issuing Instruction: Query scoreboard for each register operand needed. This mux 1755 has an output CurrentPosition used to forward register operands to an issued instruction (e.g., forward register operand(s) from a pipestage at which a producer instruction resides, to a pipestage where the now-issued instruction (no longer a candidate) resides and requires the operand(s)).

Type Entries 1760 tabulate for an Issuing Instruction: the pipeline where the specific register's producer instruction resides. A Type Entry is stored in the third register in FIG. 5 that involves no shifting in the embodiment illustrated. In some embodiments, the third registers are respectively concatenated with the CurrentPosition shift registers so that the Type is muxed out with Current Position. Type Entries are fed to a mux 1765 controlled by the Issuing Instruction: Query scoreboard for each register operand needed. This mux 1765 has an output Type used to identify the pipeline from which to forward register operands to an issued instruction (e.g., forward register operand(s) from a pipeline in which a producer instruction resides, to a pipeline where the now-issued instruction (no longer a candidate) resides and requires the operand(s)). A Type control circuit 1768 stores each Type Entry 1760 into the particular Type register pertaining to a producer instruction destination operand.

The forwarding (upper row) Current Position scoreboard is suitably provided with seven (7) bits. Five (5) of the bits handle the illustrated five (5) instruction-execute pipestages and are shifted into the pipestages and pipelined down those pipestages for forwarding purposes. Type is two (2) bits physically associated with the Current Position scoreboard row so that five Current Position bits plus two Type bits constitute a physical portion of the scoreboard in this embodiment.

One embodiment partially duplicates the current position (CP) indicator (singleton one) in the ResultValid field (RV field). It embodies overlapping information, namely older dependent instruction position and trailing ones. This advantageously results in a very simple determination process of operand availability for the issuing instruction:

1. Read ResultValid indicator (RV field) from scoreboard to know what pipestage (and all pipestages succeeding) an operand will be available.

2. Shift ResultValid indicator depending on when the issuing instruction consumes the operand to find if that operand is available (or will be available) in a specific cycle, i.e., generate OperandAResultValid as output from mux 1780.

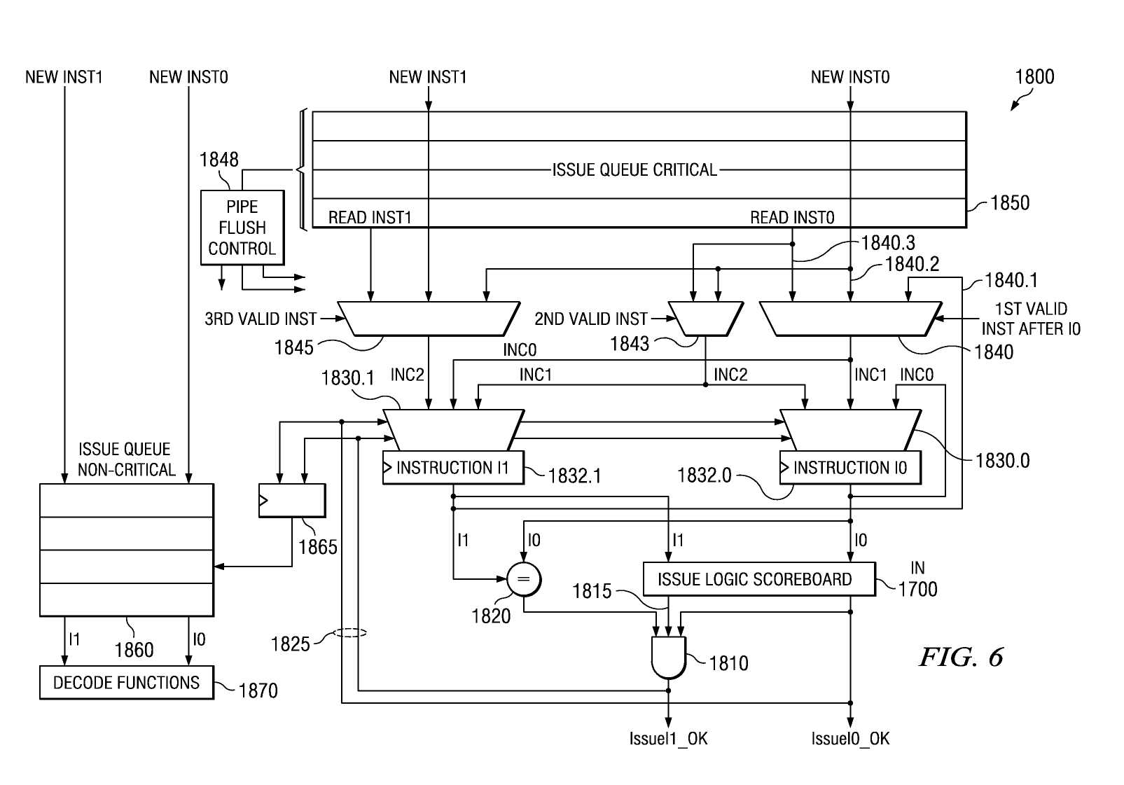

The description of FIGS. 6, 7A, 7B, 8-11, 12A-12B provides further specific detail on the scoreboard processes and structures.

### ADVANTAGES

Various advantages are described here and elsewhere herein. Among other advantages, one or more embodiments confer:

1. A simpler circuitry and process that incurs less logic in a known or very probable critical path within a microprocessor.

2. Higher frequency of operation by incurring less logic and delay in a known or very probable critical path within a microprocessor.

3. Forwarding select (e.g. between instructions in different pipestages) is read directly from a scoreboard.

4. Simple and unique implementation for dependency checking regardless of which pipeline the result is valid or which pipeline the operand is used.

5. Operand scoreboard is highly organized.

6. Pipe lengthening does not fundamentally affect the scoreboard architecture.

7. Number of operands being checked does not fundamentally affect the scoreboard architecture.

8. Partitioning of dispatch go/no-go information (ResultValid) from forwarding information (CurrentPosition and Type) makes the scoreboard's organization elegant and uncomplicated.

9. Forwarding controls (e.g., for forwarding information between instructions in different pipestages or pipelines) are obtained by a direct read of the scoreboard structure.

10. Scoreboard integrates various cycles of consumer instruction control at both the issue candidate instruction phase and the issued instruction phase.

Illustrative Analysis of go/No-go Scoreboard Operation and Structure

The following mathematical description is provided to facilitate understanding of some of the embodiments of structure and process pertaining to the issue control (lower-row) part of the scoreboard). In other embodiments, the equations are suitably modified for analysis of those embodiments, and the circuitry of those other embodiments is correspondingly modified compared to circuitry embodiments that correspond to the equations below.

Ip signifies a producer instruction in the execute pipeline. Producer instruction Ip generates the data which a dependent candidate Instruction consumes, or on which a dependent Instruction depends.

I0 and I1 each signify a dependent candidate Instruction awaiting issue which will consume data generated by the Producer Instruction Ip. In most cases, references to instruction I0 are equally applicable to instruction I1.

Let EA(Ip) represent the pipestage in which results first become available from producer Instruction Ip. The value of execute availability EA is a property of the instruction Ip, so EA is either conveniently decoded from instruction Ip or obtained by table lookup.

“Forwarding” is the act of conveying the result data from a producer Instruction Ip (before the result is written back into register file) from one execute pipestage to another pipestage for consumption as a source operand for a subsequent instruction.

Let E(Ip) represent the pipestage which Producer Instruction Ip has reached when a determination occurs whether to issue dependent instruction I0 or not.

Let EN(I0) represent the pipestage of execute need in which the operand will be Needed by instruction I0, once I0 is issued. The value of EN(I0) is a property of the instruction I0. Accordingly, EN(I0) is generated by decoding logic that decodes the Dependent Instruction or determines EN(I0) by table lookup.

Then the number of cycles before instruction I0 can be allowed to issue is equal to a difference D as a function of EA, E and EN, where

D=(EA(Ip)−E(Ip))−EN(I0)+1 except if result<0 threshold, then set D=0. (1)

Equation (1) expresses the idea that a first number of cycles (EA(Ip)−E(Ip)) elapse or are consumed before producer instruction Ip reaches the pipestage EA(Ip) where instruction Ip can source the data on which instruction I0 depends. D is difference between that first number of cycles and a second number of cycles EN(I0) which would be needed, if dependent instruction I0 were issued immediately, in order for instruction I0 to travel to pipestage EN(I0) where instruction I0 would need to consume the data that instruction Ip produces. The “+1” (plus-one) in Equation (1) adds an extra clock cycle in this embodiment to avoid a race condition if the producer instruction Ip were otherwise to reach its sourcing pipestage EA(Ip) on the same clock cycle as the issuing instruction were to reach the consuming pipestage EN(I0). (In embodiments where a race condition is not an issue, the plus-one is omitted and circuitry revised accordingly.)

As soon as D becomes equal to or less than zero, instruction I0 may be issued immediately, so that I0 would appear in the first pipestage into which issue occurs in the very next clock cycle, provided that no other reasons to delay issue exist. Such other possible reasons to delay issue are discussed in connection with FIGS. 7A, 7B, 7C and FIG. 8 and elsewhere herein.

In a first example, suppose decoding of the Dependent Instruction I0 determines that I0 is a type of instruction that requires the data from producer instruction Ip for consumption by I0 if and when I0 reaches third execution pipestage E3. In other words, EN(I0) is three (3). In a case where EA(Ip) is 3 (column position number of the leftmost one in the second row of the scoreboard) and position E(Ip) is one (as signified by a one (1) at the column 1 position in the first row of the scoreboard), control circuitry responds to the decoding and to the state of the scoreboard rows to issue I0 immediately. The formula reflects this advantageous operation since D=(3−1)−3+1=0. There are no cycles to wait before issuing dependent instruction I0 if no other reasons to delay issue exist.

In a second example, suppose decoding of I0 determines that I0 is a type of instruction for which EN(I0)=2. I0 requires the data from producer Ip for consumption by I0 when I0 is in second execution pipestage E2 (and not E3 as in the first example in the paragraph just above). In the case where availability EA(Ip) is 3 (leftmost one) in the second row of the scoreboard and position E(Ip) is one (1) in the first row first column of the scoreboard, the control circuitry that issues dependent instruction I0 responds to the decoding and to the state of the scoreboard rows to wait one cycle. The control circuitry maintains an issuance-disable signal pertaining to instruction I0 and then supplies an issuance-enable for instruction I0 after the one cycle wait. Again, the formula reflects this advantageous operation since D=(3−1)−(2)+1=1. The formula says to wait one cycle before issuing instruction I0 if no other reasons to delay issue exist.

One clock cycle later in the second example, decoding of dependent instruction I0 still has determined EN(I0)=2. I0 is a type of instruction that requires the data producer Ip for consumption by I0 when I0 is in second execution pipestage E2 (and not E3 as in the first example in the paragraph just above). EA(Ip) is 3 but now producer position E(Ip) has now advanced to pipestage two (2). Correspondingly, the singleton one (1) in the first row of the scoreboard has advanced to the second column. The control circuitry that issues candidate I0 responds to the decoding and to the state of the scoreboard rows to immediately issue instruction I0 since instruction I0 requires data no sooner than pipestage E2. Again, the formula reflects this advantageous operation since D=(3−2)−(2)+1=0. The formula says to wait zero cycles (no-wait) before issuing instruction I0 if no other reasons to delay issue exist.

In a third example, suppose decoding of candidate I0 determines that I0 is a type of instruction for which EN(I0)=1. This means I0 requires the data from producer Ip for consumption by I0 when I0 is in first execution pipestage E1 (and not E3 or E2 as in the first and second examples respectively). In the case where EA(Ip) is 3 (leftmost one) in the second row of the scoreboard and position E(Ip) is one (1), the control circuitry that issues candidate I0 responds to the decoding and to the state of the scoreboard rows to wait two cycles by maintaining an issuance-disable signal pertaining to I0 and then supplying an issuance-enable for I0 on the second cycle. Again, the formula reflects this advantageous operation since D=(3−1)−(1)+1=2 cycles. The formula says to wait two cycles before issuing I0 if no other reasons to delay issue exist.

One clock cycle later in the third example, decoding of I0 still determines Need EN(I0)=1. Availability EA(Ip) is still 3 but now position E(Ip) has advanced to pipestage two (2). The control circuitry that issues I0 responds to the decoding and to the state of the scoreboard rows to wait one cycle by maintaining an issuance-disable signal pertaining to I0 and then supplying an issuance-enable for I0 after one cycle. Again, the formula reflects this advantageous operation since D=(3−2)−(1)+1=1 cycle. The formula says to wait one cycle before issuing candidate I0.

One additional clock cycle later producer position has advanced, so E(Ip)=3. The formula result is (3−3)−(1)+1=zero (0) cycles. The issuance-enable for I0 is immediately supplied and I0 is issued if no other reasons to delay issue exist.

A first embodiment is feasibly provided with an arithmetic circuit for computing value D from Equation (1) for a scoreboard entry for each register file register.

Even more conveniently, an alternative second embodiment provides the scoreboard with a stationary leftmost one in a leftward-moving series of all-ones in the second row to initially represent EA(Ip) on the scoreboard. E(Ip) is in the first (upper) row and is a rightward moving singleton one (1).

Consider a formula to describe the situation where the second row has this left-shifted series of ones.

EA(Ip)=EL(Ip)+E(Ip)−1 (2)

In words, when the previous instruction (producer) Ip is in the first pipestage position E(Ip)=1, then the leftmost one in the second row of the scoreboard has a column position equal to EA(Ip). This initial column position of leftmost one represents the first pipestage in which the producer instruction Ip generates data to its given destination operand. Then as cycles proceed, the increasing column number of position E(Ip) in the upper row compensates in this equation for the decreasing column position EL(Ip) of the leftmost one in the lower row. This Equation (2) is provided as a defining equation for EL(Ip) as a function of the difference EA(Ip)−E(Ip), since, as noted above, EA(Ip) is a property of the producer instruction Ip itself.

Substituting Equation (2) into Equation (1) then yields for D, the number of cycles before I0 can be allowed to issue:

D=((EL(Ip)+E(Ip)−1)−E(Ip))−EN(I0)+1

D=EL(Ip)−EN(I0), except if result<0 threshold, then D=0. (3)

In one embodiment described by Equation (3), the lower row of ones is first entered in the scoreboard with the leftmost one initially entered at the position EA(Ip). The reason is that this entry occurs when the instruction Ip is itself first issued. When instruction Ip has just been issued, position E(Ip) signifies the first pipestage (upper leftmost cell on scoreboard), so E(Ip)=1 (one). Substituting E(Ip)=1 into Equation (2) determines that the initial entry of EL(Ip) equals EA(Ip), the pipestage of first availability for this instruction Ip. Accordingly, EL(Ip) is initialized with its leftmost one at the column EA(Ip) of the lower shift register of the scoreboard unit.

Note further that the scoreboard unit for each register file register is continually updated by shifting control circuitry each clock cycle independently of whether any candidate instruction I0 is accessing that scoreboard unit or not. Accordingly, the producer instruction Ip which has a given register file register as a destination operand, in general can have reached any particular pipestage depending on the clock cycle, by the time the issue control circuitry in response to the latest candidate instruction I0 accesses the corresponding scoreboard unit to check for data dependency.

Accordingly, when Equation (3) is computed or determined for purposes of issuing an instruction I0 or not, leftmost one position EL(Ip) will either be at the column EA(Ip) or will already have advanced somewhere left of column EA(Ip). This will depend on how many clock cycles have elapsed since producer instruction Ip entered its pipeline. Thus EL(Ip) represents a dynamically determined position of the left-most one in the series of left-advancing ones in the lower row of the scoreboard.

As soon as D becomes equal to zero or less than zero at all scoreboard units corresponding to the registers of the consuming operands of consuming candidate instruction I0, instruction I0 is issued immediately if no other reasons to delay issue exist. Equation (3) is feasibly implemented with a simple subtractor associated with the respective scoreboard associated with each register file register. Even more conveniently, a muxing approach is described in connection with FIGS. 7A and 7B hereinbelow where “ReadPort1” (corresponding to an operand register of consuming instruction I0) is described.

In that latter muxing approach, a mux is monitoring the lower scoreboard row at the column-position EN(I0). If a one is present in the lower scoreboard row at column-position EN(I0), that one is muxed out of the scoreboard unit to supply an enable signal that indicates that no dependency issue exists relative to the particular register file register to which this scoreboard unit pertains. Accordingly, unless a dependency issue for instruction I0 exists in some scoreboard unit for another register file register, or some other reason to prevent issuance exists, then instruction I0 is enabled by this muxed-out one for issue into the pipeline.

Also, as described herein, the series of ones in the lower row of the scoreboard is advantageously provided indeed as a series of ones, instead of being a singleton one in the lower scoreboard row, for at least the following reasons. A first reason is to always provide a one to be muxed out at scoreboard lower row column-position EN(I0) if the leftmost one in the lower row has either reached or advanced leftward of column-position EN(I0) as of the time the issuance determination is needed. A second reason is that if a dependency issue exists in a scoreboard for another register file register, or some other reason to prevent issuance exists, then issuance of instruction I0 is deferred one or more clock cycles, and the lower row leftmost one advances leftward of column-position EN(I0). In such condition, another enabling one for use in these subsequent clock cycles is advantageously still available in the lower scoreboard row corresponding to the given register because of this series of ones.

Equation (3) shows that issuance of candidate I0 can be controlled by use of the lower or second row of the scoreboard alone to represent producer leftmost one position EL(Ip) together with decoding of I0 to yield first pipestage of need EN(I0). Advantageously, this embodiment eliminates circuitry to independently store the initial state of the series of ones in the second row of the scoreboard, and instead responds to the current state of the scoreboard directly.

All three issuance-timing examples described earlier hereinabove and based on Equation (1) operate just as well based on the advantageously less-complicated approaches based on Equation (3).

In the first timing example, decoding of the Dependent Instruction I0 determined that I0 is a type of instruction that needs the data from producer Ip for consumption by I0 if and when I0 reaches third execution pipestage E3. In other words, EN(I0) is three (3). In a case where availability EA(Ip) is 3 (column position number of the leftmost one in the second row of the scoreboard), then leftmost one EL(Ip) exists at or has advanced left of EA(Ip). Accordingly, a one in the series of ones is muxed out as an enable to issue candidate I0 immediately unless some other reason otherwise prevents. Equation (3) reflects this advantageous operation since D=3−3=0. There are no cycles to wait before issuing I0 if no other reasons to delay issue exist.

In the second example, decoding of I0 determined EN(I0)=2. In the case where EA(Ip) is 3 in the second row of the scoreboard, then EL(Ip) (leftmost one) will be at least as far left as column position 3. Assume that EL(Ip) is precisely in column 3. The mux is looking for a one in column 2, just to the left of column 3, because EN(I0) is 2. However, column 2 has a zero therein because the leftmost one EL(Ip) is only at column 3. In this case, the control circuitry that can issue candidate I0 waits one cycle by maintaining an issuance-disable signal low (0) pertaining to I0. Equation (3) reflects this advantageous operation since D=3−2=1. The formula says to wait one cycle before issuing I0. Only after the one cycle can the circuit then supply an issuance-enable for I0 when the series of ones in the lower scoreboard row has advanced to column 2 and thus EL(Ip)=2, and D=EL−EN=2−2=0. Equation (3) at that one-cycle-later time is saying to wait zero cycles (no-wait) before issuing I0 if no other reasons to delay issue exist.

In the third example, decoding of candidate I0 determined that EN(I0)=1. Availability EA(Ip) is 3 so leftmost one EL(Ip) will be at least as far left as column position 3. Assume that EL(Ip) is precisely in column 3. The mux is looking for a one in column 1, two columns to the left of column 3, because EN(I0) is 1. However, column 1 and column 2 have zeroes therein because the leftmost one EL(Ip) is only at column 3. In this case, the control circuitry that can issue I0 responds to the decoding and to the state of the scoreboard rows to wait two cycles by maintaining an issuance-disable signal low (0) pertaining to candidate I0. Again, the formula reflects this advantageous operation since D=3−1=2. Only after the two cycles can the circuit then supply an issuance-enable for candidate I0 when the series of ones in the lower scoreboard row has advanced to column 1 and thus EL(Ip)=1, and D=EL−EN=1−1=0. Equation (3) at that two-cycles-later time is saying to wait zero cycles (no-wait) before issuing I0 if no other reasons to delay issue exist.

Another Embodiment for the go/No-go

The information used to determine whether an instruction can issue can advantageously be derived from the candidate instruction I0 consuming operand and the current position (CP) of the producer instruction Ip within the execution pipeline. In another embodiment, determining an operand is available (or will be available) from producer instruction Ip for the candidate instruction I0 involves these steps. Use FIG. 5 for comparison.

Read the current position indicator 1750 (singleton one) from scoreboard unit to identify the position of the producer instruction E(Ip).

Shift a mask (e.g., the left-shifted row of ones in the lower shift register 1770) depending on when the candidate instruction IO consumes the operand (e.g., by initializing the leftmost one of the mask in the column identifying the pipestage EA(Ip) where the producing instruction first generates the operand). That is, the operand needs to be produced by a certain stage or any stage previous (by the producer instruction Ip) to allow dispatching the candidate instruction IO.

AND the mask and the current position (CP field) 1750.

Bitwise OR the result to find if that operand is available (or will be available) in a specific future clock cycle, i.e. generate OperandAResultValid out of mux 1780.

Step 1 reads E(Ip). Step 2 positions the series of ones to be leftmost at EA(Ip)−EN(I0)+1. The shifting of Step 2 refers to an effective one-time offsetting of EA(Ip) by EN(I0)−1. In this approach the upper row CP 1750 singleton one E(Ip) is advanced clock cycle by clock cycle to the right. The lower row 1770 series of ones is offset-shifted left at the outset and not cycle-by-cycle thereafter. Steps 3 and 4 in effect accomplish a subtraction equal to the result EA(Ip)−EN(I0)+1 of Step 2 less E(Ip) from step 1.

D=EA(Ip)−EN(I0)+1−E(Ip) which is the same as Equation (1). Since the comparison is relative, alternative approaches can do either or both of 1) offset-shift the upper row right at the outset and not offset-shift the lower row and 2) shift the lower row left cycle by cycle and not shift the upper row right cycle by cycle.

### Operation of Top Row of Scoreboard—Data Forwarding

Given a singleton one at position E(Ip) in the scoreboard upper row 1710, consider what happens to an instruction I0 that is now issued and needs data that is first generated in execution pipestage EA(Ip) by producer Instruction Ip.

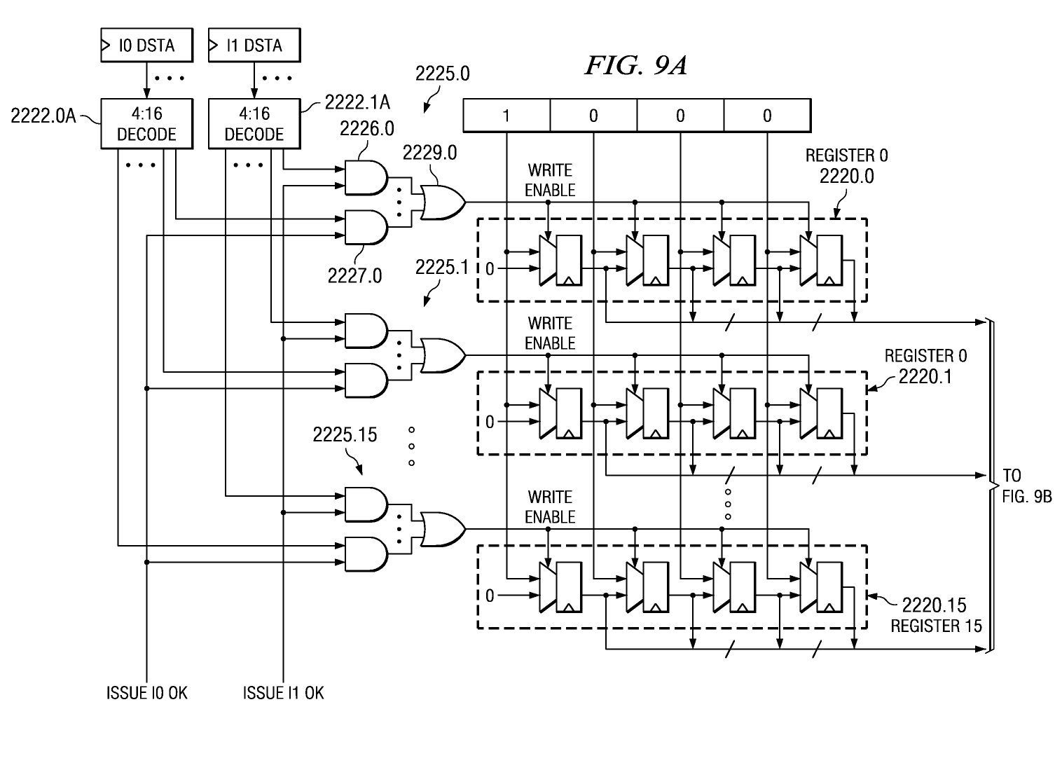

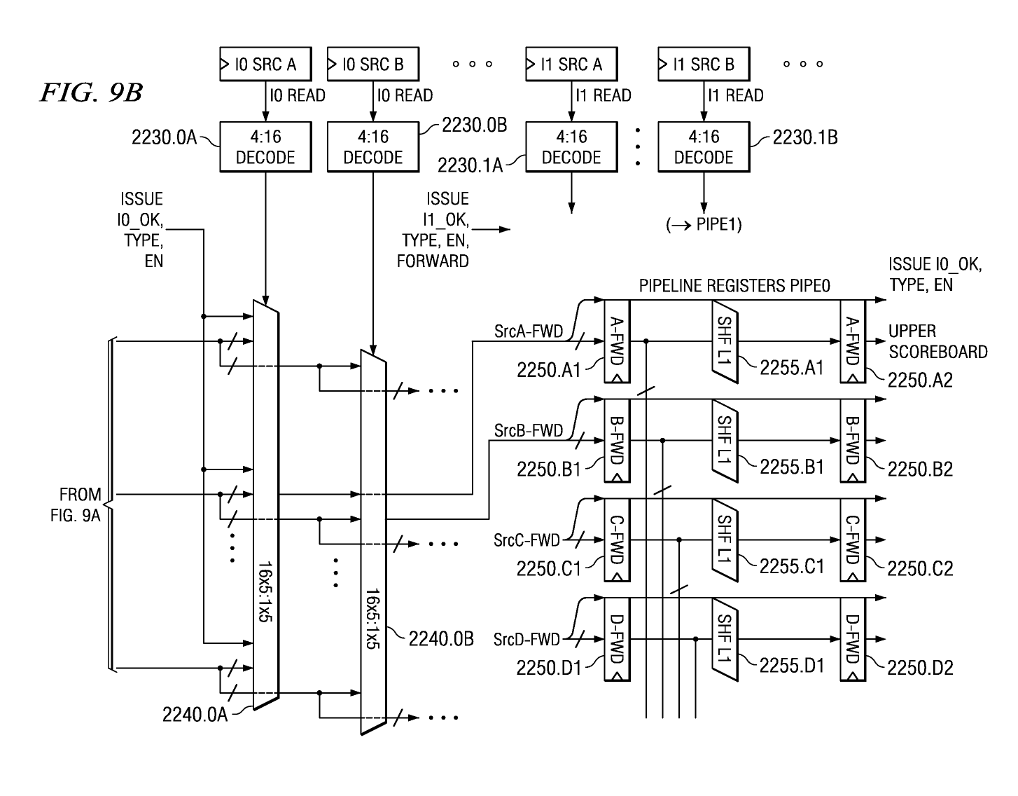

The Dependent Instruction I0 knows from the upper row (also called the “top vector” herein) of the scoreboard which pipestage (and pipeline identified by the Type register 1760 in the scoreboard unit) has the data to supply from the producer Instruction Ip. From the time the Dependent Instruction I0 enters its pipeline until instruction I0 reaches its execution pipestage of need EN(I0) to consume an operand, instruction I0 copies out the top vector shifting it into itself, it is shifting the copied top vector through pipestages along with itself. This action is described later hereinbelow, see FIG. 9B. Then the singleton one in the top vector, as shifted along the top vector, matches and identifies the producer pipestage E(Ip) from which instruction I0 in its own pipestage EN(I0) requires the data.

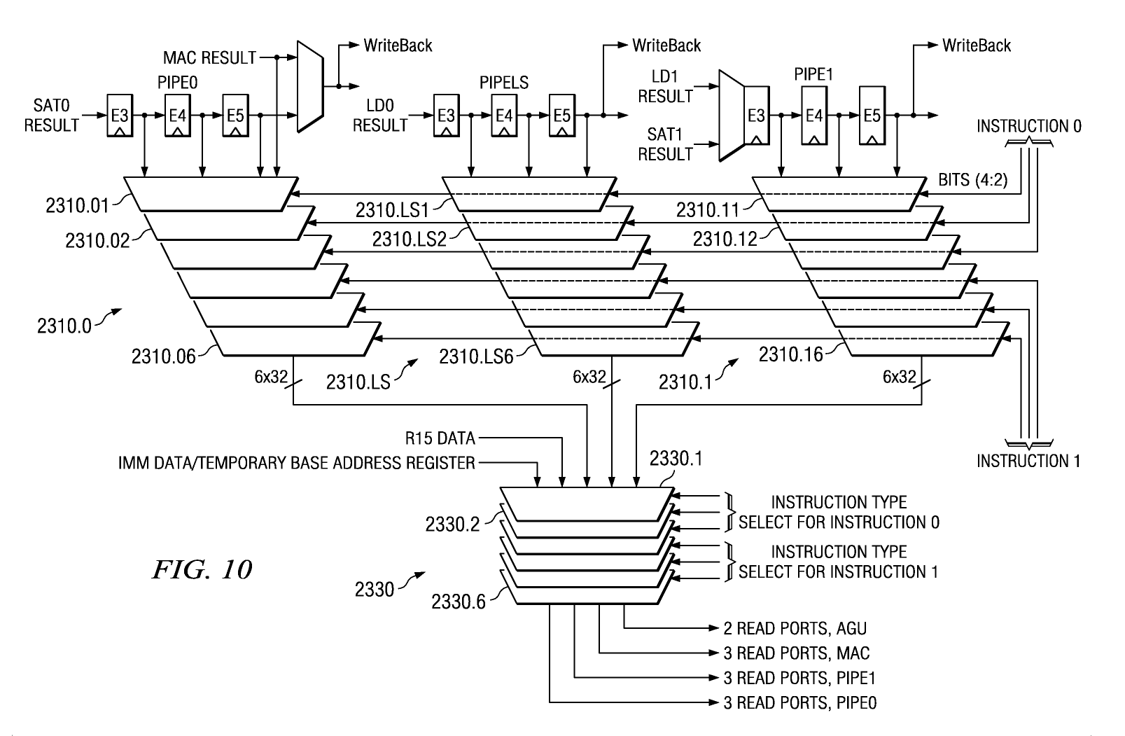

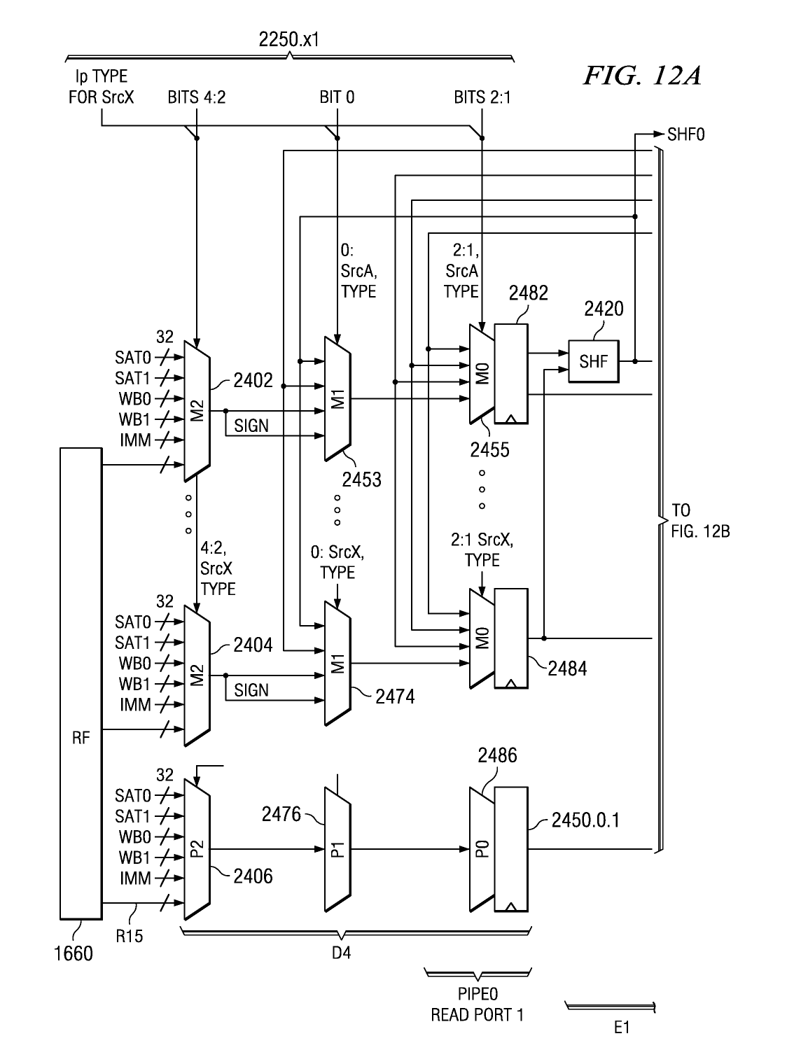

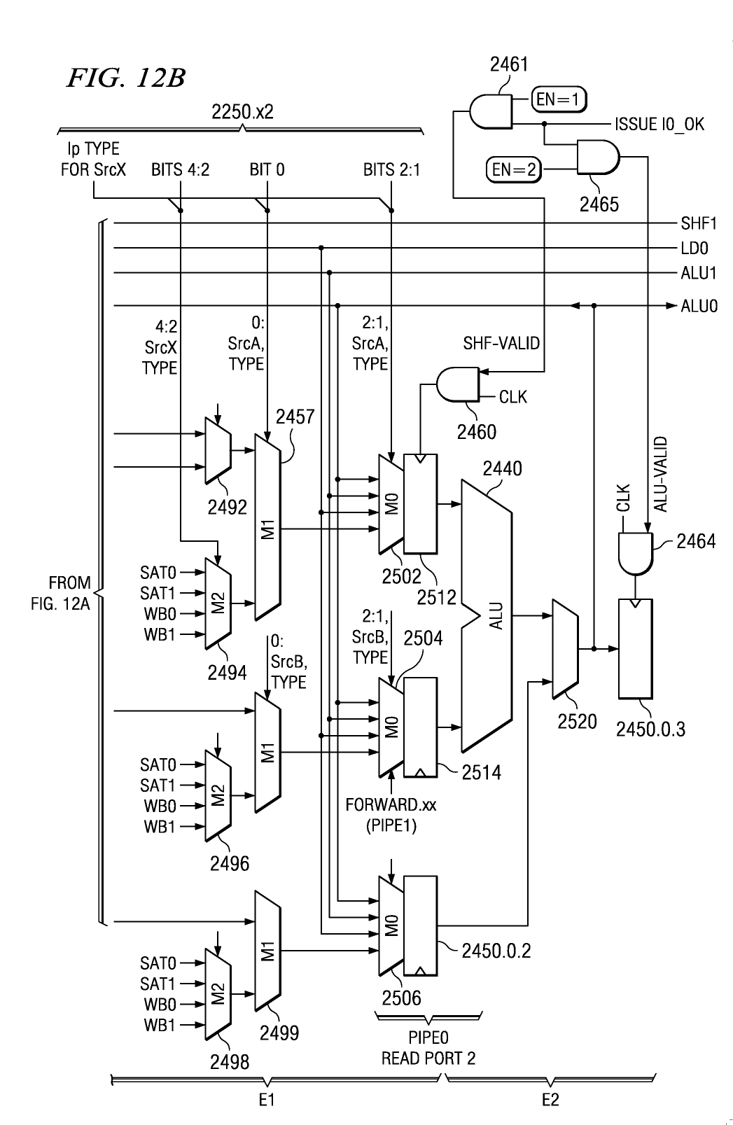

Then the instruction I0 in pipestage EN(I0) causes the data to be sourced from producer pipestage position E(Ip) to consuming pipestage EN(I0) by controlling a forwarding control circuit. An example of the forwarding circuitry is shown in FIGS. 10, 12A and 12B. The forwarding control circuit is suitably provided as an assemblage of transmission gates and parallel lines coupling a register in producer pipestage E(Ip) to consuming pipestage EN(I0).

Forwarding between pipestages E1-E5 is distinct from reading and writing register file registers 1660. In the forwarding operations of some embodiments herein, the scoreboard has scoreboard units corresponding to register file registers 1660. The upper row 1710 of each scoreboard unit facilitates control of forwarding. The identification of the corresponding register file 1660 register is thus an organizing identification for its respective scoreboard unit. The register file register in this embodiment is not a physical site for reading or writing of data in the forwarding of data between pipestages themselves.

The description here emphasizes at this point why the first row of the scoreboard is advantageous. The first row singleton one at position E(Ip) points to the forwarding pipestage from the Previous Instruction Ip when the Dependent Instruction I0, now issued into the pipeline, has reached the receiving pipestage EN(I0) where I0 requires the data. The register file 1660 in this embodiment is unavailable to hold result data from Instruction Ip before instruction Ip reaches the write back pipestage at the end of the pipeline. In this particular embodiment, Instruction Ip writes into register file when the Instruction Ip is valid for write back and cannot be cancelled by exception, misprediction, or replay.

There are at least two reasons for having an embodiment that does not write back to register file immediately when the result data is produced.

First, results can be completed in different pipeline stages, if sourcing instructions were all allowed to write back to the register file immediately, then the register file could suitably be provided with a number of write ports equal to the number of sourcing execute pipestages. Where integrated circuit real estate and gates are preferably minimized, all other things being equal, then providing these multiple write ports is an albeit feasible but less desirable alternative. Instead, by pipelining the result through all the execute pipestages following the pipestage in which the result is generated, then only one (1) write port to register file is sufficient, and thus much more efficient of real estate and gates.

Second, for superscalar architectures, suppose an instruction in a second pipeline Pipe 1 can generate result data in the first pipestage E1 but another instruction in first pipeline Pipe0 is not completed until third pipestage E3. The instruction in first pipeline Pipe0 can suffer a branch misprediction, an exception, or a miss in a data cache which requires replay of the instruction in an architecture providing for replay. Accordingly, the instruction in second pipeline preferably is made to wait until the instruction in the first pipeline is valid for write back before writing into the register file.

Third, even for a single pipeline this consideration is important. Suppose an instruction in first pipeline Pipe0 is completed in the fourth pipestage E4, and an instruction in second pipeline Pipe1 (issued 1 cycle after instruction 0) is completed in the first pipestage E1. Then the second instruction is preferably prevented from being able to write back to the register file until the first instruction is valid for write back because the first instruction can cause misprediction, exception, or replay.

In the pipeline, the forwarding of a result from one pipestage to another pipestage in this embodiment happens inside one same clock cycle t. Forwarding is from an older instruction to younger instruction. The older instruction is at a later pipeline stage forwarding to an earlier pipeline stage for a younger instruction. For example, the older instruction at E2 pipeline stage suitably forwards to new younger instruction entering E1 pipeline stage. See FIG. 3.

In an architecture having a pipeline including first and second parallel pipes, as in FIG. 3, forwarding 1686 from a pipestage of the first pipe into the identical corresponding pipestage of the second pipe is provided for two instruction issued at the same time wherein the instructions are of such type that this forwarding is suitable for the instructions. For example, let two instructions I0 and I1 issue at the same time into parallel execution pipelines. The result of instruction I0 in stage E2 of the first pipe is required by instruction I1 which resides in stage E2 of the second pipe. Accordingly, the result of instruction I0 is suitably forwarded from stage E2 of the first pipe to the same stage E2 of the second pipe for consumption by instruction I1.

In one embodiment, dependent instruction I0 does not copy the upper row of the scoreboard and pipeline that copied upper row along with instruction I0. In due course, Instruction I0 monitors the upper row of the scoreboard itself when instruction I0 reaches its pipestage of need EN(I0). At pipestage EN(I0) instruction I0 determines the column position of the upper row singleton one representing the pipestage position of the sourcing instruction Ip.

In another embodiment of FIG. 9B, dependent instruction I0 does copy the upper row of the scoreboard, such as when instruction I0 is issued into the pipeline. This way, only candidate instructions access the original scoreboard shift register units. This confers simplicity by reducing the number of read ports.

Thereafter, cycle by cycle the copied upper row is shifted rightward in pipestage storage space and transferred down the pipeline from one pipestage to the next. The advancing position of the singleton one rightward in each pipestage storage space identifies the execution pipestage E(Ip) up ahead from which the required data is consumed by instruction I0 thereafter. When dependent instruction I0 reaches its pipestage of need EN(I0), the singleton one is by this time shifted rightward to point to the current pipestage position E(Ip) where sourcing instruction Ip now resides in the pipeline.

Advantageously, the instruction issue circuit of FIGS. 7A, 7B, 7C operates to issue the candidate dependent instruction I0 as soon as when issuance will permit the instruction I0 to travel down the execution pipeline so that when the instruction I0 reaches any given execution pipestage EN where an operand is needed from the one register file register identified to the source operand of the instruction I0, the sourcing (producer) instruction Ip will have reached the pipestage EA of first availability so that the operand will be available by data forwarding inside the pipeline itself from the pipestage position E(Ip) where the producer instruction Ip resides at that time. In other words, the issue control circuit operates to issue the dependent instruction I0 at a time prior to the forwarding of the data but sufficiently recently so that the data is actually available from the pipestage position E(Ip) pertaining to the producer instruction Ip when the dependent instruction I0 reaches the receiving pipestage such as EN.

When Instruction I0 is issued, then I0 tracks the upper row as a copy separate from the original scoreboard. When instruction I0 issues, control circuitry copies the top vector from the scoreboard that describes producer instruction Ip, and passes the top vector copy down the execution pipeline with I0. Then the pipeline operations move the top vector along with instruction I0 down the pipeline to the pipestage EN(I0) (e.g. pipestage E2) where instruction I0 needs the data from producer instruction Ip. Thus, in pipestage E2 that one (1) from the top vector copy is now available there for forwarding control. Then the later pipestage (e.g., E3) holding instruction Ip now forwards the data required by instruction I0 into pipestage E2 via path 1684 of FIG. 3. This forwarding occurs by virtue of instruction I0 identifying that later pipestage E3 using the singleton one (1) from the top vector copy that has been pipelined with instruction I0 down to pipestage E2. When the forwarding is completed and instruction I0 reaches the end of the pipeline, the control circuitry resets (throws away) the thus-pipelined top vector copy.

The reason that the singleton one in the top vector copy identifies the sourcing pipestage from Instruction Ip is that Instruction I0 has already been issued with appropriate timing by Equation (1) so that (and no sooner than when) the data will be available to Instruction I0 when Instruction I0 needs the data. Decoding of Instruction 10 earlier determined the pipestage in which Instruction I0 requires the data. The only information still needed is to identify the execution pipestage from which producer Instruction Ip will deliver the data.

It is this latter pipestage identification which the singleton one E(Ip) supplies from the top vector copy in the clock cycle when consuming Instruction I0 reaches the pipestage which is the predetermined pipestage EN(I0) in which the data is required.

Each pipeline is arranged so that when destination operand data is first generated in availability pipestage EA(Ip) by producer instruction Ip, then that same data is shifted clock cycle by clock cycle down the pipeline until the writeback pipestage is reached. The writeback stage finally actually writes the data thus generated by producer instruction Ip to the register file 1660 register to which the instruction Ip destination operand was coded to point. The scoreboard unit corresponding to that register file register is the same scoreboard unit which in the meantime had been tracking producer instruction position E(Ip) with respect to the operand thus destined for that register file register.

Now suppose the top vector points to pipestage E4 by the time the dependent instruction I0 will need the data even though first availability EA(Ip)=3 (pipestage E3) from the producer instruction Ip. This situation can occur when dependent instruction I0 has been delayed from issuance until data hazards in all of its multiple consuming operands have been resolved by using issuance Equation (1) or (3) in respect of every consuming operand. In this case, Instruction I0 should have the data sourced from pipestage E4 since the data will no longer be obtainable from execution pipestage E3. Thus, when dependent instruction I0 reaches pipestage EN (I0) wherein instruction I0 needs the data from Instruction Ip, the dependent instruction I0 simply monitors and uses the scoreboard upper row column E(Ip) to identify the current producer pipestage (e.g., E4 here) for forwarding control of the operand needed.

In an alternative embodiment, a respective counter is substituted for either or both of the shift registers of the scoreboard. Logic circuitry in place of muxes interprets the content of the counters as described herein.

The number of columns in the scoreboard is suitably established equal to the number of pipestages in the pipeline for which forwarding of instructions is to be improved. Alternatively, the number of columns in each scoreboard is made at least equal to the number of pipestages for which forwarding of instructions is to be improved, which may be less than or equal to the number of pipestages in the entire pipeline in which the pipestages reside.

It is apparent that every embodiment having rows and columns has a corresponding additional embodiment wherein the rows and columns are transposed so that columns of one embodiment perform functions of the rows of the other embodiment and vice-versa.

The number of columns in each scoreboard is suitably augmented on either the left or right, or both left and right in either or both rows of the scoreboard and for some or all of the registers. Bits are suitably provided in these columns of augmentation for associated instruction-related and pipeline control purposes, and the bits as described above are entered into intermediate columns and shifted through some but not all of the columns and with operations based on the principles disclosed herein.

In processors wherein an instruction is suitably issued into the middle of a pipeline, and where different instructions are issued into different initial pipestages of the pipeline, the singleton one for Previous Instruction Ip is correspondingly entered in the column of the first (upper) row of the scoreboard corresponding to the pipestage into which Ip is issued. Similarly the Dependent Instruction I0 is suitably issued into some pipestage other than the first pipestage. In such processors the equations are revised.

Recall that Equation (1) depends only on variables that at any given time do not explicitly involve the initial pipestage into which an instruction is issued:

D=(EA(Ip)−E(Ip))−EN(I0)+1 (1)

Notice that Equation (1) is equivalent to

D=(EA(Ip)−E(Ip))−(EN(I0)−1) (1A)

where the final one (1) in Equation (1A) corresponds to the assumed issuance of candidate I0 into the first pipestage.

Let EF(I0) symbolize the actual pipestage where I0 will be First issued, and replace the one (1) in Equation (1A) with EF(I0). EF(I0) is determined from decode of instruction I0. (When I0 becomes issued the upper row scoreboard column EF(I0) gets the singleton one.)

D=(EA(Ip)−E(Ip))−(EN(I0)−EF(I0)) (1B)

The candidate instruction I0 is issued to pipestage EF(I0) when delay D=0.

Scoreboards as disclosed herein are suitably implemented to service more than one pipeline at a time, and to operate on the same clock or on different clocks (meaning clock cycles generated by different clock generators). This improvement is particularly useful in the multiple pipelines of superscalar processors, in pipelines of processors and the pipelines of their one or more coprocessors, and in the pipelines of multiple-core processors.

Notice that logic “one” and “zero” as used in the exemplary description above, are illustrative of any particular logic level and its logical complement, and that reversed logic levels are suitably used in a given row of the scoreboard independent of any other row of the scoreboard, and suitably used in the scoreboard row for any given register independent of any other row for any other particular register.

Further, note that right shifting in the first (upper) row of the scoreboard, and left shifting in the second (lower) row of the scoreboard are arbitrary directions utilized in the description to conceptually relate the rows of the scoreboard to the pipestages and advantageous functions they perform. The physical orientation of the rows and directions of shifting relative to one another are not required to be the same as illustrated. In the physical implementation, adjacency of the cells to one another in the illustrated manner is not required. The cells may be physically scrambled or separated in physical order of their layout, but the electrical order as bits shift, as well as the manner of control operation is advantageously preserved. For instance, a single physical row of pairs of independently controlled bits is suitably operated to perform the functions of the two rows of the scoreboard.

Similarly, physical reversal of the first (upper) and second (lower) rows of the scoreboard is suitably provided in each pair of rows of the scoreboard independent of any other pair of rows of the scoreboard. Advantageously, one row of the scoreboard is associated with controlling the issuance of a dependent instruction I0 based on information in that row pertaining to a previously issued instruction Ip. Another row of the scoreboard is associated with identifying a particular pipestage from which the previous instruction Ip sources or forwards data required by the dependent instruction I0 when I0 has reached at least the first pipestage in which I0 first requires that data.

In the first (upper) row of the scoreboard, the singleton one is in other embodiments replaced with any configuration of logic levels wherein a single column position advancing across the first row can be detected. Accordingly, in one type of embodiment, the right-shifted first-row singleton one that is surrounded by zeroes in all other columns is replaced with don't cares (ones or zeroes) on the left and all zeroes on the right. A rightmost-one detector monitors the position of that right most one. This type of embodiment arranges the upper row of the scoreboard to have a configuration of logic levels wherein a single column position advancing across the first row is detectable, and wherein the upper row of the scoreboard has a series of identical logic level toward which an adjacent complementary logic level is shifted, and a detector for the adjacent complementary logic level monitors the position of that adjacent complementary logic level.

A second type of embodiment utilizes one or two incremented and/or decremented counters in place of either or both of the first row of the scoreboard and the second row of the scoreboard respectively. For example, the first row of the scoreboard has a singleton bit. In radiation-sensitive applications (e.g., alpha particles or gamma radiation), the singleton bit (one-hot) may be less preferable from a reliability point of view than a counter arrangement with parity checking of the counter representing the upper row. Although the counter arrangement may introduce more gates of counting and other logic than the upper row singleton one shift register approach, the choice between these two options is primarily based on the type of application as just noted. Indeed, this second type of embodiment is useful in a wide variety of applications. For instance, in place of a shift register approach, this second type of embodiment provides each lower row scoreboard unit with short-length counter of length suitable to accommodate the number of pipeline stages. For four pipeline stages, for one example, a two(2)-bit counter is loaded with a binary value representing pipestage of availability EA(Ip) and decremented each clock cycle to generate the value EL(Ip) as discussed in connection with Equation (3). The current counter value representing EL(Ip) for that scoreboard unit is coupled to a respective comparing circuit to respectively compare with a pipestage of need EN value corresponding to each given source operand SrcX of each candidate instruction, such as I0 and I1. Each comparing circuit outputs an active comparison signal result when EL(Ip) is less than or equal to the respective EN. A similar comparing circuit arrangement is provided for comparison of EL(Ip) less than or equal to EN(I1). The outputs of all of those comparing circuits for all the lower row scoreboard units are muxed out (e.g. 16:1 as in FIG. 7C) and fed to logic for issue control purposes as described later hereinbelow in connection with FIG. 7C.

A third type of embodiment relatively changes the states of one or the other or both of two circuits relative to one another in such a way as to permit a comparison that enables issuance of a dependent instruction. Each of the first and second circuits can independently be of a type chosen as shift register or counter or mux with variable mux selection. Basically, the idea of the third type of embodiment is to note from Equation (1)

D=(EA(Ip)−(E(Ip)−1))−EN(I0) (decrementing EA with E yields EL) (1′)

is essentially the same as

D=EA(Ip)−(EN(I0)+(E(Ip)−1)) (incrementing EN with E) (1″)

Thus the two approaches above are themselves in turn essentially the same as doing one step or the other of i) decrementing EA or ii) incrementing EN, in any given clock cycle. The control can be deterministic or even random control of which of step i) or ii) is performed in any given clock cycle. This feature is believed useful in security-oriented circuitry.

For instance, a “3A” third type of embodiment relatively decrements a first circuit clock cycle by clock cycle from a state that initially represents the pipestage EA(Ip) in which the result data is first available, relative to a second circuit that indicates the pipestage EN(I0) in which the result is first needed and then compares the circuits to determine when equality is occurring or already has occurred.

Moreover, a “3B” third type of embodiment increments the second circuit clock cycle by clock cycle from a state initially indicates the pipestage EN(I0) in which the result is first needed, relative to the first circuit continuing in a state that initially represents the pipestage EA(Ip) in which the result data is first available. This advantageously accomplishes the same function as above.

Further, a “3C” third type of embodiment relatively and alternately decrements the first circuit clock cycle by clock cycle from a state that initially represents the pipestage EA(Ip) in which the result data is first available, relative to incrementing the second circuit alternate-clock-cycle by every-other clock cycle from a state that initially indicates the pipestage EN(I0) in which the result is first needed. In other words, decrement the first circuit, then increment the second circuit, then decrement the first circuit again, then increment the second circuit again, etc. Or intersperse the decrements and increments in equal or unequal numbers in groups of any durations deterministically or randomly. Still further variations of this relative decrementing or relative incrementing are plain from the above.

A fourth type of embodiment uses fast logic without shift registers to first compute equation (2) followed by Equation (1):

EA(Ip)=EL(Ip)+E(Ip)−1 (2)

D=(EA(Ip)−E(Ip))−EN(I0)+1 (1)

Again, as soon as D becomes equal to zero, instruction I0 is issued if no other reasons to delay issue exist. This type of embodiment is useful where real estate is available for the fast logic. One-hot bits are obviated for high reliability and parity bits are used for error correction.

Discussion now turns to FIGS. 6, 7A and 7B which show an issue-loop in FIG. 6 and an embodiment for instruction issuance under scoreboard (lower row) control in FIGS. 7A and 7B.

In FIG. 6, the processor of FIG. 3 has an issue-loop circuit 1800 in decode pipe 1630. New instructions NEW INST0 and NEW INST1 are both entered into an instruction issue queue having two sections 1850, 1860 for different parts of each instruction. The first section, issue queue critical 1850, is provided for time-critical signals pertaining to an instruction. The second section, issue queue non-critical 1860, is provided for delay shifting of less-critical signals pertaining to the same instruction.

In queue stages within issue queue critical 1850 respective to different instructions, the issue queue critical 1850 operates to queue source (consuming) and destination (producing) operands, condition code source, and 1-hot bits for instruction type. The second section, issue queue non-critical 1860, operates to queue program counter addresses, instruction opcodes, immediates, and instruction type information respective to different instructions.

Issue queue critical 1850 suitably includes a register file structure with plural write ports and plural read ports. Issue queue critical 1850 has a write pointer that is increased with a number of valid instructions in a decode stage, a read pointer that is increased with a number of instructions issued concurrently to the execute pipeline, and a replay pointer that is increased with a number of instructions past a predetermined decode stage. The read pointer is set to a position of the replay pointer if a condition such as data cache miss or data unalignment is detected.

In FIG. 6, the issue loop circuit 1800 has an issue logic scoreboard 1700 (lower row) described further in FIGS. 7A and 7B, which selectively produces an IssueI0_OK signal at particular times that directs issuance of an Instruction I0 into execute pipeline Pipe0 1640 of FIG. 3. An AND-gate 1810 produces an IssueI1_OK signal at particular times that directs issuance of an Instruction I1 into execute pipeline Pipe1 1650 of FIG. 3.

AND-gate 1810 has inputs coupled to IssueI0_OK, to an instruction I1 related line 1815 from issue logic scoreboard 1700, and to an intradependency compare circuit 1820. Intradependency compare circuit 1820 prevents premature issuance of instruction I1, and this circuit 1820 is described further hereinbelow in connection with FIG. 8. Intradependency compare circuit 1820 is also herein called an operand identity checker circuit and is represented by a circled-equals-sign (=). Operand identity checker circuit 1820 performs a simultaneous instruction dependency check where instruction I0 produces an output to a register file register RN and instruction I1 as the Dependent Instruction requires an operand value input from the same register file register RN.

The lines IssueI0_OK and IssueI1_OK loop back to the selection control inputs of both of two muxes 1830.0 and 1830.1 to complete an issue loop path 1825. The two muxes 1830.0 and 1830.1 supply respective selected candidate instructions I0 and I1 to flops (local holding circuits) 1832.0 and 1832.1. The instructions I0 and I1 are each coupled to source and destination decoding circuitry in issue logic scoreboard 1700 and intradependency compare circuit 1820.

The flops 1832.0 and 1832.1 are updated by the muxes 1830.0 and 1830.1 respectively. The selector signals are established, for one example, according to TABLE 1.

TABLE 1
MUX SIGNALS

| Selector Signals | |
|---|---|
| (IssueI1_OK, IssueI0_OK) | Selected Mux Input |
| 00 | INC0 |
| 01 | INC1 |
| 10 | Not Permitted (AND 1810) |
| 11 | INC2 |

When the selector signals are 00, no instruction has just been issued out of either flop 1832.0 or 1832.1. The current contents of flop 1832.0 are fed back through the input INC0 of mux 1830.0 into flop 1832.0 again. At this time, the current contents of flop 1832.1 are fed back to a mux 1840 input 1840.1. In one case of selection at mux 1840, the input 1840.1 is then coupled to an input INC0 of mux 1830.1 and instruction I1 from flop 1832.1 returns back into flop 1832.1.

For incrementing one or two instructions when one or two candidate instructions I0 and I1 have just been issued, muxes 1830.0 and 1830.1 have their INC1 and INC2 inputs fed variously by muxes 1840, 1843 and 1845 as next described. Muxes 1840, 1843, and 1845 have more inputs fed from the Issue Queue Critical 1850.

In one case of operation when selector signals are 01, Instruction I1 from flop 1832.1 is fed via mux 1840 over to flop 1832.0 because only the candidate instruction I0 has just been issued out of flop 1832.0 and the contents of flop 1832.1 are the appropriate next instruction to be made a candidate for issue. READ INST0 is coupled through mux 1843 to input INC1 of mux 1830.1 to update flop 1832.1 to provide new candidate instruction I1. This is because READ INST0 supplies the next instruction in software program sequence.

In other cases when the selector signals are 01, the current contents of flop 1832.0 for candidate instruction I0 are updated via input INC1 from the output of mux 1840 either with the instruction at output READ INST0 of the queue 1850 or with NEW INST0 which is an input into the queue 1850. A selector input 1^{st} Valid Inst After I0 controls mux 1840. In this way, the next instruction for updating candidate instruction I0 is provided when the candidate instruction I0 has just been issued out of flop 1832.0.

Also, when the selector signals are 01, the current contents of flop 1832.1 for candidate instruction I1 are updated via input INC1 of mux 1830.1 coupled from the output of a mux 1843. Mux 1843 has inputs for the instruction at output READ INST0 of the queue 1850 or with NEW INST0 which is an input into the queue 1850. A selector input 2nd Valid Inst After I0 controls mux 1843. In this way, the next instruction for updating candidate instruction I1 is provided when the candidate instruction I0 has just been issued out of flop 1832.0.

When the selector signals are 11, the current contents of flop 1832.0 for candidate instruction I0 are updated via input INC2 of mux 1830.1 from the output of mux 1843 either with the instruction at output READ INST0 of the queue 1850 or with NEW INST0 which is an input into the queue 1850. Selector input 2nd^{st} Valid Inst After I0 controls mux 1843. In this way, the next instruction for updating candidate instruction I0 is provided when both candidate instructions I0 and I1 have just been issued out of flops 1832.0 and 1832.1.

Also, when the selector signals are 11, the current contents of flop 1832.1 for candidate instruction I1 are updated via input INC2 of mux 1830.1 coupled from a mux 1845. Mux 1845 has inputs for the instruction at output READ INST1 of the queue 1850, NEW INST1 which is an input into the queue 1850, and NEW INST0 which is an input into the queue 1850. A selector input 3rd Valid Inst After I0 controls mux 1845. In this way, the next instruction for updating candidate instruction I1 is provided when both candidate instructions I0 and I1 have just been issued out of flops 1832.0 and 1832.1.

In one case of operation when selector signals are 11, READ INST0 is coupled through mux 1843 to input INC2 of mux 1830.0 to update flop 1832.0 to provide new candidate instruction I0. Similarly READ INST1 is coupled through mux 1845 to input INC2 of mux 1830.1 to update flop 1832.1 to provide new candidate instruction I1. In this way, a parallel pair of queued instructions is moved into the flops 1830.0 and 1830.1 in one clock cycle.

In regular in-line code execution, mux 1840 selects the input coupled in from the output of flop 1832.1. Mux 1843 selects the READ INST0 input. Mux 1845 selects the READ INST1 input. Then depending on the scoreboard outputs Issue I0_Ok and Issue I1_Ok the code flows through the issue circuitry with the identified elections 1^{st} valid, 2nd valid, 3^{rd} valid, fed unchanged to muxes 1840, 1843, 1845.

For handling a pipe flush, different cases occur and these are appropriately handled by feeding NEW INST0 and NEW INST1 respectively to flops 1832.0 and 1832.1, or otherwise as appropriately handled by pipeflush control circuitry 1848. That circuitry 1848 provides the selector control signals 1^{st} Valid Inst After I0, 2^{nd} Valid Inst After I0, and 3^{rd} Valid Inst After I0.

Also, in FIG. 6, the outputs from Issue Queue Non-Critical 1860 are controlled by control circuitry 1865 which is fed by the issue control signals IssueI0_OK and IssueI1_OK. The less time-critical portions of instructions I0 and I1 are fed to decode circuitry 1870 for Decode Functions.

FIGS. 7A and 7B illustrate an issuance control circuit called Go/No-Go logic herein. As noted earlier, the second (lower) row 1720 of the scoreboard 1700 of FIG. 7 prevents premature issuance of the Dependent Instruction I0 if the producer Instruction Ip will not have provided the output identified to the register RN on which the Dependent Instruction I0 depends, by the time when the Dependent Instruction I0 requires that operand data even if that data is still in the pipeline.

FIG. 7B illustrates circuitry including AND gate 1965 which provides an output IssueI0_OK to issue a first Dependent Instruction (instruction I0) no sooner than when issuance will permit the Dependent Instruction I0 to travel down the execution pipeline successfully. For this purpose, successfully means that when the Dependent Instruction I0 reaches any given execution pipestage where the operand required from any register RN identified as a source (consuming) operand register by the source field(s) of Dependent Instruction I0, the data needed will have already been provided as an output of a producer instruction identified to that register RN even if that data is still in the pipeline.

FIG. 7B also illustrates circuitry including AND gate 1975 which provides an output IssueI1_OK to issue a second Dependent Instruction (instruction I1) no sooner than when issuance will permit the Dependent Instruction to travel down the execution pipeline successfully. In the case of instruction I1 in this dual-issue embodiment, successfully means that when the Dependent Instruction I1 reaches any given execution pipestage where the operand required from any register RN identified as a source operand register by the source field(s) of Dependent Instruction I1, the data needed will have already been provided as an output of a producer instruction identified to that register RN even if that data is still in the pipeline. For this purpose, a producer instruction not only includes any previously-issued instruction Ip in the pipeline but also the first instruction I0 described in the previous paragraph and wherein instruction I0 may be issuing concurrently with instruction I1. This type of producer instruction pertains in this embodiment only because this embodiment utilizes in-order issue and in-order execution. Other embodiments may operate differently.

### Writing the Lower Row of the Scoreboard

In FIG. 7A in this embodiment, a 4:16 decode 1930.0A and AND-gates 1935.xxi collectively form a 1:16 demultiplexer (demux) which is responsive to a selection control signal representing a destination register DstA I0 to route the FIG. 7B bit contents 1922.0A of Execution Availability EA decode 1920.0A to a particular one of the sixteen destination lower row scoreboard shift registers 1950.i. Indeed, in FIG. 7A there are four such collective 1:16 demultiplexers in this embodiment corresponding to decodes and gating for producer destination operands A and B for instructions I0 and I1 upon issuance, namely DstA I0 1910.0A, DstB I0 1910.0B, DstA I1 1910.1A, and DstB I1 1910.1B. Notice that in this and some other embodiments the number of shift registers advantageously exceeds the number of write multiplexers writing to them. The index i identifies a scoreboard unit shift register selected by each just-mentioned collective demux. Index i corresponds to and identifies destination register DstA I0, DstB I0, DstA I1, or DstB I1. Upon issue, a candidate instruction I0 changes role and becomes a producer instruction Ip on the scoreboard.

In a processor having an instruction that produces and delivers one or more resultands to multiple destination registers DstA, DstB (and as many additional destinations as the instruction provides), the 4:16 decoder 1930.0A is one of a plurality of 4:16 decoders to accommodate each destination. For example, suppose one instruction I0 has two 4-bit fields DstA, DstB respectively with bit-contents (0101, 1100) that as binary numbers point to the corresponding decimal-numbered register file registers R5 and R12 as the actual register file register destinations. Then when instruction I0 issues, at least two decoders 1930.0A and 1930.0B are provided and used to load second row scoreboard shift registers 1950.5, and 1950.12 respectively.

Notice that the Availability EA Decoders 1920 and Need EN Decoders 1985 described in connection with FIGS. 7A and 7B are responsive to the bits representative of or decoded from the respective instruction to be decoded itself. Indeed those decoders are responsive to the instruction bits as well as, or even instead of, the explicitly-shown four instruction operand bits identifying the register file register to which a given operand of the instruction pertains.

In this way, at hardware level, the bit pattern representative of a respective instruction in the instruction set architecture (ISA) of a given processor is decoded to determine the pipestage EA of first availability of data produced by a particular instruction being decoded. Each destination has its own Write Decode EA bits, meaning for example, that operand DstA can forward data as soon as when that instruction is in E3 pipestage, DstB can forward data as soon as when that instruction is in E2 pipestage.

Similarly, the bit pattern representative of a respective instruction in the instruction set architecture (ISA) of a given processor is decoded to determine the pipestage of first need EN of data to be consumed by a particular instruction being decoded.

In this embodiment and using the destinations R5, R12 example, note that in FIG. 7B I0 Write Decode (EA) bits 1922.0A pertain to a given destination operand DstA. Bits 1922.0A are loaded (written) only into a particular one shift register 1956.i to which the bit field of DstA points. Index i is 5 or 12 output from 4:16 decoders 1930.0A and .0B respectively. The series of one-bits to load to represent EA=E3 pipestage is “0011” from EA decoder. 1920.0A. The leftmost one is in column 3 because EA=E3. Compare to lower row 1720 of FIG. 4, cycle 1. The 4:16 decoder 1930.0A and AND-gate 1935.0A5 thus routes I0 Write Decode bits 1922.0A “0011” (E3) to the appropriate single corresponding shift register 1956.5 among the 16 scoreboard shift registers 1956.0-1956.15. This is because the DstA I0 bits correspond to a single register address R5 in the register file.

Similarly, a 4:16 decoder 1930.0B and AND-gate 1935.0B12 (ellipsis) route I0 Write Decode bits 1922.0B. If pipestage EA for destination DstB is E2, then a decoder 1920.0B generates bits 1922.0B as “0111” (E2). These bits are concurrently written to the appropriate single corresponding shift register 1956.12 as directed by 4:16 decoder 1930.0B and AND-gate 1935.0B12, because the DstB I0 bits correspond to a single register address R12 in the register file.

For instruction I1, there are another set of destination bit fields DstA I1 and DstB I1 and another set of operations of writing the destination bit fields of I1 to particular scoreboard shift registers 1956.i if instruction I1 is issued at the same time with instruction I0. Additional AND-gates 1935.1A0-1935.1A15 and 1935.1B0-1935.1B15 are qualified by the signal IssueI1_OK and are responsive to 4:16 decoders 1930.1A and 1930.1B to select the particular mux-flop 1950.i on and into which the write of I1 Write Decode EA bits, 1922.1A and 1922.1B are routed and performed.

Also, in the scoreboard logic of FIG. 7A, equality decoder blocks 1940i compare destinations of instruction I1 against destinations of instruction I0. If there is a match and instruction I1 is issued, then destination of instruction I1 has higher priority than instruction I0 to update the scoreboard register. To understand this, suppose the destination fields of I0 and I1 are compared and a match is found. In that case, instruction I1 is given first priority over the other instruction I0 to update the scoreboard shift register to which the matching destination fields both point.

Suppose the destination fields of I0 and I1 are compared and a match is found. In that case, and in this embodiment, instruction I1 is given first priority to update the scoreboard shift register to which the matching destination fields both point, instead of instruction I0. This approach is useful because the instruction I0 is earlier in the instruction flow of the software program than instruction I1. Since results of earlier instructions are used by later instructions in a software program, rather than the reverse, this priority assignment is appropriate.

Accordingly, in this embodiment, the scoreboard register keeps track of only the latest instruction Ip# in the pipeline for forwarding.

Each instruction in the pipeline is designated Ip# with number (“#”) representing the relative order of the instruction in the program. In other words, the latest instruction Ip# in the pipeline is designated with a higher number # even though that latest instruction resides in an earlier pipeline stage closer to the point of issue and not in a later pipeline stage that would be closer to the end of the pipeline. Each candidate instruction for issue is designated I# followed by a number representing its own relative order in the software program flow.

Note that the subsequent instruction only cares about the latest dependency.

### Example:

Ip0 R0<-R1, R2 - - - the scoreboard for R0 is set up

. . . .

Ip5 R0<-R5, R6 - - - the scoreboard for R0 is overwritten
by Ip5 instruction

. . . .

I0 R0<-R2, R3 - - - Not update scoreboard for R0 at all if I1 issues concurrently with IO

I1 R0<-R3, R4 - - - the scoreboard for R0 is overwritten by I1 if I1 issues concurrently with I0.

I2 R5<-R0, R2 - - - I2 cares for forwarding from
I1=scoreboard of R0

The scoreboard is overwritten with no bad effect from a hardware viewpoint because there would have to be a software error for there to be any such bad effect. When a dependent instruction (i.e., an instruction with a read operand the same as the producer instruction output operand) enters the pipeline that dependent instruction in a correct program flow precedes any subsequent producer instruction that would overwrite the scoreboard.

The scoreboard remarkably and advantageously accommodates multiple instructions proceeding down and active in not just one pipeline but multiple pipelines concurrently. Generally speaking, the number of instructions can be as great as a number arithmetically equal to the sum of all the pipestages in all the execution pipelines into which instructions are issued. The disclosed circuitry increases the instruction efficiency (instructions per cycle throughput) of the processor by keeping all the pipelines as full as possible. As each such instruction is issued into the execution pipeline, the circuitry makes entries on the scoreboard shift registers 1956.i corresponding to each register file register i for which that instruction has a destination operand.

In a two-issue superscalar processor, as many as two instructions can be issued per clock cycle, and in that case two sets of Write Decode bits 1922.0x and 1922.1x (for I0 and I1) are latched into the scoreboard per cycle. All the information relating to the location of each such previous (issued) instruction and which clock cycles (pipestages) have valid results are captured in the first and second rows of the scoreboard. The shift mechanism of the scoreboard (upper row shift right singleton one for location and lower row shift left ones for valid result) thus keeps track of all previous producer instructions in the pipelines.

Subsequent instructions prior to issue and entering a pipestage are governed by the issue logic of FIGS. 7B and 7C. The issue logic of FIGS. 7B and 7C in effect looks at the scoreboard and remarkably and advantageously checks for dependency on not one but all previous instructions in the pipeline, and does not issue any subsequent instruction prior to all conditions on issuance being met as described herein. This is an important advantage of the scoreboard improvements.

If no dependency occurs for a while and no new instruction is issued to update a particular scoreboard unit that previously had been written, then the upper row becomes all zeroes and the lower row becomes all ones. The candidate instruction has no data hazard and will obtain the operand from the register file register corresponding to that scoreboard unit.

In FIG. 7B, the circuitry has a set of shift registers 1950.i. The shift registers are indexed in FIG. 7B with the letter “.i” to represent each respective second row 1720 of a scoreboard unit of FIG. 4 for each of the register file registers. In other words shift registers 1950.i are a physical realization in FIG. 7B of the second row 1720 of the scoreboard of FIG. 4.

In FIG. 7B, for example sixteen shift registers 1950.0, 1950.1, . . . 1950.i, . . . 1950.15 are suitably provided to instantiate sixteen second rows 1720 corresponding to sixteen register file registers respectively. Each of the column cells 1956.i.1, 1956.i.2, 1956.i.3, . . . 1956.i.(M−1) corresponds to a respective pipestage in the pipeline being scoreboarded, less the last pipestage.

Upon issue of a latest instruction, the particular shift register 1950.i that is loaded with information corresponds to the entry in Instruction destination operand block 1910.xx. In the example, if the DstA I0 entry is “0101,” then DstA I0 1910.0A points to register R5, and shift register 1950.5 among the sixteen (16) registers 1950.0-.15 is the shift register which becomes active via line a line 1952.0A5. When Instruction I0 has multiple destination registers DstA I0, DstB I0, etc, those destination identifiers like “0101” respectively select additional corresponding ones of the 16 architectural registers 1950.0-1950.15 for input. In this way, every register in the register file which is being sourced by a an issuing instruction at any pipestage in the pipeline, has a corresponding circuit 1950.i actively providing second row scoreboarding in FIG. 7B.

In the go/no-go scoreboard Decode I0 Write decoders 1930.0A, .0B, .1A, .1B, suppose instruction I0 has destination operands DstA and DstB, and instruction I1 has its own destination operands DstA and DstB. All these destinations Dst potentially have different pipestages of first availability EA but some same destination registers. Accordingly, multiple write ports (e.g., four write ports in this example) for the lower-row scoreboard units 1950.i are provided.

The possibility of a simultaneous write is typified by a case wherein different destination operands DstA I0 and DstA I1 point to the same register file register, say R5. To handle this situation the destination register identifier bits DstA I1 are compared against DstA I0, e.g., those of I0. If they match (same), and IssueI1OK is active, then one of a set of priority decoders 1940.i gives priority to instruction I1 to update the lower-scoreboard unit selected by DstA I1 4:16 decode 1930.1A.

Sixteen sets of four 5:1 muxes 1954.i in the mux-flops of the shift registers have their selector circuitry responsive to sixteen decoders 1940.i responsive to sixteen sets of four WriteEnable lines 1952.0Ai, 1952.0Bi, 1952.1Ai, and 1952.1Bi. Index i goes from zero to fifteen.

Returning to FIG. 7A, the Write Enable lines 1952.xxx are fed by the output of respective AND-gates 1935.0Ai, .0Bi, .1Ai, .1Bi. AND-gates 1935.0Ai has a first input coupled to output i of 4:16 decoder 1930.0A, and a second input coupled to line IssueI0_OK. AND-gate 1935.0Bi has a first input coupled to output i of 4:16 decoder 1930.0B, and a second input coupled to line Issue I0_OK. AND-gate 1935.1Ai has a first input coupled to output i of 4:16 decoder 1930.1A, and a second input coupled to line Issue I1_OK. AND-gate 1935.1Bi has a first input coupled to output i of 4:16 decoder 1930.1B, and a second input coupled to line Issue I1_OK.

The priority circuitry has four write enable lines 1952.xx5 going to the decoder 1940.5 that feeds selector controls to muxes 1954.5 in mux-flop shift register 1950.5. Those four write enable lines are designated 1952.0A5, .0B5, .1A5, .1B5. Every mux 1954.5 has four inputs for EA decode bits 1922.0A, .0B, .1A, .1B, plus a fifth input for the bit series of advancing ones in cascaded flops 1956.xx fed from right by one-line 1953. One of the five inputs is selected by every mux 1954.5 as directed by decoder 1940.5.

The sixteen identical prioritization decoders 1940.i have output lines for prioritized selector control of all m of the muxes 1954.i.m in each shift register 1950.i. (Index m goes from 1 to M−1 pipestages.) Each decoder 1940.i illustratively operates in response to the 1 or 0 outputs of AND-gates 1935.xxi according to the following TABLE 1. Due to the parallelism in each shift register 1950.i and the structure of Table 1, the logic for this muxing 1940.i is readily prepared by the skilled worker to implement Table 1.

TABLE 1

| Write Enables 1952.xxx | Write Decode Bits (EA) |
|---|---|
| (.0Ai, .0Bi, .1Ai, .1Bi) | from 1922.xx or from flops 1956 |
| 0000 | Output of next-right flop |
| | 1956.i.m + 1 or One-line 1953.i |
| 0001 | .1Bi |
| 0010 | .1Ai |
| 0011 | error in I1 |
| 0100 | .0Bi |
| 0101 | .1Bi (priority) |
| 0110 | .1Ai (priority) |
| 0111 | error in I1 |
| 1000 | .0Ai |
| 1001 | .1Bi (priority) |
| 1010 | .1Ai (priority) |
| 1011 | error in I1 |
| 1100 | error in I0 |
| 1101 | error in I0 |
| 1110 | error in I0 |
| 1111 | error in I0 and I1 |

For example, the Table 1 row (0000, One-line 1953.i) signifies no writing of a scoreboard unit i, but instead clocking an already stored set of zeroes and ones to the left on that lower row scoreboard unit. Each flop in unit 1956.i.m receives the contents of the next-right flop 1956.i.(m+1). Flop 1956.i.(M−1) receives the one (1) from one-line 1953.i.

Table 1 rows (0001, .1Bi), (0010, .1Ai), (0100, .0Bi), (1000, .0Ai) signify respective simpler cases where just a single Write Enable line 1952 is active and so there is no prioritization issue. That write enable line controls the mux 1954 selection. For example, in the case (0001, .1Bi), the output of decoder 1940.i causes muxes 1954.i to select the bits 1922.1B out of the four sets of bits 1922.0A, .0B, .1A, .1B.

Prioritization is active in the four cases specified by Table 1 rows (0101, .1Bi), (0110, .1Ai), (1001, .1Bi) and (1010, .1Ai). Here, both instruction I0 and I1 are using the same register for a destination. Instruction I1 is given priority because it identifies, and is treated by this hardware embodiment as, the later instruction in software program sequence. For example, in the case (0101, .1Bi), instruction I0 Destination B and instruction I1 destination B point to the same shift register 1950.i. Prioritization decoder 1940.i causes muxes 1954.i to select the bits 1922.1B and not the bits 1922.0B.

It is emphasized that candidate instruction(s) are only entered on the scoreboard once, when they are enabled to issue. The prior determination of whether to issue a candidate instruction is further described next.

### Controlling Instruction Issue by Reading the Lower Row Scoreboard

Instruction designations I0 and I1 represent the current two candidates for issue in this embodiment. Instructions I0 and I1 are issued at the same time unless there is some reason to issue sequentially, as in the case of intradependency described in connection with FIG. 8 hereinbelow. Instructions I0 and I1, prior to issue, each read the scoreboard, as it were, for bits that are set by previous (producer) instructions “Ip” already in the pipeline. Neither instruction I0 nor instruction I1 has any data in the scoreboard since I0 and I1 are still candidates for issue, they are as yet un-issued.

Once an instruction is issued free of any dependency issue, its location in the pipeline is entered into the upper row of the scoreboard in the respective scoreboard unit 2220.i pertaining to each destination operand DstA, DstB. If more than one instruction is issued on the same clock cycle, all the destination operands for both instructions are used to identify respective scoreboard units for entry. See description of FIG. 9 later hereinbelow.

Concurrently, a series of ones representing the valid-result-cycle EA decoded by decoder 1920.xx from the type of instruction for each destination operand of the instruction is also entered in the lower row of the scoreboard in the respective scoreboard unit 1950.i pertaining to each destination operand DstA, DstB. This entry is subject to prioritization. See description of FIG. 7A hereinabove.

Corresponding information about all the previous instructions in the pipeline have at this point been stored in the upper and lower rows of appropriate scoreboard units in analogous manner earlier. Once the information for an instruction entering the pipeline is entered into the scoreboard, that instruction takes the role of a “previous instruction” also, for purposes of the scoreboard recordkeeping. In this embodiment, a previous instruction does not access the scoreboard 1950 once that previous instruction has been issued, although this restriction may be relaxed for various purposes in other embodiments.

Now the description proceeds further in FIG. 7B and then on to FIG. 7C to describe the manner of reading the scoreboard lower row(s) 1950.i to control instruction issue in the first place.

Each column cell in each second row shift register 1950.i is designated 1956.i.1, 1956.i.2, . . . 1956.i.m, . . . 1956.i.(M−1). Shift register index i goes from zero (0) to number of register file registers less one (e.g., 16 registers minus one equals 15). Shift register column cell index m goes from one (1) to the number of execution pipestages less one (e.g., five stages minus one equals four equals (M−1)). Thus, the number (M−1) of column cells in each second row (lower row) shift register 1956.i is one less than the number of M pipestages to be tracked.

Each bit in each column cell m is provided to a respective input of each of eight M:1 read port multiplexers including four such muxes 1958.iA, 1958.iB, 1958.iC, 1958.iD for instruction I0 and four more such muxes for instruction I1 beneath each i-th shift register block 1950.i. In addition, the constant bit, one (1) 1953, is supplied to the last input of each of those read port muxes 1958.xx. Those read port muxes 1958.xx are provided for each shift register 1950.i to correspond in number to the largest number of source operands of any instruction in the instruction set of the processor. In this example, four source operands SrcA, SrcB, SrcC, SrcD are assumed. In this example, the total number of read port muxes 1958.iA,B,C,D is 4 source operands times two instructions I0, I1 (number of simultaneous instruction issue for the processor) times 16 shift registers 1950.i equals 128 (one hundred twenty-eight) of those read port muxes 1958.iA,B,C,D.

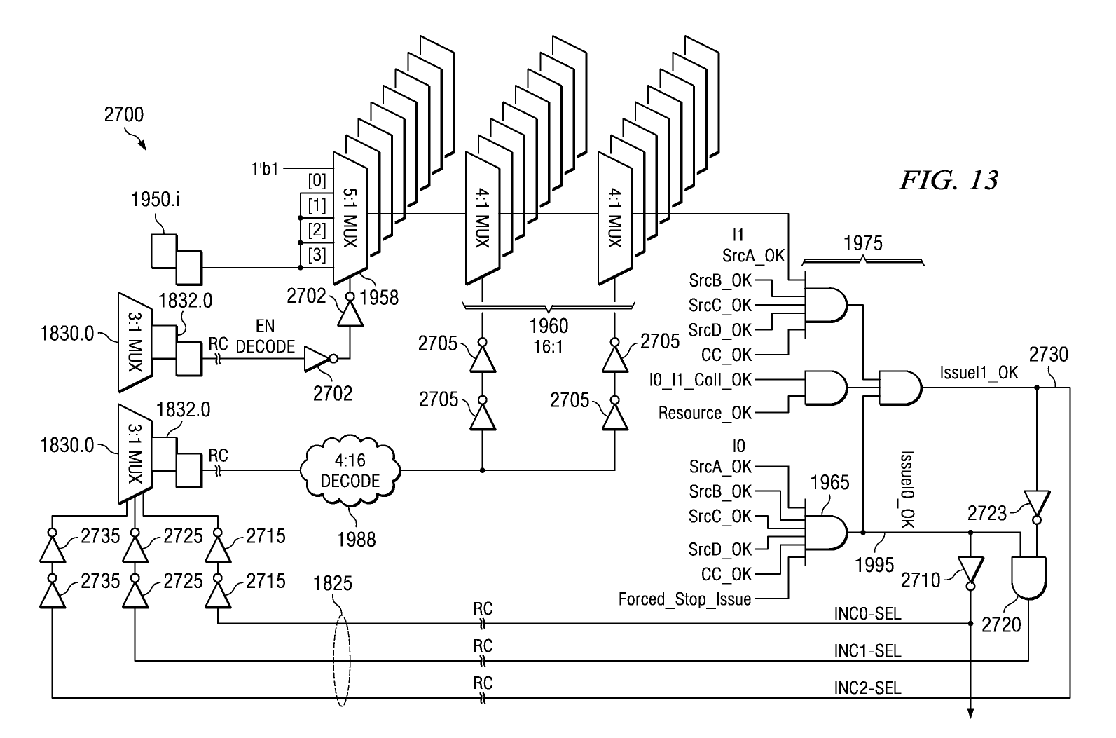

Notice that if the pipelines each have M execute pipestages (e.g. 5), then a fewer number (M−1 equals four) shift register cells are advantageously used in the lower row (go/no-go) scoreboard shift registers 1958.i. The reason (as shown and described later hereinbelow in connection with FIGS. 7B and 13) is that one of the pipeline stages being tracked (usually the last pipestage) is often a writeback pipestage.

In this embodiment, there is always a “one” (“1”) conceptually in the scoreboard unit for the writeback pipestage, and that “one” (“1”) is the rightmost one in the series of ones in lower row 1720 of FIG. 4. Accordingly, there is no need to provide a lower-row scoreboard shift register cell for the writeback pipestage, since a “1′b1” line for the constant one-bit 1953 can simply be delivered instead to the muxes 1958.xx, and save some scoreboard real estate on-chip. If the result is produced in execution pipestage E5, then “0000” is written to initialize the lower-row scoreboard unit 1950.i for the destination.

Also, in this embodiment for the go/no-go (lower row) scoreboard, the number of mux inputs to muxes 1958.i can be even further reduced in some but not all cases. Suppose that dependency checking is needed in a particular processor only for the first three (3) execute pipeline stages because no instruction has a source operand that consumes data after the first three execute pipeline stages. That means that the number of mux inputs to muxes 1958.i can be three, because only the leftward three flop outputs of the shift register flops 1956.i correspond to those first three execute pipeline stages to be checked.

In this special case of lower row scoreboard dependency checking for only the first three execute pipeline stages, the number of lower row shift register stages remains at four in some cases and can be reduced in other cases. For instance, suppose further that some instructions first produce destination operand data DstA or DstB in the fourth and fifth execute pipeline stages. Then in such case, four lower row scoreboard shift register stages 1956.i are suitably used, because the destination operand DstA or DstB for fourth or fifth execute pipestage calls for four bits to initialize of that shift register with “0001” or “0000.” The right most (M−1) shift register flop 1956.i.4 then shifts left with each clock cycle. When a one “1” reaches the third shift register flop 1956.i.3 (“0011” in shift register) then the reduced three-input mux 1958.i will see that one “1” and dependency will then be no concern.

If, however, no instruction first produces destination operand data later than the (M−1)-indexed pipeline stage then the right most (M−1) shift register stage can be omitted, so that there are now M−2 shift register stages (FIG. 7B) in the lower row. The number of upper row stages in FIG. 9 is suitably unchanged in this case.

In FIG. 7C, description now turns to further read selection processes and structures. Note that each read operand of the instruction I0, and each read operand of the instruction I1, can have different pipestages of first need EN. For example, instruction I0 can have read operands A, B, C, and D designated SrcA, SrcB, SrcC, SrcD. Read ports for operand A and B of that instruction I0 might select column E1, read port for operand C might select column E2 and read port for operand D might select column E3. Analogous and further example comments can be made about instruction I1 but are omitted for brevity. Decoders 1985.xx provide this information about pipestages of first need and supply them on control lines called ReadPort control lines herein.

Each M:1 multiplexer 1958.iA,B,C,D makes a selection specified by control lines designated ReadPort0A, 0B, 0C, 0D, 1A, 1B, 1C, 1D herein. Each ReadPort control line designates the column number of the scoreboard unit 1950.i corresponding in Equation (3) to the first pipestage EN(I0 or I1) at which candidate Dependent Instruction I0 or I1 requires data from the register file register i identified by a particular 4-bit source operand (e.g. SrcA of instruction I0).

The ReadPort lines are supplied with signals as follows. Registers 1980.0A, 0B, 0C, 0D, 1A, 1B, 1C, 1D identify each register file register associated with a consuming operand SrcA,B,C,D in instruction I0 and in Instruction I1. Each instruction I0 and I1 and the contents of the registers 1980.xx is decoded by corresponding decoders 1985.xx which produce selector control signals for muxes 1958.i representative of the pipestage of first need EN of that instruction and operand.

The selection specified by control lines ReadPort0A is fed to all of the muxes 1958.iA (e.g., all sixteen of them) for instruction I0. The selection specified by decoder 1985.0B output lines ReadPort0B is fed to all the muxes 1958.iB (all sixteen) for instruction I0. The selection specified by similar decoder 1985.xx output lines ReadPort0C, 0D, 1A, 1B, 1C, 1D is respectively fed to all the rest of the muxes 1958 in groups each equal in number to the number of register file registers (e.g., sixteen).

Eight sets of sixteen (16) 5:1 multiplexers 1958.iA, 1958.iB, 1958.iC, 1958.iD (for instructions I0 and I1) of FIG. 7B each have sixteen one-wide outputs per set fed to a corresponding 16:1 multiplexer among eight muxes in FIG. 7C. For Instruction I0 these 16:1 muxes are designated 1960.0A, 1960.0B, 1960.0C, 1960.0D. For Instruction I1 these muxes are designated 1960.1A, 1960.1B, 1960.1C, 1960.1D. (Corresponding, but actually separate, lines for instruction I1 muxes 1960.1x are only diagrammatically passed through the 1960.0x muxes for conciseness in FIG. 7C.) The four 16:1 multiplexers for each of Instructions I0 and I1 correspond to the four respective source operands SrcA, SrcB, SrcC, SrcD, etc. of each instruction I0 and I1 in this example.

In FIG. 7C, selection controls for the 16:1 muxes 1960.xx are supplied with signals as follows. The source operand register identification bits in the registers 1980.0A,0B,0C,0D,1A,1B,1C,1D are respectively decoded 4:16 by corresponding decoders 1988.0A,0B,0C,0D,1A,1B,1C,1D. These decoders 1988.xx in turn produce the selector control signals for muxes 1960.xx to choose the output from a corresponding one of the read muxes 1958.i and thereby recover the special zero or one representative of whether a dependency is not OK, or is OK, respectively. In this way, the appropriate lower row scoreboard unit is read.

So, for example, suppose a Mux 1958.5A for Instruction I0 is controlled by the signal on selector control line ReadPort0A to look for a one (1) in the third column cell 1956.53 (EN=3) of the shift register 1950.5. Presence of that “one” would signify that data destined for register file register 5 will be ready for instruction I0 source operand SrcA to consume in the third execution pipestage E3. Suppose that the “one” is present. That “one” is output from mux 1958.5A for Instruction I0 and fed along with all the other mux 1958.iA outputs to the 16 input mux 1960.0A for Instruction I0 SrcA.

The control to mux 1960.0A is supplied by lines 1989.0A carrying the bits identifying the register for operand SrcA of instruction I0. For example, if the SrcA register is R5 for operand SrcA, then the control lines 1989.0A from 4:16 decoder 1988.0A to mux 1960.0A supply “0101” (binary equivalent to decimal “5”). In other words decoder 1988.0A supplies a selector control signal on lines 1989.0A instructing mux 1960.0A to select the output from mux 1958.5A for Instruction I0. That output is “one” in this example.

Mux 1960.0A couples that “one” to its output line SrcA-OK which is connected to an input of an AND-gate 1965. AND-gate 1965 also has analogous inputs SrcB-OK, SrcC-OK, SrcD-OK from the muxes 1960.0B, 1960.0C, 1960.0D. If the instruction I0 in a particular case has fewer than four consuming operands, then the inputs for the unused SrcD-OK, SrcC-OK for instance are OR-ed with overriding signals from the corresponding decoder 1985.0x by straightforward circuitry based on the teachings herein abbreviated from FIG. 7C for conciseness.

Mux 1960.1A has output line SrcA-OK for Instruction I1 connected to an input of an AND-gate 1975. AND-gate 1975 also has analogous inputs SrcB-OK, SrcC-OK, SrcD-OK from the muxes 1960.1B, 1960.1C, 1960.1D. If the instruction I1 in a particular case has fewer than four consuming operands, then the inputs for the unused SrcD-OK, SrcC-OK for instance are OR-ed with overriding signals from the corresponding decoder 1985.1x by straightforward circuitry analogous to that for Instruction I0 and abbreviated from FIG. 7C for conciseness.

Suppose a producer instruction has passed entirely through the execute pipeline and completed a writeback to its destination register and no new producer instruction has been issued that writes to that destination register. In that case the upper row scoreboard will be all zeroes, and the lower row scoreboard 1950.i will have all ones when the candidate instruction source operand (e.g. I0 SrcA) interrogates the scoreboard. In such case, the logic of FIG. 7C responds to the lower row 1950.i and makes SrcA-OK high at AND-gate 1965. When instruction I0 is issued it can read directly from the appropriate register file register identified by the SrcA consuming operand instead of using FIGS. 9, 10, 11, 12 data forwarding within the pipeline.

Other conditions, such as a low-active RESET-bar, and a low-active PIPEFLUSH 1848 control line from FIG. 6, are fed to further inputs of AND-gates 1965 and 1975. The input IntradependencyOK to AND-gate 1975 is discussed elsewhere herein in connection with FIG. 8.

A few summary remarks about FIGS. 7B and 7C are made next.

In FIG. 7B, to initialize column cells 1956.i.1, . . . 1956.i.(M−1), these column cells are parallel loaded with the series of ones discussed in connection with scoreboard lower row FIG. 4. (All the other row cells leftward are zero left of the ones). The first pipestage represented by the first one (1) at left in the lower row, the leftmost one, is found by searching from left in the second row 1720 or simply by muxing 1958.0x. There is at least one “one,” and all the ones are contiguous and to the right of all zeroes in each lower row scoreboard unit shift register 1950.i. After the initial parallel write, the circuit shifts FIG. 4 second row 1720 left cycle-by-cycle, and “1” 1953 is continually entered into the shift register 1950.i of FIG. 7B.

At this point of the description of FIG. 7B, consider another example. Suppose mux 1958.5 is controlled by signal ReadPort1A to select the cell 1956.5. ReadPort1A and supply the bit state of that cell in 1956.5. identified by ReadPort1A for output from mux 1958.5. Conceptually, the candidate Instruction I1 is “looking for” a one (1) value of EN in that cell to signify that there is no objection based on dependency pertaining to register R5 to issuing instruction I1 into an execute pipeline. Because a series of ones are being left-shifted through shift register 1956.5, there will be a certain clock cycle at which the leftmost one of the scoreboard will reach or have reached that cell identified by ReadPort1A. Because in this embodiment, a series of ones trail the leftmost one in every cycle thereafter, there will be a “one” (1) in that cell beginning in that certain clock cycle and continuing therein every relevant clock cycle thereafter.

Note that a “one” (1) output as signal SrcA-OK from mux 1960.1A only provides a no-objection based on a data dependency check on operand SrcA of Instruction I1 to AND-gate 1975 issuing Instruction I1. In other words SrcA-OK lifts a veto or provides only one enable among other required enables that AND-gate 1975 needs to produce an output high and issue Instruction I1. If the data dependency issues are not resolved in this clock cycle, Instruction I1 may only be issued one or more clock cycles thereafter when all the potential data dependency questions are indeed resolved as determined by scoreboard reads by muxes 1958 and 1960, and intradependency OK and Other Conditions.

Advantageously, providing and left-shifting a series of ones in the lower row 1720 of the scoreboard of FIG. 4, and not just a singleton one, confers a simplicity of design in this embodiment that generalizes to dependencies pertaining to multiple consuming operands of the dependent instruction.

Furthermore, the use of the multiplexers 1958.xx provides a real-estate efficient and power efficient implementation of Equation (3). Equation (3) earlier hereinabove is written as a subtraction operation and issuance is permitted if the result D of Equation (3) is zero or negative. The multiplexers 1958.xx remarkably and advantageously facilitate the instruction issuance process utilizing the special left-shifting series of ones in the lower row of the scoreboard and the decoded information from the dependent instruction identifying the pipestage in which the dependent instruction will first need the data in register file register Ri.

Advantageously and remarkably, the lower row scoreboard shift registers 1950.i do not need to be replicated for multiple instructions, multiple destination operands and multiple source (consuming) operands. Instead these matters are handled by appropriate replication of write ports and read ports as shown in FIGS. 7A, 7B and 7C. Provision for the destination DstA, DstB, etc., operand(s) of instructions I0 and I1 are not necessary to control selections in 1958.xx and 1960.xx read multiplexing here since the destination operands of these candidate instructions I0, I1 result from the source Src operands which are already accounted for in FIG. 7C.

In the case of a single issue instruction machine, the diagram of FIG. 7B explicitly shows three (3) lower-row scoreboard registers out of sixteen (16) such registers. The diagram of FIG. 7A, 7B explicitly shows one (1) write port for candidate instruction I0 out of two (2) or more write ports for additional destinations such as DstB of candidate instruction I0. Because of single-issue, there is no instruction I1 and logic for I1. By write ports here, what is meant is providing a WriteEnable0A, 0B, etc. 1952.xxx to load bits 1922.0A, 0B into shift registers in the shift register group 1950 when candidate instruction I0 has more than one destination register DstA, DstB, etc., to which instruction I0 provides results. Read ports 1958.x, 1960.x in FIGS. 7B and 7C are provided equal in number to the largest number of source operands that any single instruction has in the instruction set.

For a dual-instruction-issue machine, additional write ports and read ports are provided for Instruction I1 as well. This doubles the number of write ports and doubles the number of read ports. In general, in this category of embodiment the ports are straightforwardly multiplied by the number of multiple-instruction-issue of the architecture. Two or more simultaneously-issued instructions are thereby accommodated. In this way, architecture upgrade is readily based on the teachings herein. Ad hoc tangled mishandling of architecture upgrade is advantageously avoided.

Suppose that instruction I0 is issued, but instruction I1 must wait a cycle because of a dependency. Refer to the descriptions of FIG. 7C and FIG. 6. When the instruction I0 is issued, the scoreboard is updated with the appropriate information about the instruction I0. The instruction I1 is fed back in FIG. 6 by muxing input INC1 and now becomes the new instruction I0 in flop 1832.0. A subsequent instruction becomes the new instruction I1 in flop 1832.1 as described and shown in FIG. 6. New instruction I0 interrogates the scoreboard and old instruction I0 has now been issued and become a producer instruction on the scoreboard.

If no dependency occurs for a few instructions, meaning no overlap of registers to check, the newly issued instruction taking the role of Previous Instruction is entered on the scoreboard and the scoreboard is shifted right in the upper row and left in the lower row until some candidate instruction does show up in one of the flops 1832.0 or 1832.1 in FIG. 6 and a dependency is thereupon detected on the scoreboard. Then the Go/No-Go logic of FIGS. 7A, 7B and 7C prevents or issues the new candidate instruction as a Dependent Instruction depending on whether the scoreboard circuitry allows issuance.

In FIGS. 7A, 7B, 7C, each producer instruction Ip has a destination operand DstA, DstB, etc. identified to a register file register. The candidate instruction I0 or I1 has a source operand identified to the same said register file register. The scoreboard issue logic circuitry (e.g., gates 1965, 1975) responds to the read multiplexer circuitry 1958 to issue the candidate instruction I0 or I1 as soon as when issuance will permit that instruction to travel down the execution pipeline so that when that instruction reaches any given execution pipestage EN where an operand is required from the register file register identified by that instruction, the data needed will be available from the producer instruction Ip with destination operand identified to that register file register even if and though the producer instruction Ip is still in the pipeline.

AND-gate 1965 advantageously operates to prevent issuance of the Dependent Instruction I1 from AND-gate 1975 until the information derived from the second rows of the scoreboard establishes that Dependent Instruction I1 will have any and all the data dependencies of its source operands resolved by the time Dependent Instruction I1 reaches each pipestage where it requires the particular data for each given one of its source operands. In other embodiments not involving the in-order issue of FIG. 7C, the logic is suitably revised to not prevent such issuances. In addition intradependency checking of instruction I1 relative to instruction I0 is also accomplished as described in connection with FIG. 8 next.

### Intradependency Muxing

In FIG. 8 each register designated in source operands Src A,B,C,D of instruction I1 is compared to destination register designated in destination operands DstA and DstB of instruction I0. The condition for stalling is: a SrcA, B, C, or D source operand register of instruction I1 matches a DstA or DstB destination operand register of instruction I0 and result is not available in time for consumption if candidate instruction I1 issuance were to occur immediately.

In FIG. 8, the initial series of FIG. 4 lower row logic bits 1735 pertaining to the Previous Instruction I0 (“I-Zero”) are supplied to a register 2028.0A by instruction EA decode 2025.0A. The logic bits 1735 represent and identify which pipestage is the first, or lowest-numbered, pipestage at which the results of the Previous Instruction I0 become valid. From register 2028.0A the logic bits 1735 are respectively coupled to the corresponding inputs of a mux 2060.AA. Mux 2060.AA selector controls are derived from Dependent Instruction I1 (“I-One”) Use Decode.

A purpose of Mux 2060.AA is to detect as between candidate instructions for simultaneous issuance whether instruction I0 would, once issued in the pipeline, write necessary data as soon as or before the other instruction I1 under condition of simultaneous issuance would need it. I1UseDecode control signal to Mux 2060.AA thus points to the earliest pipestage from which I1 needs to use the operand written by instruction I0. Conversely, I0WriteDecode entry 2028.0A leftmost-one points to the earliest pipestage EA from which the data will be available. Shifting of bits 2028.0A is not involved in FIG. 8.

Decode block 2035.1A (explicitly shown), 2035.1B, 2035.1C, and 2035.1D are fed by four-bit lines from each corresponding block 2030.1A,B,C,D identifying the respective register for a source operand of the instruction I1 as a consuming instruction. The result of this decode 2035.1A represents the pipestage of first need EN by I1 for data at the SrcA register. The output of this decode 2035.1A is fed to the select control input of mux 2060.AA. Other terminology used for this decode 2035.1x is “I1UseDecode” herein, and this function corresponds to the EN decode blocks 1985.1A, B, C, D (or 1985.1x) of FIG. 7B. Each decode 2035.1x is suitably identical with and obtained from the EN decode blocks 1985.1x. These decodes are also called “Read Port 1” herein for instruction I1. In FIG. 8, the I1UseDecode in effect selects the bit column for reading one selected bit from bits 2028.0A.

Summarizing by an example, suppose I1UseDecode points to the 2^{nd} pipestage, and I0WriteDecode points to the 3^{rd} pipestage as shown. Then mux 2060.AA takes the 2^{nd} bit counting from the left in 2028.0A and provides it as an output (zero in this example is second bit in 0011) from mux 2060.AA to an input of AND-gate 2070.AA via an inverter 2075.AA. The output zero in this example means that the timing of write is incompatible with the earlier timing of the read, and therefore issuance of instruction I1 is not permitted when there is a match from equality comparison 2050.AA.

Mux 2060.AA is replicated for each source operand of Instruction I1 to be compared with a given destination operand of Instruction I0. Mux 2060.AA muxes I0 Write Decode under mux control of I1UseDecode as a relative timing test of write by Instruction I0 destination a relative to use by Instruction I1 source of operand A. In this embodiment, the equality comparators 2050.xx do not veto issuance of I1 merely because some destination of instruction I0 is the same as a source operand of instruction I1. Instead the equality comparators 2050.xx respectively enable AND-gate 2070.xx to consider the output of muxes 2060.xx when some destination of instruction I0 is the same as a source operand of instruction I1.

For example, suppose equality comparator 2050.AA with AND-gate 2070.AA detects a register match between DstA I0 and SrcA I1 and generates a match signal to an input of AND-gate 2070.AA. But, further suppose instruction I0 first produces a data result in execution pipestage E2 and instruction I1 needs the result at least as soon as first execution pipestage E2 of the other pipe. So there is no data hazard. In that case, the match signal from comparator 2050.AA is appropriately ignored by AND-gate 2070.AA under controls coupled from mux 2060.AA.

For another example consider:

### Instruction I0: Shift R1<-Rx, Imm

### Instruction I1: Add R2<-R1+R3

Note that the destination register R1 of Instruction I0 matches the source register R1 of Instruction I1. Suppose that the shift unit is in a first execution pipeline, at pipestage E1 for executing the Instruction I0 Shift, and that the ALU unit is in a second pipeline, at pipestage E2 for executing the Instruction I1 Add. The result of instruction I0 is available in pipestage E1, and the result from the shift unit can be forwarded to the second pipeline, second pipestage E2 for instruction I1 to use. In that case, the comparator 2050.AA supplies match signal to AND-gate 2070.AA. However, mux 2060.AA sees EA=1 availability bits “1111” from decode 2025.0A. The mux 2060.AA selects the second “1” bit from that string because EN=2 from decoder 2035.1A. Inverter 2075.AA accordingly feeds a zero (0) to AND-gate 2070.AA. AND-gate 2070.AA outputs zero (low) meaning there is no data hazard here.

In light of this mux 2060.AA read, next consider the advantageous function of the equality comparator 2050.AA in a slightly different way than described a little earlier above. The equality comparator 2050.AA can also be regarded as validating, for intradependency purposes, the reading of the I0 Write Decode 2028.0A “quasi-scoreboard entry” by mux 2060.AA. In other words, the equality comparator 2050.AA gives validation that the read operation on I0 Write Decode is relevant to determination of IntraDependency OK because there is a register match.

Recall that I0 Write Decode block 2025.0A has entries for each of the destinations DstA, DstB, etc. of Instruction I0. Note further that for each Instruction I0 destination such as DstA, for example, composite mux 2060 includes submuxes 2060.xx like that illustrated replicated for and controlled by I1 Use Decode bits for each of the Instruction I1 source operands SrcA, SrcB, SrcC, SrcD, etc. The submuxes in mux 2060.xx supplied to a NOR-gate 2040 to produce an output active representing that there are no timing problems for a given destination operand of Instruction I0 relative to the sources of Instruction I1.

Each of eight replica circuits 2010.AA, 2010.BA, . . . , 2010.DA, 2010.AB, . . . 2010.DB provides a respective output from its corresponding AND-gate 2070.AA, . . . 2070.DB to logic provided as single NOR-gate 2040 (not eight of them) in this embodiment. Each AND-gate 2070.xx instantiates the above-described validation by equality comparator match, and instantiates the overriding of the match when the mux 2060.AA output represents a situation where instruction I1 can use the data output of instruction I0 by needing that output no sooner than when that data output becomes available from Instruction I0. NOR-gate 2040 outputs a high-active IntradependencyOK output high (1) only if the outputs from all of the logic gates 2070.xx are low (no Stall). Otherwise, NOR-gate 2040 outputs a low (zero) on the IntradependencyOK indicating an intradependency issue (not OK) if the output from even one of the logic gates 2070.xx is high (Stall).

In FIG. 8, logic circuits 2010.AA, 2010.BA, 2010.CA, 2010.DA, 2010.AB, 2010.BB, 2010.CB, 2010.DB compare each of the dependent instruction I1 source operands SrcA, SrcB, SrcC, etc. with the instruction I1 destination operands DstA, DstB, etc. in general. (Two destination operands are illustrated here).

For example, in logic circuits 2010.xx (of which only circuit 2010.AA is explicitly shown in FIG. 8), these comparisons of sources to Destination A are provided by a plurality of equality-detection circuits 2050.AA, 2050.BA, 2050.CA, 2050.DA each having a first input connected in common to a four-bit line 2022.0A representing DstA of instruction I0, from block 2020.0A. The four-bit line 2022.0A has four bits to identify any one of the illustratively 16 registers in the register file. Comparisons of sources to Destination B are provided by a another plurality of equality-detection circuits 2050.AB, 2050.BB, 2050.CB, 2050.DB each having a first input connected in common to a four-bit line 2022.0B (not shown for conciseness and analogous to line 2022.0A) representing DstB of instruction I0, from a block 2020.0B analogous to block 2020.0A.

The equality-detection circuits 2050.AA and 2050.AB each have a second input connected in common to a four-bit line from a block 2030.1A identifying the register for the source operand SrcA of instruction I1. Analogously, further pairs of the equality-detection circuits (2050.BA, 2050.BB), (2050.CA, 2050.CB), (2050.DA, 2050.DB), each have the second inputs of a given pair connected in common to a four-bit line from a block 2030.1B, 2030.1C, 2030.1D identifying the respective register for the source operand SrcB, SrcC, SrcD of instruction I1.

AND gates 2070.AA, . . . 2070.DA, 2070.AB, . . . 2070.DB each have an output 2045.xx connected to a respective one of the inputs of single NOR gate 2040 thus coupled to all the logic circuits 2010.AA-.DB. NOR gate 2040 has an output designated IntraDependencyOK coupled to an input of the AND gate 1975 of FIG. 7B. A second input of AND gate 1975 is fed with a signal IssueI0_OK representing that issuance of Previous Instruction I0 was permitted by the output of AND gate 1965 described hereinabove.

This embodiment advantageously features a superscalar architecture with parallel pipelines. Accordingly, two unissued instructions I0 and I1 are in some instances able to be issued simultaneously into the pipelines respectively. If these instructions were to be issued side-by-side each other into the parallel pipelines, next to each other in that sense, the instructions need a dependency check beforehand. But neither of the two unissued instructions I0 and I1 are yet in the pipeline to have information entered in the scoreboard. Accordingly, the two unissued instructions I0 and I1 are checked by logic for intra-dependency as shown in FIG. 8.

The concept of IntraDependencyOK recognizes that before information yet exists to enter into the scoreboard, the instructions I0 and I1 are quickly checked so that the Source Operands (input operands) of unissued Instruction I1 are not requiring information too soon from any of the same registers as are destination registers for the other unissued Instruction I0. If such intradependency is detected, the issue circuitry issues Instruction I0 if no other reasons to delay issue exist. If no intradependency is detected, then Instruction I0 and I1 can both issue if no other reasons to delay issue exist.

However, Instruction I1 is prevented from issue when IntraDependencyOK signal is low (not OK) at the output of NOR-gate 2040 and thereby prevents AND-gate 1975 from supplying an active IssueI1_OK signal which is the signal that would otherwise be able to cause issuance of instruction I1. By this time, Instruction I0 has been issued into the pipeline and scoreboard information is entered into the scoreboard for Instruction I0.

Since Instruction I0 is no longer unissued, it goes on the scoreboard and takes the role of a producer instruction Ip. Also, instruction I1 takes the role of a new Instruction I0. The FIG. 8 Intradependency checking circuitry 2010, 2040 no longer prevents issuance of new Instruction I0 (old I1) at the IntradependencyOK input of AND-gate 1975. Instead, issuance of new Instruction I0 depends on passing all scoreboard tests at AND-gate 1954.

In a further intradependency example, suppose in the equality comparator 2050.AA that DstA I0 matches SrcA I1 but equality comparator 2050.BA provides a no-match output of the comparison of DstA to SrcB I1. (Ignore DstB I0 for purposes of this example.) Also, suppose Mux Circuit 2060.AA for the I0 Write Decode for DstA says result is available in time for SrcA I1 but too late for SrcB I1.

In this example, there are 2 independent compares by comparator 2050.AA (explicitly shown in FIG. 8) and comparator 2050.BA (in circuitry 2010.BA identical to FIG. 8 coupled to Stall line B-A to NOR-gate 2040 of FIG. 8). Similarly, an I1 Use Decode mux 2060.AA is provided for SrcA (explicitly shown in FIG. 8), and an I1 Use Decode mux 2060.BA is provided for SrcB in the above-mentioned circuitry identical to FIG. 8.

SrcB of I1 does not match DstA of I0 providing a low output by comparator 2050.BA to an AND-gate 2070.BA. Thus, I1 Use Decode mux 2060.BA output is ignored by AND-gate 2070.BA, because that mux 2060.BA output is not a condition for stalling. AND-gate 2070.BA output is low at the B-A input of NOR-gate 2040.

SrcA of I1 matches DstA of I0 providing a high output by comparator 2050.AA to an AND-gate 2070.AA. This example assumes the result is available (I1 Use Decode mux=1 active-high at output of mux 2060.AA), it is not a condition for stalling. Specifically, I1 Use Decode mux 2060.AA supplies an output high, which is inverted by inverter 2075.AA, which in turn supplies a zero (low) to an input of the AND-gate 2070.AA. This low input matters to the output of AND-gate 2070.AA because a comparator 2050.AA match has qualified AND-gate 2070.AA. The output of AND-gate 2070.AA goes low, meaning no-stall. This no-stall output from AND-gate 2070.AA is correct since mux 2060.AA predicts in-time availability of the DstA operand from instruction I0 for consumption by the SrcA operand of instruction I1.

Assuming there are no active-high inputs on the Stall inputs of NOR-gate 2040, the output of NOR-gate 2040 provides an active-high IntradependencyOK output. The IntradependencyOK output from NOR-gate 2040 is fed to an input of AND-gate 1975 of FIG. 7B. If there are no high-active conditions at the inputs of the AND-gate 1975, then AND-gate 1975 produces a high-active output IssueI1OK in FIG. 7B on a line that goes through FIG. 7A, and Instruction I1 is thereupon issued.

FIGS. 7A and 7B illustrate scoreboard control for in-order instruction issuance. The input IssueI1_OK to AND-gate 1975 is prevented from going active before IssueI0_OK goes active for instruction I0. Accordingly, instruction I1 is prevented from being issued sooner than instruction I0, and in-order instruction issuance is preserved.

### Type Bits

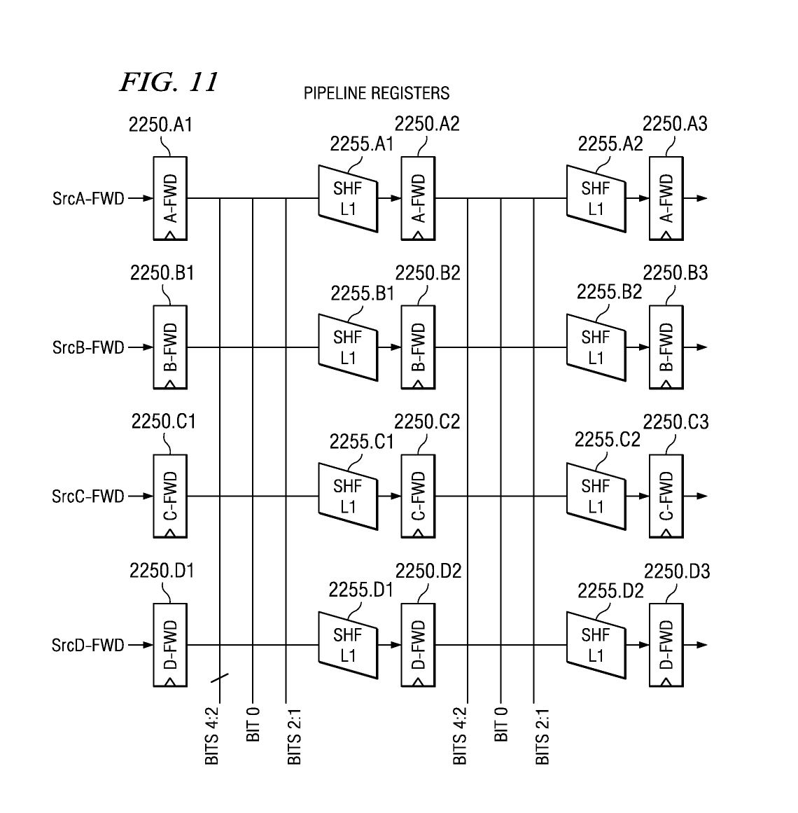

Case Where I0/I1 Write to Same Register: Notice that in this embodiment the FIG. 8 intradependency logic does not prevent simultaneous issuance where that would cause I0 and I1 to write the same register file register from two different pipes in the same cycle when writeback stage is reached at end of pipes in FIG. 3. The younger instruction I1 is accorded priority to write the register in this embodiment because the Instruction Type information is entered as two bits in the scoreboard 1760 of FIG. 5 indicating in which pipe the destination is generated. Lower row go/no go scoreboarding to same register 1950.i is handled by priority decoding 1940.i as described elsewhere herein. Forwarding in FIG. 11 is disambiguated in this case by the Type information as described next and in connection with FIGS. 9-12.

For a superscalar machine, Instruction Type bits (e.g. two (2) bits) represent which pipeline into which each instruction issues, e.g. ALU0, ALU1, MAC pipeline, Load-Store pipeline. A Type control circuit 1768 suitably stores Type bits into the Type register pertaining to a producer instruction destination operand. These Type bits are suitably supplied by the type control circuit to an area of the scoreboard as non-shifting bits associated with the upper row scoreboard and associated with a particular index i of register file register. An example of Type bits generation is that instruction I0 is issued into pipeline Pipe0 (Type ALU0), as indicated by the line for IssueI0_OK being active.

If instruction I1 is dual-issued with instruction I0, then instruction I1 is issued into pipeline Pipe1 (Type ALU1) as indicated by the line for IssueI1_OK being active. In case of destination i register match, priority decode 1940i inserts the Type information for Instruction I1 (not I0) into the Type field indexed i corresponding to that register match. In this way, instruction I1 is given priority for data forwarding purposes.

If either instruction is a MAC or load-store instruction, then decode of the instruction by Type control 1768 establishes Type bits for MAC or LS pipe and loads the Type bits to the scoreboard when the instruction is issued into the pipe for which it is destined.

The coding scheme for the Instruction Type bits of one embodiment is tabulated in Table 2 next:

TABLE 2

| SCOREBOARD | | |
|---|---|---|
| INSTRUCTION TYPE | | |
| CODE BITS | DESIGNATION | REMARKS |
| 00 | ALU0 | Arithmetic Logic Pipe0 |
| 01 | ALU1 | Arithmetic Logic Pipe1 |
| 10 | LD0 | Load-Store Pipe 0 |
| 11 | LD1 | Load-Store Pipe 1 |

The Instruction Type bits are decoded to accomplish that write operation described in this foregoing paragraph. Other codings of Instruction Type bits to control forwarding for the same or other pipeline structures are suitably implemented based on the teachings herein.

Further embodiments have Instruction Type bits that advantageously track more information about the pipelines by adding more information to the scoreboard. For example, bits are suitably entered by Type control 1768 for any one, some or all of: 1) Data types such as single or double precision, fixed point, floating point, etc., 2) Identity of pipeline, 3) Identity of functional unit producing a result, and 4) other useful information. Any information that is useful for controlling instruction issue and data forwarding is suitably entered by Type control 1768 onto the scoreboard according to the principles set forth herein. In a floating point machine scoreboard embodiment, a single precision result is suitably entered by a code on the scoreboard to advantageously preclude forwarding to a different-precision-level of instruction.

The Instruction Type 1760.i information for a producer instruction is physically associated with the upper scoreboard row 1750.i of FIG. 5 and FIG. 9A and muxed out with the upper scoreboard row 1750.i of FIG. 5 and FIG. 9B into the pipeline into which the consumer instruction is issued, along with the SrcA/B/C/D-fwd when the consumer instruction is issued. Thereafter, the Instruction Type information 1760.i is pipelined in FIGS. 9B and 11 through the various stages of FIG. 11 registers A/B/C/D-fwd along with the upper scoreboard row copy but without being right-shifted stage-by-stage like the upper scoreboard row copy.

Thus, the Instruction Type bits 1760.i are read out from the scoreboard and pipelined and then used as type selects in FIG. 10. The Instruction Type selects are decoded from the A/B/C/D-fwd registers and fed to and used as selects by the lower forwarding mux of FIG. 10 as the Instruction Type selects for that lower forwarding mux.

Along with the register position i in the scoreboard portion 1750.i, the Type (ALU0/ALU1/Load0/Load1) is thus stored. If the same destination register i is common to both instruction 0 and 1, then the Type selects the destination for instruction 1 to forward using second level set of mux 2330.4, .5, .6 in the bottom half of FIG. 10, for instance.

### Detailed Description of Data Forwarding Between Pipestages

First, refer to the earlier description of FIG. 3 for a general description of data forwarding between execute pipestages under the control of scoreboard units pertaining to the upper row of the scoreboard of FIG. 4. The description next hereinbelow provides even more detailed description of such data forwarding processes and structures in connection with FIGS. 9A, 9B, 10, 11, and 12A/12B.

In FIG. 9A, a set of scoreboard upper row shift registers 2220.0-2220.15 (e.g., corresponding to sixteen register file registers) are provided. An initial value (FIG. 4 cycle 1) “1000” of position bits for the scoreboard upper row is muxed to a shift register 2220.i when WriteEnableI0 is high. Otherwise a zero (0) is right-shifted into each shift register 2220.0-2220.15.

Further in FIG. 9A, the initial value “1000” is concurrently provided to each respective shift register 2220.i, 2220.j, etc. corresponding to a destination register identified by DstA, DstB, etc. of each instruction when it is issued. Each of the 4-bit destination fields DstA, DstB, etc. of each issuing instruction is decoded by a 4:16 decoder 2222.xx to identify each one of the 16 shift registers 2220.i that is to be written with “1000”.

Consider the pipelines and pipestages tracked for upper row scoreboard unit forwarding purposes. In this embodiment of each upper row scoreboard unit, there are two non-shifting Instruction Type bits 1760 of FIG. 5 to represent the pipeline forwarding data, and physically suitably associated with upper-row scoreboard shift register cells 2220.i in each scoreboard unit in FIG. 9A.

If each of the pipelines have M execute pipestages, then each shift register 2220.i suitably has M (e.g. 5) cells or mux flops. Also, some embodiments can omit the last shift register mux-flop to the extent that the nature of the last pipestage being a writeback pipestage can permit. FIG. 9A represents M=5 mux-flops per shift register although four are explicitly drawn.

As discussed earlier hereinabove, issuance of a candidate instruction I0 may be delayed for one or more clock cycles by the circuitry that responds to the lower row of the scoreboard. In the meantime, during these clock cycles of delay, the upper row of the scoreboard is right shifted by right-shifting a zero into each shift register 2220.0-2220.15. This is because the scoreboard upper row units 2220.i describe producer instructions already issued into the pipeline and advancing actually down the pipeline(s) with every clock cycle.

The right shifting occurs provided that the output of a respective ANDs-to-OR circuit 2225.0-2225.15 provides a WriteEnable low. If WriteEnable is high from one or more particular circuits 2225.i, 2225.j, etc corresponding to particular destinations DstA, DstB, etc., then the initialization value “1000” is loaded into the respective shift registers 2220.i, 2220.j, etc. AND-gates 2227.i are fed by decoder(s) 2222 for instruction I0 destinations and qualified by IssueI0_0K. AND-gates-2226.i are fed by decoder(s) 2222 for instruction I1 and qualified by IssueI1_0K.

If the instruction set has an instruction that has multiple destinations DstA, DstB, etc., the circuitry is augmented to have more destination decoders 2222.0A, .0B, .1A, .1B and more AND gates 2226.i, 2227.i, etc. in front of each OR gate 2229.i for each scoreboard upper row shift register 2220.i. Similarly, where there is more than one instruction, still more AND-gates 2224 are provided in front of each OR-gate 2225.i. Prioritization of FIG. 7A is not provided in FIG. 9A because it is all right to redundantly write “1000” for multiple destination operands and instructions to the same register 2220.i. Write Prioritization is thus omitted from FIG. 9A.

Note that as previous instructions have been being issued on different clock cycles into the pipelines, the various shift registers 2220.0-2220-.15 corresponding to actual destination registers of each of those previous producer instructions have been being loaded with respective copies of “1000” upon occurrence of those respective different clock cycles of issuance of those previous instructions. The singleton ones in those shift registers are clock cycle by clock cycle, being shifted in accordance with the pipestage position of each producer instruction except where overwriting has occurred.

Further in FIG. 9B, upon instruction issue, the five (5) bits of each of the scoreboard upper row shift registers 2220.0-2220.15 are fed in parallel to five 16:1 submuxes of a composite mux 2240.0A (16×5:1×5). Mux 2240.0A has its selector input fed with the output of a 4:16 decoder 2230.0A of SrcA, the register file register number identified by the Source A operand of the instruction. Advantageously, this mux 2240.0A thus produces a 5-bit wide output SrcA-fwd from the particular scoreboard shift register 2220.i corresponding to the register file register identified as the source register of operand SrcA of candidate instruction I0.

Similarly, the five (5) bits of each of the scoreboard upper row shift registers 2220.0-2220.15 are also fed in parallel to five 16:1 submuxes of a composite mux 2240.0B (16×5:1×5). Mux 2240.0B has its selector input fed with the output of a 4:16 decoder 2230.0B of SrcB, the register file register number identified by a second source operand designated SrcB of the instruction I0. Advantageously, this mux 2240.0B thus produces a 5-bit wide output SrcB-fwd from the particular scoreboard shift register 2220.j corresponding to the register file register identified as the source register of operand SrcB of candidate instruction I0. Analogous description applies to a composite mux 2240.0C to produce 5-bit output SrcC-fwd, and a composite mux 2240.0D to produce a 5-bit output SrcD-fwd.

Notice that outputs SrcA-fwd, SrcB-fwd, SrcC-fwd, SrcD-fwd represent the 5-bit contents of precisely the upper scoreboard rows 2220.i containing the pipestage position information for all producer instructions that have destinations into registers that are sources for instruction I0. When instruction I0 is issued into a pipeline, then outputs SrcA-fwd, SrcB-fwd, SrcC-fwd, SrcD-fwd are loaded into respective holding registers 2250.A1, 2250.B1, 2250.C1, 2250.D1 just ahead of the first execution pipestage.

Then as the newly issued instruction I0 moves clock cycle by clock cycle down the pipeline, the upper scoreboard row contents (for the producer instructions Ip that supply data to the consuming Src operands) are right-shifted by respective shifting circuits 2255.A1, 2255.B1, 2255.C1, 2255.D1 into the next group of holding registers 2250.A2, 2250.B2, 2250.C2, 2250.D2 ahead of the second execution pipestage, then into respective shifting circuits 2255.A2, 2255.B2, 2255.C2, 2255.D2 into the next group of holding registers 2250.A3, 2250.B3, 2250.C3, 2250.D3 (see FIG. 11) and so on down the extent of the pipeline as far as needed to derive control signals for controlling data forwarding.

Pipelining of selected upper scoreboard rows 2220.i is being described here. The first set of pipeline registers 2250.A1, 2250.B1, 2250.C1, 2250.D1 control the forwarding for the first stage of execution. The second set of pipeline registers 2250.A2, 2250.B2, 2250.C2, 2250.D2 control the forwarding of the second stage of execution. And the third set of pipeline registers 2250.A3, 2250.B3, 2250.C3, 2250.D3 control forwarding of the third pipeline stage.

Summarizing this FIG. 9A/9B example, sixteen (16) scoreboard upper row registers 2220.i contain the singleton one position bits for various producer instructions Ip. For single issue instruction, the diagram of FIG. 9A explicitly shows three (3) registers 2220.1 out of sixteen (16) registers. The diagram of FIG. 9A explicitly shows one (1) write port for candidate instruction I0 out of two (2) or more write ports for additional destinations of candidate instruction I0. By write ports here, what is meant is providing decoders 2222.0A, 0B to load “1000” into shift registers in the shift register group 2220 when candidate instruction I0 has more than one destination register DstA, DstB, etc., to which instruction I0 provides results. Furthermore, the diagram of FIG. 9B explicitly shows two (2) read ports for SrcA, SrcB for candidate instruction I0 out of four (4) read ports SrcA, SrcB, SrcC, SrcD.

For dual issue instruction architecture, additional write ports to accommodate a candidate instruction I1 in an architecture that can simultaneously issue up to two candidate instructions I0 and I1 into at least first and second pipelines Pipe0 and Pipe1. By additional write ports here, what is meant is providing additional decoders 2222.1A, 1B, to load “1000” into shift registers in the shift register group 2220 for all destinations of additional candidate instruction I1.

Furthermore, the diagram of FIG. 9B is augmented with decoders 2230.1A, 1B, 1C, 1D, and muxes 2240.1A, 1B, 1C, 1D for additional read ports for all sources Src of candidate instruction I1. Then the read ports for instruction I0 feed source registers 2250 for pipeline Pipe0 as shown (or selectively to a Type defined pipe). The read ports for instruction I1 feed source registers 2251 (not shown) and shift circuits 2256 (not shown) for an additional pipeline Pipe1 or any further additional pipeline identified by the Type bits of instruction I1.

Issue bits and Type routing down pipelines is described next and elsewhere herein. These further bits are routed by muxing down the pipelines. Issue I0_0K and IssueI1_0K are of FIG. 5 respectively routed (non-shifting) down pipeline Pipe0 and Pipe1. Type entry bits 1760 are selected by mux 1765.x of FIG. 5 which is controlled by the same Src decoders 2230.xx as in FIG. 9B. The Type entry muxing is muxing 2240.xx with two additional inputs and fed to non-shifted portion of pipeline registers 2250.xx that bypass shifters 2255.xx.

Turning to FIG. 10, forwarding the data resulting from execution pipestages E3, E4 and E5 can be less time-critical than the data results in execution pipestages E1, E2, and E3 stage (for load result). Control circuitry for the important but less time-critical results from pipestages E3, E4 and E5 is shown in FIG. 10. Control circuitry for the important and more-time-critical results from pipestages E1, E2 and E3 is shown in FIGS. 12A/12B.

In FIG. 10, 32-wide data resulting from each of pipestages E3, E4, and E5 are supplied by pipeline latches labeled E3, E4, E5 in three pipelines Pipe0, LS Pipe, and Pipe1 to data forwarding muxes 2310.0, 2310.LS, and 2310.1 for the respective pipelines. Each of the data forwarding muxes 2310.0, 2310.LS, and 2310.1 have six (6) or more submuxes suffixed 1, 2, 3, 4, 5, 6 . . . and collectively fed in parallel with the 32 bit data from each of pipestages E3, E4, E5. Each submux is 3:1 for the three 32 bit buses from the corresponding pipeline Pipe0, PipeLS, and Pipe1 except that mux 2310.0 has a fourth 32-wide input from data result of a multiply-accumulate circuitry (MAC). Data forwarding muxes 2310.0, 2310.LS and 2310.1 have their outputs coupled by respective 6×32 bit lines to an output forwarding mux 2330. The number of submuxes 2310.xxx and their inputs are chosen by the skilled worker by considering the number of source (consuming) operands of instructions and the number of pipestages for producer instructions.

Bits [4:2] of the pipeline registers 2250.x1 of FIG. 9B and FIG. 11 hold the upper scoreboard bits pertaining to pipestages E3, E4, and E5 for a producer instruction. Selection inputs labeled “Instruction 0” for the data forwarding muxes 2310.0, 2310.LS, and 2310.1 are coupled to and fed by bits [4:2] of the scoreboard upper rows stored in registers 2250.A1, 2250.B1, 2250.C1, 2250.D1 associated with pipeline Pipe0. In the case of a dual-issue architecture example here, further selection inputs collectively labeled “Instruction 1” for the data forwarding muxes 2310.0, 2310.LS, and 2310.1 are coupled to and fed by similar bits [4:2] of the scoreboard upper rows stored in additional registers (not shown) associated with pipeline Pipe1 in circuitry corresponding to registers 2250.A1, 2250.B1, 2250.C1, 2250.D1.

Output forwarding mux 2330 has six or more submuxes 2330.1-.6. Each submux 2330.x has three 32 bit inputs corresponding to the three muxes 2310.0, 2310.LS, and 2310.1. Each input receives a respective 32-bit output from a corresponding one of the six or more submuxes in one of the three data forwarding muxes 2310.0, 2310.LS, and 2310.1. Register R15 (Program Counter PC) data is fed in parallel to an input of each of the output forwarding submuxes 2330.1-.6. Immediate data and temporary base address register data is also fed to another input of each of the output forwarding submuxes 2330.1-.6.

Selector inputs for each of the six output forwarding submuxes 2330.1-.6 are respectively fed by three Instruction Type Selects (meaning the pipeline type for each producer instruction Ip) for Instruction 0, and by three analogous Instruction Type Selects for Instruction 1. Note that Instruction Type pertains to scoreboard entries 1760.i of FIG. 5, and also discussed in connection with FIGS. 9A/9B. The Type selects are the ones pipelined down registers 2250.xx of FIG. 9B without shifting.

At this point, data is selected from a pipeline identified by Type and from a pipestage identified by scoreboard upper row bits 4:2. Data selections are performed concurrently for every consuming Src A, B, C, D operand of both instructions I1 and I2.

Outputs for the six output forwarding submuxes 2330.1-.6 are next coupled to each actual consuming pipestage to which a corresponding Src A,B,C,D operand pertains, for example three (3) read ports 2402, 2404, 2406 of FIG. 12A for Instruction 0, of pipeline Pipe0 just ahead of pipestage E1 therein. Other outputs for the six output forwarding submuxes 2330.1-.6 are coupled to three (3) analogous read ports for Instruction 1, of pipeline Pipe1 just ahead of pipestage E1 therein. Further outputs for the six output forwarding submuxes 2330.1-.6 are illustratively coupled to three (3) read ports for an execute stage E1 of a MAC pipeline. Still other outputs for the six output forwarding submuxes 2330.1-.6 are coupled to two (2) read ports for AGU (address generation unit) execute stage E1 of load-store pipeline PipeLS. Note in FIG. 10 that the mux symbol (trapezoid) of muxes 2330 stands for more than an 5:1 selection. Each submux 2330.1-3 output is hardwired out in parallel to the Pipe0 read ports. Each submux 2330.4-.6 output is hardwired out in parallel to the Pipe1 read ports. This, in effect, provides a hardwired demux to the pipestage.

Advantageously, the submuxes of the data forwarding muxes 2310.0, 2310.LS, and 2310.1 are responsive to the upper row scoreboard information from scoreboard pipeline registers 2250.A-D to select any one or more of the data sourcing pipestages for forwarding purposes identified by the scoreboard for use as source operands for the consuming instruction. Those submuxes of data forwarding muxes 2310.0, 2310.LS, and 2310.1 provide as their output the selected sourcing data to the output forwarding submuxes 2330.1-.6. In turn, the output forwarding submuxes 2330.1-.6 are responsive to the Instruction Type select information decoded from consuming instruction I0 itself, or consuming instruction I1 itself, to route the respective sourcing data to each appropriate pipeline and pipestage therein which consumes the respective sourcing data.

Every submux among the six submuxes for all the muxes 2310.0, 2310.LS, 2310.1, and 2330.1-.6 corresponds to a different source operand for one of the two consuming instructions I0 and I1. The skilled worker provides sufficient submuxes to accommodate all the appropriate source operands for all the consuming instructions in a superscalar processor. In mux 2330, every submux 2330.1-.6 selects an appropriate input to supply as submux output. Each submux 2330.1-.6 feeds hardwired parallel lines to supply to the consuming instruction I0 or I1 itself, by routing the submux output to any selected consuming read port for Pipe0, Pipe1, MAC, or AGU in the destination pipeline. Each consuming port corresponds to the pipestage position of the consuming instruction I0 or I1 in its pipeline due to control lines from respective pipestage register 2250.x1, .x2, . . . , for pipestages 1, 2, . . . .

Regarding FIG. 10, in one perspective, the whole assemblage of 3 muxes 2310.xx to one mux/demux 2330.x is entirely replicated for every consuming pipestage to respond to controls [4:2] from that respective consuming pipestage. In other words, the whole assemblage replicated is fed by control lines [4:2] in FIG. 11 from every register 2250.x1 of pipestage 1, control lines [4:2] from every register 2250.x2 of pipestage 2, etc. When an instruction I0 reaches its consuming pipestage of first need EN, the muxes pertaining to that consuming pipestage of need are operated in order to accomplish the data forwarding. In this first alternative, some gates 2460, 2461, 2464, 2465 of FIG. 12B in the pipeline are provided to respond to the I0 Read decode EN so that the consuming instruction I0 only accepts forwarding mediated by the scoreboard upper row when the consuming instruction I0 has at least reached its consuming pipestage of first need EN (A,B,C,D) of forwarding respective to a given source Src A, B, C, or D of instruction I0.

In a second perspective of FIGS. 12A/12B together with FIG. 10, the forwarded value of any selected one of pipestages E1, E2, E3, E4, E5 forwarded into pipestage E1 and/or E2. The forwarded value from pipestage E1-E5 is muxed by circuitry highly integrated into the pipeline and stored into the flops 2450.0x of FIG. 12 just ahead of the consuming pipestage to which the forwarded value is muxed. The muxed value is used in the consuming pipestage or piped down from there as instruction definitions require or permit.

In this second perspective, the data value from a sourcing (producer) pipestage is consumed immediately or forwarded every pipestage. Depending on whether the forwarded data is used or not then the source operand can be either valid or not. For example, if a pipestage E1-Valid bit (e.g., ShF_valid) is set, then the operand data (which are also valid due to issue timing circuitry of FIGS. 7A and 7B) are used and consumed in pipestage E1. SHF_valid is active high when IssueI0_0K is high and EN=1 for pipestage 1 for a source operand SrcX.

And, if a pipestage E2-Valid bit (e.g., ALU_valid) is set, then the operand data (which are also valid due to issue timing circuitry of FIGS. 7A-7C) are used and consumed in pipestage E2. ALU_valid is active high when IssueI0_0K is high and EN=2 for pipestage 2 for a source operand SrcX.

Instruction valid indication IssueI1_0K (and EN equaling pipestage number 1) means to execute the operand data that presented in that pipeline stage. Examples of signals that each represent that a pipestage is valid for forwarding are Shift_valid for pipestage E2 operation and ALU_valid for pipestage E3 operation. Each of these signals Shift_valid and ALU_valid are produced directly from decoding of the consuming instruction to determine its first ipestage of need EN (A,B,C,D) respective to each SrcA, B,C,D operand. In that sense, the signals Shift_valid and ALU_valid are independent of or separate from the scoreboard.

If a producer instruction Ip is moving through the pipeline but the consumer instruction I0 is delayed from issue by the go/no-go circuitry, the upper scoreboard row enters the pipeline immediately accompanied by a not-valid bit IssueI0_0K equals zero (0) representing that the consumer instruction I0 is not validly issued. The producer instruction Ip, for its part, was controlled by the issue circuit so that the scoreboard circuitry earlier writes/sets up the scoreboard at the time when the producer instruction was issued (meaning enters pipestage 1 of a pipeline with its own valid bit set).

The consumer candidate instruction I0 reads the scoreboard for go/no-go as described in connection with FIGS. 7A and 7B. When the consumer instruction I0 is itself issued in due course, Issue I0_0K goes high (equals one) and that “one” is fed into the register 2250.x1 as an instruction Valid “one” bit. See Tables 3-5 next.

In the embodiment of FIGS. 9 and 11, suppose now that a consuming instruction has identified the particular scoreboard unit so that the scoreboard upper row information is entered into the pipeline register SrcA-fwd 2250A.1. Refer to the an example of the operation of the pipeline circuitry in Table 3.

TABLE 3
EXAMPLE OF UPPER SCOREBOARD INFORMATION
IN PIPELINE PIPE0, REGISTERS 2250.A1-A5
ON CURRENT CLOCK CYCLE

| Bit [0:4] | A1 | A2 | A3 | A4 | A5 | |
|---|---|---|---|---|---|---|
| 0 | 0 | 0 | 0 | 0 | 0 | |
| 1 | 0 | 0 | 0 | 0 | 0 | |
| 2 | 0 | 0 | 0 | 0 | 0 | |
| 3 | 1 | 1 | 1 | 0 | 0 | |
| 4 | 0 | 0 | 0 | 1 | 0 | |
| Instruction | I0 | I0 | I0 | Ip2 | Ip1 | |
| Valid | 1 | 0 | 0 | 1 | 1 | |
| Producer | 0 | 0 | 0 | 0 | 0 | |
| Type Bits | 1 | 1 | 1 | 0 | 0 | |
| Consumer | 1 | 1 | 1 | 0 | 1 | Valid = Issue I0_0K |
| First Need | 0 | 0 | 0 | 1 | 1 | (0/1) = Pipe1 producing |
| EN | | | | | | (0/0) = Pipe0 producing |
| | | | | | | 0/1 = E1, 1/0 = E2, 1/1 = E3 |

Table 3 illustrates an example of scoreboard values in five successive A-fwd pipeline registers 2250.A.1, A.2, A.3, A.4, and A.5 of FIG. 11 corresponding to pipestages E1, E2, E3, E4, E5. The upper row bits [0:4] of the scoreboard are entered vertically (columnwise) like the vertical orientation of those registers 2250 in FIG. 11.

A singleton one in one row in each column has the row position of the singleton one signifying a respective pipestage position 1,2,3,4,5 of a producer instruction for operand A of the each consumer instruction in the pipeline. The Instruction Valid bit, producer Type bits, and consumer pipestages of first need EN are also entered columnwise.

In the example, a pipelined bit Instruction Valid of Tables 3, 4, 5 (Valid row) is determined by the 0,1 value of IssueI0_0K in pipe0 and the (0,1) value of IssueI1_0K in Pipe1. See also FIG. 9B for these Issue I0_0K and Issue I1_0K pipelined bits. A consuming instruction I0 was not valid (valid=0) for issue one cycle ago and two cycles ago. Consuming instruction I0 has just now been validly issued (valid=1). Because the circuitry of FIGS. 9A/B and FIG. 11 permits the scoreboard information to enter the pipeline even before the consuming instruction I0 is valid for issue, an additional valid/not-valid bit is also fed into the pipeline registers 2250, such as 2250.A.1-.A.5. Accordingly, Instruction I0 is not valid in the E2 and E3 pipestages (Valid bit is 0), but Instruction I0 is valid in the E1 pipestage (Valid bit is 1) because it has just now been issued.

Thus, the scoreboard is read every clock cycle into the pipeline whether or not a candidate instruction I0 is valid for issue. In other words, in this real-estate efficient embodiment there is advantageously no gating provided for the muxes 2240 of FIG. 9B such as in another embodiment might be additionally provided to prevent the muxes 2240 from flowing the scoreboard upper row into pipeline. The SrcA fwd is don't care if instruction_valid_0 is not set in pipestage E1 of Pipe0 or instruction_valid_1 is not set in pipestage E1 of Pipe1.

The lack of gating of muxes 2240 in this embodiment is especially useful in an in-order issue machine. With in-order issue, it is efficient to enter an invalid bit (valid=0), if need be, with the scoreboard into the pipeline in each clock cycle until the candidate instruction I0 is valid for issue. The circuitry simply inserts a series of scoreboard “upper row snapshots” cycle by cycle until the latest snapshot coincides with valid issuance (valid=1) of the instruction I0. Thereupon the process is repeated with another candidate instruction.

Notice that because both the FIG. 9A originating scoreboard 2220.i and the FIG. 9B and FIG. 11 scoreboard pipelining shifters 2255 are both operative, the pipeline registers 2250.A.1, A.2, A.3 have the singleton one in the same row position (e.g., Bit 3) in each of the columns E1, E2, E3 of Table 3. That row position depends on the position of the particular producer instruction that is sourcing the consuming instruction I0 ScrA. In this example, the producer instruction is instruction Ip2 in pipestage 4 corresponding to the Bit 3 position of the singleton one pertaining to consuming instruction I0. If the producer instruction were another instruction in another pipestage, then the scoreboard singleton one would have been appropriately placed to correspond to that producer instruction pipestage.

TABLE 4
EXAMPLE OF UPPER SCOREBOARD INFORMATION IN PIPELINE
Pipe0, Registers 2250.A1-.A4 ONE CYCLE PREVIOUSLY

| Bit [0:4] | A1 | A2 | A3 | A4 | A5 | |
|---|---|---|---|---|---|---|
| 0 | 0 | 0 | 0 | 0 | | |
| 1 | 0 | 0 | 0 | 0 | | |
| 2 | 1 | 1 | 0 | 0 | | |
| 3 | 0 | 0 | 1 | 0 | | |
| 4 | 0 | 0 | 0 | 1 | | |
| Instruction | I0 | I0 | Ip2 | Ip1 | | |
| Valid = | 0 | 0 | 1 | 1 | | Valid = IssueI0_0K |
| Issue I0_0K | | | | | | |
| Producer Type | 0 | 0 | 0 | 0 | | |
| Bits | 1 | 1 | 0 | 0 | | |
| Consumer 1^{st} | 1 | 1 | 0 | 1 | | |
| Need EN | 0 | 0 | 1 | 1 | | 0/1 = E1, 1/0 = E2, 1/1 = E3 |

TABLE 5
EXAMPLE OF UPPER SCOREBOARD INFORMATION
IN PIPELINE Pipe0, Registers 2250.A1-
.A3 TWO CYCLES PREVIOUSLY

| Bit [0:4] | A1 | A2 | A3 | A4 | A5 | |
|---|---|---|---|---|---|---|
| 0 | 0 | 0 | 0 | | | |
| 1 | 1 | 0 | 0 | | | |
| 2 | 0 | 1 | 0 | | | |
| 3 | 0 | 0 | 1 | | | |
| 4 | 0 | 0 | 0 | | | |
| Instruction | I0 | Ip2 | Ip1 | | | |
| Valid = Issue I0_0K | 0 | 1 | 1 | | | Valid = IssueI0_0K |
| Producer Type Bits | 0 | 0 | 0 | | | |
| Ip | 1 | 0 | 0 | | | |
| Consumer First | 1 | 0 | 1 | | | |
| Need EN | 0 | 1 | 1 | | | |

Table 4 and Table 5 respectively show the upper scoreboard entries in the pipeline one cycle previously and two cycles previously for the instructions Ip1, Ip2, and I0. Pipestages not under consideration for purposes of this example are left blank in Tables 4 and 5.

Notice that in the example, the upper scoreboard entries are shifted downward and to the right with the passage of time. In Table 5, the position of a producer instruction for not-yet-valid Instruction I0 is in pipestage E2, as represented by Bit 1=1 in 2250 register .A1. Thus instruction Ip2 is identified as the producer instruction when the Instruction Type Information (0.0) in the scoreboard identifies pipeline Pipe0 wherein Ip2 resides.

As described, an instruction-Valid bit in this embodiment is pipelined in parallel down register 2250.xi with the upper row of the scoreboard. Advantageously, the instruction-Valid bit is used to qualify the forwarding information. In other words, if the instruction-valid bit is not set, the forwarding information is disabled or prevented from initiating a forwarding operation between pipestages.

If the source data is used only in E1 to E3, then the forward information is pipelined only from E1 to E3. Instruction Valid indication means to execute the operand data that presented in that pipeline stage. Examples of signals that each represent that a pipestage is valid for forwarding are Shift_valid for pipestage E2 operation and ALU_valid for pipestage E3 operation. Each of these signals Shift_valid and ALU_valid are produced directly from decoding of the instruction.

The Shift-valid signal is used as clock-gating for the shift unit which is independent of the operand data. Similarly, the ALU-valid signal is used as clock-gating for the ALU unit or pipestage, which is independent of the operand data. By contrast, Instruction-valid is and signifies instruction validly being issued. Instruction-valid is used to qualify data sent by the instruction decoder 1630 of FIG. 3. See Issue I0_0K qualifying EN=1 or EN=2 of AND-gates 2461 and 2465 of FIG. 12B. Instruction decoder 1630 can send data, such as scoreboard data, into a pipeline independently of whether a valid instruction is issued to a pipeline of the execute unit or not.

The operand result data value from a sourcing (producer) pipestage is forwarded every pipestage to a consuming pipestage mux M0, M1 or M2 of FIG. 12A/B regardless of whether that forwarded data value is used or not. If the forwarded data is not used, (not clocked into a flop) then it is immaterial whether the source operand was either valid or not. For example, if a pipestage E1-Valid bit (e.g., SHF_valid) is set high, then the operand data (which are also valid due to issue timing circuitry of FIGS. 7A and 7B) are used and consumed in pipestage E1. And, if a pipestage E2-Valid bit (e.g., ALU_valid) is set high, then the operand data (which are also valid due to issue timing circuitry of FIGS. 7A and 7B) are used and consumed in pipestage E2.

Now consider a case in which the circuitry is to forward data from E2 Pipe0 to E2 Pipe1. Instructions I0 and I1 were issued simultaneously and have reached execution stage E2. In this case, in this embodiment, the forwarding information is separate from the scoreboard shift registers. This forwarding information is provided in FIG. 8 by AND-gate 2080.AA in the intradependency logic 2010.AA. AND-gate 2080.AA generates a signal on line FORWARD.AA that is like an inversion of the stall signal from AND-gate 2070.AA. That signal on FORWARD.AA is coupled and sent from the intradependency logic of FIG. 8 into register 2250.x1, etc., to cause the result to be forwarded from pipestage E2 of pipeline Pipe0 to pipestage E2 of pipeline Pipe1. See additional selector input line FORWARD.xx to mux 2504 of FIG. 12B used in the circuitry for Pipe1.

Each of the eight FORWARD.xx signals .AA to .DA and .AB to .DB are suitably pipelined with the corresponding instruction and qualified by instruction valid and provided through appropriate logic for controlling the data forwarding in the execute pipeline Pipe1. The circuitry of FIG. 11 pertaining to Pipe1 has an additional FORWARD bit. When, for example FORWARD.CB goes high in FIG. 8, then a “one” is piped down registers 2250.Ci for Pipe1 to forward producer instruction I0 destination B Pipe0 stage E2 into consumer instruction I1 SrcC consuming operand at pipestage E2 of Pipe1.

In summary, the arrangement is replicated in a highly efficient and integrated manner for control by each consuming pipestage. As noted hereinabove, and depending on the first pipestage of need for an operand, data forwarding is controlled by each set of pipeline registers 2250.x.1, 2250.x.2, 2250.x.3 for pipestages 1, 2, 3 (where x stands for any of consuming operands A,B,C,D). When the consuming instruction reaches its first pipestage EN of need for an operand, the one or more pipeline registers 2250.x.N at that pipestage control the data forwarding. The first pipestage EN of need for an operand SrcX is already decoded from the consuming instruction.

Since the pipelines hold multiple consuming instructions traveling down the pipelines, the forwarding from different producer instructions into different consuming instructions is being controlled by the circuitry of FIG. 11 and FIGS. 12A/12B to handle the different producer instructions for up to two simultaneously issued consumer instructions I0 and I1, and by replicas of the circuitry of FIG. 11 and FIGS. 12A/12B to handle other different pipestages holding other consuming instructions. In this embodiment, a second pipeline Pipe1 is thus provided wherein forwarding is from an older instruction to a no-older instruction between said the first pipeline Pipe0 and the second pipeline Pipe1.

Appropriate gating based on the first pipestage of need prevents premature use of forwarded data in the pipestages. Advantageously, the circuitry of FIG. 10 and the per-pipe replicated circuitry of FIGS. 11 and 12A/12B confer the operations of an elegant data forwarding mechanism or data exchange mechanism in the pipeline with the operations perfectly timed and coordinated to rapidly process instructions successfully through the pipeline.

For layout purposes in FIG. 10, the data forwarding muxes 2310.0, 2310.LS, and 2310.1 and output forwarding mux 2330 are suitably centralized in one block using bits [4:2] of the forwarding control bits from the scoreboard and pertaining to producer instruction at pipestages E3, E4, E5 as shown.

Turning specifically to FIG. 12A/12B, the results in E1, E2 stages, etc. are more time-critical. There, data forwarding muxes M1 and M0 are distributed at shifters and ALUs, using bits [2:0] of the forwarding control bits from the upper row of the scoreboard. These bits [2:0] pertain to the producer instruction at pipestages E1, E2, E3. Bits 0,1,2,3,4 carry the upper row scoreboard column entries pertaining to pipestages E1, E2, E3, E4, E5 respectively.

In FIG. 12, M2 represents the forwarding muxes in FIG. 10 for the less time-critical data path. Thus M2 very concisely stands for and represents the more detailed structure of FIG. 10 which the designation M2 in FIG. 12 is provided. Different M2 muxes in a same pipestage i are controlled by respective SrcX (SrcA,B,C,D) operands 4:2 scoreboard entries and type bits in the register 2250.xi for SrcX and pipestage i of FIG. 11. These Src sources are the consuming operands of the instruction which is conceptually in pipestage 2 at the time.

Illustrative designators are non-exhaustively provided in FIG. 12 to further exemplify the sourcing pipestages being input and routed to the consuming pipestages. These illustrative designators are SAT0 for a saturate circuit in sourcing pipestage E3 of pipeline Pipe0, SAT1 for a saturate circuit in sourcing pipestage E3 of pipeline Pipe1, WB0 for a writeback circuit in sourcing pipestage E5 of pipeline Pipe0, WB1 for a writeback circuit in sourcing pipestage E5 of pipeline Pipe1, IMM for immediate data, and RF for register file R15 (Program Counter PC) data as in FIG. 10.

Further in FIG. 12, M1/M0 represent certain fast, distributed muxes for forwarding. These fast, distributed muxes M1/M0 are distributed in the sense of being physically located near or in the consuming pipeline stages which the distributed muxes M1/M0 service. Different M1/M0 muxes in a same pipestage i are controlled by respective SrcX consuming (Src A,B,C,D or as shown) operands of the Bit0 (M1) or Bits 2:1 (M0) scoreboard entries and their Type X pertinent to that operand in the register 2250.xi for SrcX and pipestage i of FIG. 11.

The select signal for distributed muxes M1, M0 is a combination of three bits [2:0] of the forwarding information from the scoreboard upper row and further lines as appropriate representing the Instruction Ip Type information pipelined down registers 2250.x1, .x2, etc. from the scoreboard. The three bits [2:0] are sufficient to identify and select one of up to eight different lines in a given pair of the distributed muxes M1/M0 taken together. The selected line is data-wide (e.g., 32 bits) and coupled into a data register such as a data register 2450.i.1 or 2450.i.2 or 2450.i.3 for a respective pipestage 1, 2, 3. or E1, E2, E3.

The particular circuitry of the pipestages depends strongly on the details of the operations of the processor which each instruction in the instruction set of that processor have been defined and chosen by the skilled worker to represent. Such instruction definition details and choices are not specifically relevant to this disclosure. Accordingly, some details of FIGS. 12A/12B are left suggested and are less fully described since they are not specifically relevant here.

FIG. 12A shows one shifter SHF 2420 block as an example function for execution pipestage E1 in each of pipelines Pipe0 and Pipe1. FIG. 12B further shows one ALU (arithmetic/logic unit) block 2440 as an example function for execution pipestage E2 in each of pipelines Pipe0 and Pipe1. Muxes P2, P1, P0 are forwarding muxes for data that are not immediately needed in the next cycle (E1). FIG. 12A/12B has legends pertaining to pipestages E1 and E2 in Pipe0. The circuitry of FIGS. 12A/B is replicated for pipestages E1 and E2 in Pipe1 except legends have their “0” and “1” identifying suffixes reversed. A diagram of the replicated circuitry is omitted for the sake of conciseness.

Now focus on the 8:1 mux-pair M1/M0 2453, 2455 in FIG. 12. The eight inputs shown are 1) shifter SHF1 which exemplifies a shift output bus for pipestage E1 of pipeline Pipe1, 2) shifter SHF0 which exemplifies a shift output bus for pipestage E1 of pipeline Pipe0 being forwarded back via mux 2453 and 2455 to its own input register 2482, 3) and 4) data inputs from mux M2, 5) coupling from mux M1 2453 to mux M0 2455, 6) load LDO from Load-Store pipeline PipeLS, 7) arithmetic logic unit ALU1 forwarded in from pipestage E2 of other pipeline Pipe1, and 8) arithmetic logic unit ALU0 forwarded in from pipestage E2 of same pipeline Pipe0, the pipeline explicitly depicted in FIG. 12.

Next, focus on the 8:1 mux-pair M1/M0 2457, 2502 in FIG. 12. There are fewer inputs. The six inputs shown are 1) shifter SHF0 output of this pipestage E1 of pipeline Pipe0, 2) data input from mux M2 meaning from part of FIG. 10. Also, further there is provided 3) coupling from mux M1 2457 to mux M0 2502, 4) load LDO from Load-Store pipeline PipeLS, 5) arithmetic logic unit ALU1 forwarded in from pipestage E2 of other pipeline Pipe1, and 6) arithmetic logic unit ALU0 forwarded back to its own input register 2512 from pipestage E2 of pipeline Pipe0.

In FIG. 12, stage E2 with its ALU 2440 and muxing is abbreviated in detail for conciseness. More control lines [2:0] are suitably brought in from scoreboarding pipestage registers 2250.x2. Depending on the particular functions and length of a pipeline more or fewer forwarding circuitry muxes and couplings are provided in pipestage E2 near ALU 2470 as is suitable for the processor architecture and applications. Also in FIG. 12, paths are provided to pipeline data without modification through one pipestage via mux 2520, and through two pipestages via muxes 2406, 2476, flop 2486, mux 2499 and mux 2506.

In FIG. 12, appropriate gating 2460, 2461, 2464, 2465 is provided based on the first pipestage of need decoded from the consuming instruction to prevent premature forwarding into unintended consuming pipestages. Advantageously, the circuitry of FIG. 12 provides the operations of a data forwarding mechanism or data exchange mechanism in the earlier stages of a pipeline with the operations perfectly timed and coordinated to rapidly process instructions successfully through the pipeline. Together the circuitry of FIG. 10, FIG. 11, and FIGS. 12A/12B provide a data forwarding mechanism or data exchange mechanism for as many pipestages of each pipeline as is desired to benefit from the advantages of data forwarding.

FIG. 13 illustrates a logical view of circuitry 2700 associated with issue loop path 1825 in FIG. 6. Parts of FIG. 13 also correspond to portions of FIGS. 7C and 7B.

FIG. 13 illustrates arrival of a candidate instruction in mux-flops 1830, 1832 to drive scoreboard-controlled muxing 1958, 1960 and logic 1965, 1975 that supply go/no-go instruction issue controls labeled IssueI0_OK and IssueI1_OK. The issue controls in turn loop back via path 1825 as selector control signals INC0/1/2-SEL to control the muxes 1830 of the mux-flops. In this way, the loop comes full circle.

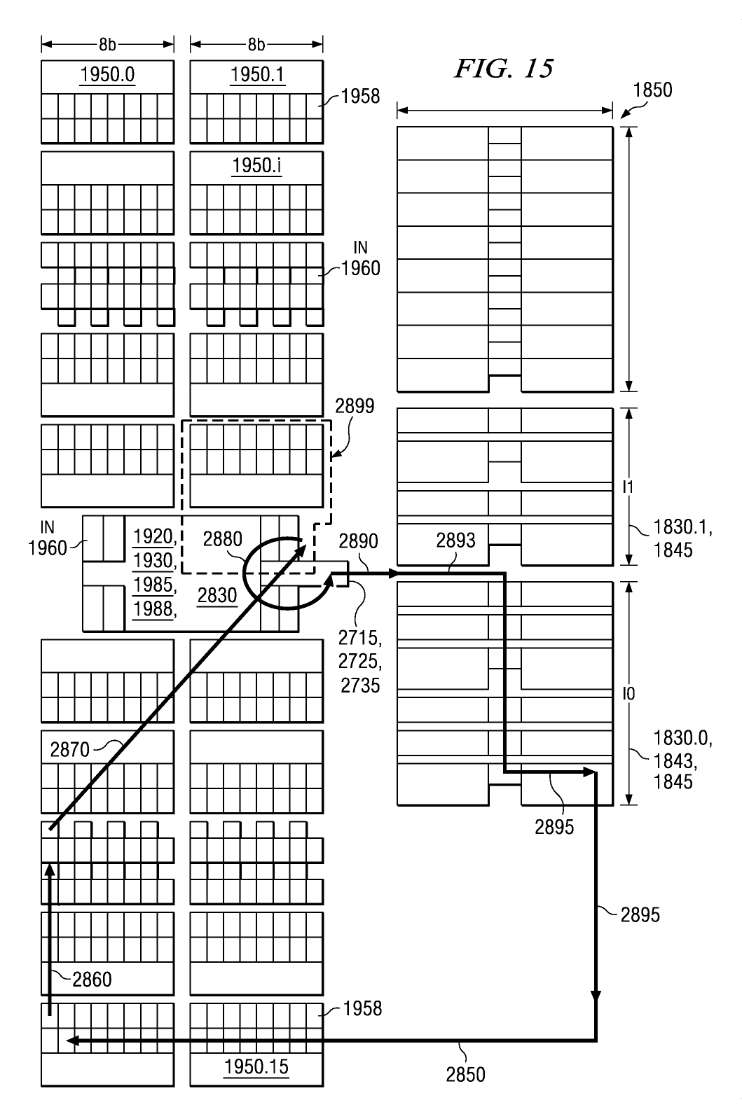

As also shown in FIG. 6, this looping back advantageously tells the rest of the circuitry in FIG. 6 how to update the flops 1832 with zero, one, or two instructions, to be ready with updated contents in the flops 1832 by the next clock cycle. Then in each successive next clock cycle the process happens all over again. The circuitry and layout are suitably prepared, as shown for example in the layout embodiment of FIG. 15, to meet the clock speed appropriate to the processor for high-speed software applications to be processed.

In FIG. 13, circuitry 2700 has mux-flop 1830.0 and 1832.0 each repeated on the diagram twice for illustrative purposes. RC delay couples the flop 1832.0 to a pair of successive inverters (non-inverting drive) 2702 to drive the selections provided by 5:1 mux circuitry 1958.xx from bits in lower row scoreboard shift registers 1950.i of FIG. 7B. In the embodiment illustrated in FIG. 13, the selector signals to the first set 1958 of muxing (called time machine muxes herein) are fully decoded in the queue as EN decode (where EN identifies the pipestage of first need of a source operand by the candidate dependent instruction) and driven directly over to the scoreboard. By contrast, the selector signals to the next two 4:1 muxes constituting the 16:1 read port muxes 1960.xx are encoded in the queue and decoded before use as mux selects for the scoreboard read muxes 1958.

In FIG. 13, a five-to-one 5:1 mux 1958 is provided for muxing the four (4) go/nogo bits per scoreboard shift register 1950.i, as well as an additional source provided by a constant or one-bit (1′b1). Notice that each go/no-go bit from a shift register 1950.i drives into all eight associated muxes 1958.1x in FIG. 7B, corresponding to four source operands each of instruction I0 and I1. The 1′b1 input to the 5:1 mux is selected to force an ‘OK’ for an operand. An OK is suitably forced when an operand is not involved in the definition of the instruction that has fewer than four source operands, or when the mux is pointed to the one (1′b1) input in representation of the last stage of the execute pipeline.

From a circuit path perspective, the output of 5:1 mux 1958.xx is coupled to two successive stages of 4:1 muxes which together comprise 16:1 muxing by muxes 1960 of FIG. 7C. Selection controls of the two stages of 4:1 muxes 1960 are driven by respective pairs of successive inverters (non-inverting drive) 2705.

Note that FIG. 13 omits much circuitry to reveal and emphasize an important timing loop and its component elements. The more extensive circuitry is depicted in FIG. 6 and FIGS. 7A, 7B, 7C.

Flop 1832.0 is coupled by another RC Delay to a 4:16 decode circuit 1988.xx, which in turn feeds the pairs of non-inverting drive 2705. The outputs of four 16:1 muxes 1960.0x pertaining to instruction I0 feed respective SRCx_OK inputs (x=A,B,C,D) to AND circuit 1965 whereupon the IssueI0_OK signal is produced. Additional enabling and disabling signals to AND-gate 1965 are shown as CC_OK for Condition Code OK and Forced_Stop_Issue for pipe flush and/or circuit reset.

The outputs of four 16:1 muxes 1960.1x pertaining to instruction I1 feed respective SRCx_OK inputs (x=A,B,C,D) to AND circuitry 1975 whereupon the Issue I1_OK signal is produced. Additional enabling and disabling signals to AND-gate 1975 are the output of AND-gate 1965 as well as signal I0_I1_Coll_OK for intradependency OK in FIG. 8, and Resource_OK for enabling use of the second pipeline Pipe1. Resource_OK involves register file read port quantity, instructions bound to pipe0, and any other considerations for permitting issuance of instruction I1 at the same time as instruction I0.

Further in FIG. 13, the issue control signal IssueI0_OK on a line 1995 is inverted by inverter 2710 to produce a selection signal INC0_SEL that is fed back via RC delay of issue loop path 1825 through a pair of inverters 2715 (non-inverting drive) to control the selector circuitry of mux 1830.0 to make that mux 1830.0 select the INC0 input thereto in FIG. 6.

Issue control signal IssueI0_OK is also fed to a first input of an AND gate 2720. IssueI1_OK on a line 2730 is inverted by an inverter 2723 at a second input of AND-gate 2720. AND-gate 2720 produces an output INC1_SEL that is fed back via a parallel line of RC delay of issue loop path 1825 and through a pair of inverters 2725 (non-inverting drive) to control the selector circuitry of mux 1830.0 to make that mux 1830.0 select the INC1 input thereto in FIG. 6.

Also in FIG. 13, the issue control signal IssueI1_OK on the line 2730 directly provides a selection signal INC2_SEL that is fed back via another parallel line of RC delay of issue loop path 1825 through a pair of inverters 2735 (non-inverting drive) to control the selector circuitry of mux 1830.0 to make that mux 1830.0 select the INC2 input thereto in FIG. 6.

In this way, in FIG. 13, the mux-flops 1830, 1832 via Resistance-Capacitance (RC)-delay and then via decode 1988, operate to control the read port mux circuitry 1958, 1960 of the lower row scoreboard of FIGS. 7B and 7C to feed logic circuitry gates 1965, 1975, 2710, 2720. The logic circuitry gates drive RC delay in issue loop path 1825 and drive the selectors of the muxes 1830. The flops 1832 are thereby updated in time for the process to advantageously repeat on the very next clock cycle.

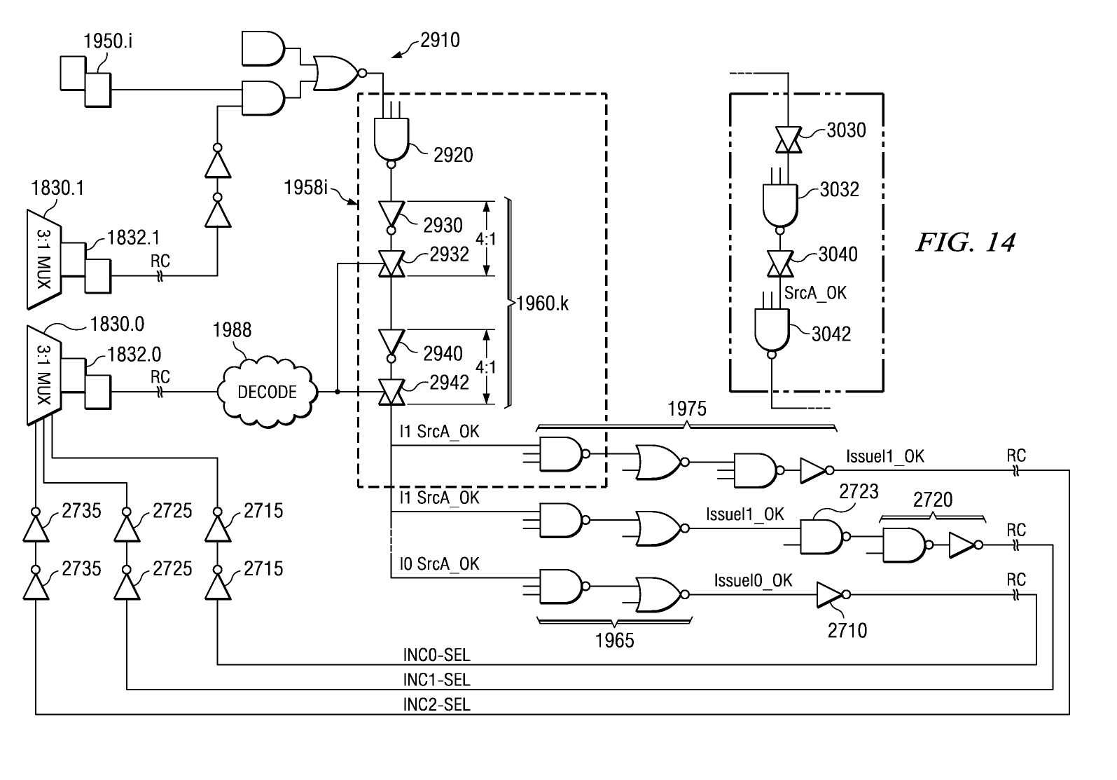

In FIG. 14, a physical circuitry view of the instruction decode pending queue shift loop further simplifies and shows features of the timing loop discussed in connection with FIG. 6 and FIG. 13. The description of FIG. 14 describes physical circuitry variations from FIG. 13 and some points of emphasis without unduly repeating the description of FIG. 13.

In FIG. 14, the loop includes the use of a 5:1 AOI-NAND mux 2910, 2920 in muxes 1958.xx for selecting which of the go/no-go bits is to be read out from the lower row of the scoreboard. A NAND-gate 2920 has each of its three inputs fed by a respective AOI (AND-OR-INVERT) circuit 2910. Each AOI 2910 has a pair of AND-gates. Each AND-gate has a first input fed by one of the respective lower row scoreboard shift register 1950.i and a second input fed by a different one of five select lines based on EN decode.

In this way, only a selected one AND-gate in one AOI 2910 is enabled to pass through a thereby-selected bit from the lower row scoreboard shift register 1950.i to NAND 2920. Logically, the INVERT (bubble) function of each AOI 2910 driving each input of NAND 2920 makes NAND 2920 the Boolean logic equivalent of an OR-gate relative to the AND gates in the AOIs 2910. In this way, the output of NAND 2920 supplies one output for one 5:1 mux among the set of 128 5:1 muxes 1958.xx of FIG. 7B.

Further in FIG. 14, each NAND 2920 for a mux 1958.xx services one source SrcX of one instruction I0 or I1, for one of the sixteen shift registers 1950.i. Each NAND 2920 is coupled to one of four inputs of each of one of four inverter-passgate (4:1) muxes in eight groups. Associated with each 4:1 mux input is one inverter 2930 coupled to one pass-gate 2932 in that 4:1 mux. Decode 1988 has a variety of output lines that activate only one pass-gate 2932 in a given 4:1 mux. (The two decode 1988 output lines emanating from the same dot in FIG. 14 are a simplified representation used for timing analysis diagramming.) Since all muxes with inverter 2930 and pass-gate 2932 are in parallel from a timing viewpoint, only one inverter 2930 and one pass-gate 2932 are shown.

Each pass-gate 2932 is coupled to respective input of a succeeding inverter-mux (4:1) combination 2940, 2942 likewise driven by decode 1988. Each pass-gate 2942 (only one of which is selected to conduct) is coupled to one input of a NAND gate in respective logic 1965 and 1975 respective to each source operand of instruction I0 and to each source operand of instruction I1. In this way the function of 16:1 mux 1960.yy is advantageously provided.

Different mux types—AOI-NAND for 5:1 mux 2910, 2920 and pass-gate muxes in mux 1960—are used to achieve speed goals, high reliability, design-for-test and other advantages. AOI-NAND muxes can use selects other than one-hot selects, but may be slower than pass-gate muxes. Pass-gate (transmission gate) muxes use one-hot selects and feature higher speed.

FIG. 14 has nand-inv-tgate-inv-tgate-nand cascade 2920, 2930, 2932, 2940, 2942. An inset to FIG. 14 has a tgate-nand-tgate-nand cascade providing equivalent logic but alternative physical circuit with different physical advantages. (“tgate” means transmission gate. “inv” means inverter.) In the inset to FIG. 14, the alternative circuit thus utilizes a first pass-gate mux 3030 coupled to one input of a first multi-input NAND-gate 3032 coupled to a second pass-gate mux 3040, coupled to an input of a second multi-input NAND-gate 3042. In FIG. 14 inset, the 3-input NAND-gates 3032 and 3042 are respectively physically associated with 4:1 pass-gate muxes 3030 and 3040. NAND-gate 3032 pertains to mux 1958 but is remarkably shuffled or interspersed physically after pass-gate 3030 of a 4:1 mux in mux 1960.

The FIG. 14 inset alternative physical circuit has physical advantages of not only making the timing path faster but also reducing the number of transistors in some embodiments. First, the alternative physical circuit advantageously omits two inverters 2930 and 2940 and so makes the timing path faster. Second, the number of transistors are reduced because in the example of FIG. 7A, 7B, 7C, there are 128 muxes 1958.xx. Remarkably, intertwining or physically shuffling the structures of muxes 1958.xx and 1960.xx in this way, achieves advantages including those just mentioned.

The 3-input NAND gate 2920 generally has more transistors than a pass-gate like 3030 so putting three times more pass-gates 3030 ahead of one-quarter as many NAND gates 3032 is acceptable, compared to putting NAND gate 2920 ahead of inverter 2930 and pass-gate 2932.

Suppose each pass-gate has two transistors, each inverter has two transistors, and each 3-input NAND gate has six transistors. Then the estimated number of transistors in the dotted area of FIG. 14 and in the alternative of FIG. 14 inset are tabulated in TABLE 6.

TABLE 6
TRANSISTOR SAVINGS

| NAND-TGATE | | | ALTERNATIVE TGATE-NAND | | |
|---|---|---|---|---|---|
| NAND | 128 × 6T = | 768T | TGATE | 8 × 3 × 4 × 4 × 2T = | 768T |
| INV | 8 × 4 × 4 × 2T = | 256T | NAND | 8 × 4 × 6T = | 192T |
| TGATE | 8 × 4 × 4 × 2T = | 256T | TGATE | 8 × 4 × 2T = | 64T |
| INV | 8 × 4 × 2T = | 64T | | TOTAL: | 1024T |
| TGATE | 8 × 4 × 2T = | 64T | | | |
| | TOTAL: | 1408T | | | |

Remarkably, the alternative TGATE-NAND circuit embodiment of FIG. 14 inset saves hundreds of transistors for a dramatic 27% transistor savings even compared to the advantageous NAND-TGATE circuit embodiment of FIG. 14. The savings will vary and can be even greater in other pairs of circuit embodiments based on the teachings herein.

Continuing further in FIG. 14, the SrcA-OK lines are diagrammatically fanned out to three generally-parallel distinct paths of logic circuitry in FIG. 14. This is because the I1 SrcA_OK line for instruction I1 is an input for the logic circuitry respectively forming INC1-SEL and INC2-SEL outputs and I0 SrcA_OK is an input for the logic circuitry forming the INC0-SEL output. The SrcA/B/C/D_OK signals are each handled similarly, with only SrcA_OK circuitry shown for clarity.

Three series of gates respectively supply selection signals INC2-SEL, INC1_SEL, and INC0_SEL for driving mux 1830 selections. In the FIG. 14 physical circuit view, a series of gates outputs the signal on line INC1_SEL. A 3-input NOR is substituted in place of a 3-input AND of FIG. 13 because NAND-NOR physical logic of FIG. 14 is used to operate logically the same as AND-AND logic of FIG. 13 at that point in the circuitry.

For instance, IssueI1_OK is written as:

5-input NAND (instruction I1 operands ok) - - - |

2-input NAND (resources ok) - - - |3-input NOR.

5-input NAND (instruction I0 operands ok) - - - |

The 3-input NOR outputs the signal IssueI1_OK.

Using DeMorgan's Theorem of Boolean algebra NOT(AB)=NOT A OR NOT B and any other applicable logic identities, the circuits of FIG. 14 are suitably rearranged physically into various embodiments proving equivalent logic but different physical advantages. Physical advantages include decreased transistor count and delay equalization or delay optimization as between different paths INC0/1/2-SEL.

The FIG. 14 physical timing view includes RC Delay on each of the INC0/1/2-SEL lines. This RC Delay is reduced but need not be considered negligible, see discussion of FIG. 15 later hereinbelow. The FIG. 15 floorplan view shows the RC Delay by representing physical distance. The FIG. 13 diagram and FIG. 14 physical view diagram annotate RC Delay by the designation “RC” for pointing out this aspect.

Among other advantageous embodiments, FIG. 15 shows a physical layout embodiment. Improved circuitry provided as shown in FIG. 15 is suitably used in any of the processor blocks in FIGS. 1 and 2 where its advantages commend it. For instance, in FIG. 2, the improved circuitry is suitably applied to the RISC processor, to the DSP processor, or both the RISC and DSP processors in digital baseband integrated circuit 1100 and in the applications processor integrated circuit 1400, and in a processor of WLAN integrated circuit 1500.

Note that the layout embodiment of FIG. 15 is not necessarily drawn to scale and that the actual regions of chip real estate are juxtaposed compactly. Lines between, through, and around blocks are omitted for conciseness and diagrammatic emphasis on the placement of the blocks. FIG. 15 depicts and preserve geometric shape, orientations and neighbor-relationships of the blocks to one another. The number of blocks long versus wide is suitably varied in rectangular groups of blocks.

Turning to FIG. 15, description now details a layout embodiment for providing advantageous performance pertaining to the muxes and logic timing loop 1830-1958-1960-1965/1975-1825-1830 of FIG. 6 and FIGS. 13 and 14. Further advantages conserve chip real estate and provide a compact physical geometry. Other layout embodiments can suitably provide various levels of advantage relative to these and other criteria. This layout of FIG. 15 involves circuitry at the bottom of (in the sense of following after) a pending instruction queue such as Issue Queue Critical 1850 of FIG. 6.

Sixteen 8-bit-wide mux-to-register blocks 1950.0, 1950.1, . . . 1950.15 correspond to the muxes 1954.xx and shift registers 1956.xx of FIG. 7B for lower row scoreboarding in go/no-go instruction issue control. Two rows of tiny blocks AOI in muxes 1958.xx are located next to each mux-to-register block 1950.i. Blocks AOI in FIG. 15 symbolize And-Or-Inverter circuits like AOI 2910 of FIG. 14.

In FIG. 14 inset and FIG. 15, a set of 4:1-mux tgates 3030 to 3-input-NAND 3032 of FIG. 14 inset are provided in two comb-shaped blocks in FIG. 15 in a middle portion (IN 1960) in each of the upper and lower halves (butterfly wings) of the scoreboard. A set of 4:1 mux tgates 3040 of FIG. 14 inset are provided in a central rectangle 2830 of FIG. 15 in eight tiny pairs (IN 1960) in corner portions of that central rectangle 2830 between the upper and lower butterfly wings. These eight 4:1 muxes provide the final muxes of the 4:1 to 4:1 mux structure that constitutes each 16:1 mux 1960.

In FIG. 14, mux tgates 3040 are followed by NAND logic 3042 which is part of combinatorial gates 1965, 1975. Correspondingly in FIG. 15, the combinatorial gates 1965, 1975 are placed in the central rectangle 2830. Combinatorial gates 1965, 1975 are provided and coupled to the 16:1 muxes 1960 to perform the final qualifications and combine all the SrcA/B/C/D_OK signals.

At upper right in FIG. 15, pending queue instruction entries enter Issue Queue Critical circuit 1850. Instructions then descend at right center of FIG. 15 to and through various blocks having FIG. 6 muxes 1840, 1843, 1845, and mux-flops 1830, 1832 physically interspersed there.

On the layout of FIGS. 15 and 16, logic is suitably placed for the 4:16 decoders 1988 and other source and destination decodes 1920, 1930, 1985 of the go/nogo section where physical room on the layout suitably accommodates them to provide a good flight path to the different sinks (signal destinations).

In the embodiment illustrated in FIG. 15, decoders 1920, 1930, 1985, 1988 are physically concentrated in the central rectangle 2830. The Read Port decoders 1985, 1988 not only drive the read port muxes 1958, 1960 for the Go/NoGo portion of the scoreboard, but also support data forwarding (upper row) and pipe select (Type) portions of the scoreboard 1700.

Upper and lower halves of the go/no-go scoreboard are located above and below the central rectangle 2830. Those upper and lower halves feature butterfly symmetry relative to the central rectangle 2830. Laterally adjacent to the right of central rectangle 2830 lie muxes 1830.1 above muxes 1830.0. A line of substantial symmetry of the scoreboard as a whole bisects the central rectangle 2830. The line of symmetry provides a general line of demarcation so that muxes 1830.0 lie mostly or all above the line of symmetry and muxes 1830.1 mostly or all below the line of symmetry.

In FIG. 15, the gates that thus form the issue-loop path part in the scoreboard are placed to include RV (lower scoreboard Result Valid) entries from shift registers 1950.i all feeding from above and below toward the central rectangle 2830 to combining logic. The combining logic has an output for instruction issue control signals IssueI0_OK and IssueI1_OK. The gates that form the issue-loop path are placed so that the final combining logic of central rectangle 2830 is also shown centered with respect to the mux-flops 1830, 1832 for instruction I0 and I1 above and below. In this way, loading is advantageously reduced.

In FIG. 15, a series of arrows 2850, 2860, 2870, 2880, 2890, 2893, 2895 forms a loop representing the logical flow of information for timing and speed path analysis purposes in this layout. This embodiment is believed to provide a near-optimum balance of various advantages by virtue of the physical circuitry arrangement of gates that form the issue-loop path.

The arrow 2850 of the loop goes to an end or extremity of a butterfly wing of the scoreboard in FIG. 15. The position of the arrow 2850 is not necessarily a literal representation of the signal path here. A first version of the embodiment puts decoders as shown in the central rectangle 2830 and fans out the decode lines up and down to control the muxes 1958 in the butterfly wings of the scoreboard. A second version puts decoders adjacent to mux-flops 1830, 1832 and fans decoder outputs laterally over to the blocks in the scoreboard wings. A third version locates the decoders in the butterfly wings. The timing considerations are believed to be relatively similar as between the versions and the loading on the decoders is moderate to small. As far as outputs are concerned, the pending queue is, in general, structured strategically in this example such that the bits are as close as possible to the scoreboard given the constraint of how many bits there are.

RV Result Valid entries (the series of ones in the lower row shift registers 1950.i) feed via arrows 2860 and 2870 toward the central rectangle 2830 where the final combining logic such as gates 1965, 1975 resides. Arrow 2880 follows RV Result Valid operand values (e.g. eight of them) from final 4:1 corner muxes in 1960 of rectangle 2830 (see 3040 in FIG. 14 inset). In rectangle 2830, short arrow 2880 passes through circuitry forming signals INC0/1/2-SEL of FIG. 14 to issue of none, one, or two of the candidate instructions I0 and I1.

The combining logic in rectangle 2830 is also shown centered with respect to the bottom pending queue mux-flops (1830.0, 1832.0; 1830.1, 1832.1) to reduce the loading. Advantageously, in FIG. 15, the RC-delay of the loop path 1825 of FIG. 6 and FIG. 13 is dramatically reduced because this path is associated with short arrow 2890.

Short arrow 2880 pertains to the logic 1965, 1975, 2710, 2723, 2720 of FIGS. 13 and 14. Short arrow 2890 pertains to issue loop path 1825. The just-named logic directly feeds the driver inverters 2715, 2725, 2735 of FIGS. 13, 14, and 15 via short arrow 2890. Because of the dramatically reduced path 1825 via short arrow 2890, the driver inverters advantageously occupy a rightward protruding stub of central rectangle 2830. The driver inverters drive adjacent mux circuitry 1830 of FIGS. 6, 13 and 14.

The signals from the driver inverters propagate laterally and vertically over the array of mux circuitry 1830.0 and 1830.1 as suggested by arrows 2893 and 2895 through mux circuitry 1830.0. For high speed operation over the multi-bit width of each instruction I0 and I1, the driver inverters drive into common-connected parallel loads presented by the parallelism in each mux circuit 1830.0 and 1830.1. The driver inverters advantageously accommodate and drive the parallelism in the mux circuitry at high clock speeds.

Arrow 2895 then connects to arrow 2850. Little or no common-connected parallel loading is involved in the communication of instruction bits to scoreboard circuitry here. Therefore, loading is advantageously moderate to small. The size and relative position of the rectangular blocks of the layout is also suitably arranged to make the path portion represented by arrows 2895 and 2850 at lower right in FIG. 15 relatively and satisfactorily short.

As thus described, the issue loop is at this point communicatively closed and the process and structure of FIG. 15 is completed.

FIG. 16 depicts a magnified view of a portion 2899 of FIG. 15. In FIG. 16, a layout for the go/nogo lower row section of the scoreboard includes successive adjacent blocks “down” from top to bottom in FIG. 16. Each block extends laterally across the chip layout of FIG. 16.

In FIG. 16, the description proceeds block-by-block from top down. At top of FIG. 16, shift registers 1950.i has bits fed and coupled next down to next-state circuitry and muxes 1920, 1925, 1930.

Next further down in FIG. 16, a clock bay section buffers Go/No-Go bits to the read ports 1958, 1960, and also includes clock buffers (not shown) connected to the clock inputs “̂” of shift registers 1950.i.

Further next down in FIG. 16 AOI circuits 2910 in muxes 1958 mux the Go/No. Go bits from the shift registers 1950.i (plus a fifth bit “one”).

Next further down, a first 4:1 muxing stage 3030 in muxes 1960 is shuffled and provided as described in FIG. 14 inset.

Next, further adjacently down, is placed more circuitry 3032 for muxes 1958 which mux the Go/No-Go bits from the shift registers 1950.i.

Still next further, is located a second 4:1 muxing 3040 in muxes 1960 for read port muxing for four ports.

At the bottom extremity of the layout of FIG. 16 lies a block divided into three sub-blocks disposed generally perpendicular to the direction of successive adjacency of the FIG. 16 blocks described above. A first sub-block provides read port decode and corresponds to portions of circuitry 1985.xx, 1988.xx in FIG. 7B. A next laterally-adjacent, middle second sub-block provides final read port muxing and combinatorial logic pertaining to logic 1965, 1975 of FIG. 7B. On the bottom right side, a third sub-block provides further read port decode circuitry and corresponds to further portions of circuitry 1985.xx, 1988.xx in FIG. 7B.

### Testing and Verification

The skilled worker tests and verifies any particular implementation of the scoreboard in any appropriate manner. For example, the forwarding function is checked to determine that correct data is being forwarded from the correct sourcing pipestage to the correct consuming pipestage. The instruction issue stage is checked to determine that issuance occurs neither prematurely before the scoreboarding and any other conditions are resolved nor delayed unnecessarily after the scoreboarding any other conditions should have been resolved. Tests when running software with known characteristics can also be performed. These software tests are used to suitably verify that computed results are correct, that average number of issued instructions per clock cycle exceeds an expected level, that average power consumption in the circuitry does not exceed an expected level and other performance criteria are met.

### Other Types of Embodiments

Some embodiments only use the issue control portion of the scoreboarding function described herein. Other embodiments only use the forwarding control portion of the scoreboarding function described herein. Still other embodiments use both the issue control and forwarding control portions of the scoreboarding function described herein. Various optimizations for speed, scaling, critical path avoidance, and regularity of physical implementation are suitably provided as suggested by and according to the teachings herein.

The scoreboard(s) are suitably replicated for different types of pipelines in the same processor or repeated in different processors in the same system. For instance, in FIG. 2, any one, some or all of the RISC and DSP and other processors in the system are suitably improved with the advantageous scoreboard embodiments described herein. Suppose RISC processor 1105 is a first processor so improved. Then one or more additional microprocessors such as DSP 1110, and the RISC and/or DSP in block 1420, and the processor in WLAN 1500 are also suitably improved with the advantageous scoreboard embodiments. WLAN 1500 with AFE 1530, and Bluetooth block 1430 are examples of additional wireless interfaces coupled to the additional microprocessors. The additional microprocessor includes a scoreboard for issue control of a second candidate instruction, and the scoreboard includes shift register circuitry operable for entering a series of bits including first identical bits of a first logic state followed by second identical bits which have a logical complement state representing a pipestage EA of availability of data from a second producer instruction. Read multiplexer circuitry in the additional microprocessor selects an issue enablement bit from a bit position in the shift register corresponding to a pipestage EN of first need of the consumer operand of the second candidate instruction. Other improved scoreboard circuits as taught herein are also suitably used in a given additional microprocessor.

The scoreboarding described herein facilitates operations in RISC (reduced instruction set computing), CISC (complex instruction set computing), DSP (digital signal processors), microcontrollers, PC (personal computer) main microprocessors, math coprocessors, VLIW (very long instruction word), SIMD (single instruction multiple data) and MIMD (multiple instruction multiple data) processors and coprocessors as cores or standalone integrated circuits, and in other integrated circuits and arrays. The scoreboarding described herein is useful in interlocked and other pipelines to address data dependencies and analogous problems. The scoreboarding described herein is useful in execute pipelines, coprocessor execute pipelines, load-store pipelines, fetch pipelines, decode pipelines, in order pipelines, out of order pipelines, single issue pipelines, dual-issue and multiple issue pipelines, skewed pipelines, and other pipelines and is applied in a manner appropriate to the particular functions of each of such pipelines.

The scoreboard is useful in other types of pipelined integrated circuits such as ASICs (application specific integrated circuits) and gate arrays and to all circuits with a pipeline and other structures involving dependencies and analogous problems to which the advantages of the improvements described herein commend their use.

In addition to inventive structures, devices, apparatus and systems, processes are represented and described using any and all of the block diagrams, logic diagrams, and flow diagrams herein. Block diagram blocks are used to represent both structures as understood by those of ordinary skill in the art as well as process steps and portions of process flows. Similarly, logic elements in the diagrams represent both electronic structures and process steps and portions of process flows. Flow diagram symbols herein represent process steps and portions of process flows in software and hardware embodiments as well as portions of structure in various embodiments of the invention.

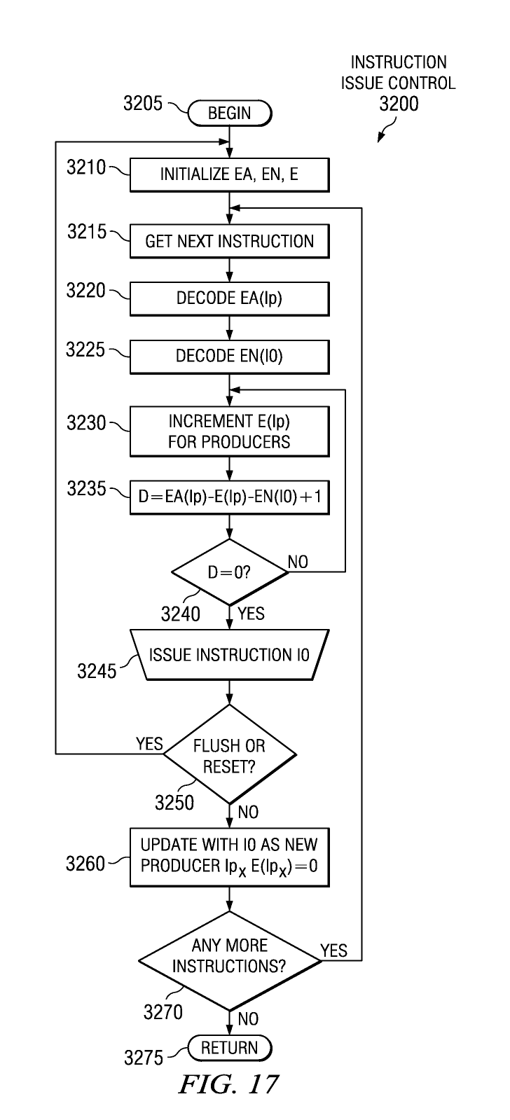

In FIG. 17, a flow diagram illustrates a form of instruction issue control 3200 according to some embodiments. The flow diagram shows a process in serially executed steps for comparing with and better understanding the operations of earlier FIGS. 6, 7A, 7B, 7C and other Figures. It is emphasized that some embodiments parallelize some of the operations and other embodiments do them all in serial order. In addition, FIG. 17 illustrates an embodiment for virtualizing or establishing in software form certain advantageous features of the hardware of FIGS. 6, 7A, 7B, 7C and other Figures.

In FIG. 17, a process, method, and operation commences with a BEGIN 3205. Next, a step 3210 for one or more candidate instructions initializes values EA and EN as defined earlier and described further below. Step 3210 further initializes the pipestage position variable E to zero to represent that a candidate instruction has not yet entered an execute pipeline. Then a step 3215 gets the next (in the beginning this is the first) candidate instruction.

A next step 3220 retrieves or obtains each decode value of Execute pipestage of first Availability EA of result data from a producer instruction Ip to destination DstA, DstB, etc. The decode to produce EA occurs when the producer instruction Ip was first issued as described in connection with step 3245 hereinbelow.

A succeeding step 3225 for each candidate instruction I0 initializes values of Execute pipestage of first Need EN of operand data for each source operand SrcA, SrcB, etc. of the candidate instruction I0. Then a step 3230 increments each pipestage position E(Ip) for each instruction in the pipeline.

A further step 3235 determines a delay D in clock cycles, if any, required before candidate instruction I0 can be issued as determined by operations based on Equation (1) earlier hereinabove:

D=EA(Ip)−E(Ip)−EN(I0)+1 (1)

Then a decision step 3240 determines whether delay D has reached zero. If not, operations loop back to step 3230 to increment the producer instructions in the pipeline, then recompute the delay in step 3235 and check for D reaching zero in decision step 3240 until the delay has reached zero. Steps 3235 and 3240 relate to the operations of the FIG. 7B shift registers 1956, muxes 1958 and FIG. 7C muxes 1960.

At this point operations proceed from decision step 3240 to a step 3245 to issue instruction I0 into the execute pipeline. The issue operation relates to the operations of circuitry 1965 in FIG. 7C and circuitry in FIG. 6 to supply IssueI0_OK for instance, and in FIG. 3 to issue an instruction into an execute pipeline 1640. Also upon issue in step 3245, the instruction I0 now becomes a new producer instruction Ip, and step 3245 decodes value EA and stores it for use in step 3220. This step 3245 decode EA relates to FIG. 7B and the store operation relates to FIG. 7A circuitry driving FIG. 7B circuitry.

After issue step 3245, a decision step 3250 checks for a pipeline flush or processor reset condition. If flush or reset, then operations loop back to initialization step 3210. Otherwise, operations instead proceed from decision step 3250 to a step 3260 to establish pipestage position information for the instruction I0 taking the role of a newly issued instruction Ipx, and initializing its pipestage position E(Ipx) to zero (0).

Another decision step 3270 then determines whether there are any more instructions in the issue queue, and if so operations loop back to step 3215 to get a next instruction (or more than one depending on embodiment) and continue Instruction Issue Control process 3200. If there are no more instructions to process, the operations reach a RETURN 3275.

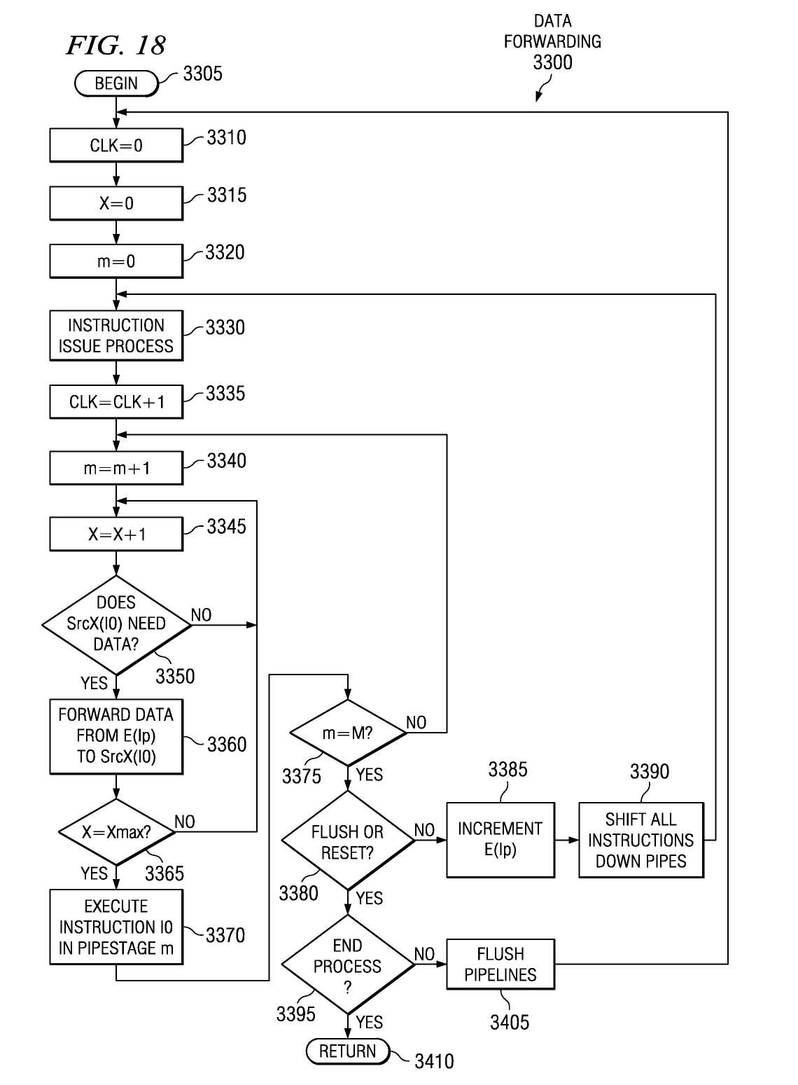

Turning to FIG. 18, a Data Forwarding process 3300 commences with a BEGIN 3305. Initialization operations set a CLK variable to zero (0) in a step 3310, set a source operand index X to zero (0) in a step 3315, and a pipestage index m to zero in a step 3320.

In FIG. 18, operations proceed from step 3320 to a step 3330 that performs an Instruction Issue Process. For example, the Instruction Issue Control process 3200 of FIG. 17 is suitably used to implement step 3330, or some other suitable Instruction Issue Process. Then a step 3335 increments the clock CLK by one cycle so that CLK=CLK+1. A further step 3340 increments the pipestage index m so that m=m+1. On the first time through the loop the pipestage index now refers to the first pipestage. A next step 3345 increments the source operand index X so that X=X+1. On the first time through, the source operand index X now refers to a first source operand of the instruction in the first pipestage m=1, for instance.

A decision step 3350 then determines whether or not source operand X of an instruction I0 in pipestage m needs data. This determination pertains to pipestage of first need EN for each source operand of the instruction as discussed elsewhere herein. If NO (not), operations loop back to step 3345 to increment the source operand index X, and then decision step 3350 looks at the next source operand of the same instruction. If a source operand needs data (YES) at step 3350, then a step 3360 proceeds to forward data from pipestage identified by E(Ip) from FIG. 17 so that the data goes to the current pipestage m to supply the needs of operand SrcX(I0).

Then a decision step 3365 determines whether all the source operands SrcX of the instruction in the pipestage m have been checked. If not, operations loop back to step 3345 and the next source operand is checked. Otherwise, operations go from step 3365 to a step 3370 to execute the instruction I0 in pipestage m. In other words, all the source operands are now provided with the data and the instruction executes.

It is emphasized that the flow diagram is generally illustrative of a variety of ways of establishing the flow and the specific order and interconnection of steps is suitably established by the skilled worker to accomplish the operations intended. For instance, step 3365 is suitably put directly after step 3345 and then step 3360 unconditionally goes back to step 3345.

Step 3370 is suitably arranged in some embodiments to pipeline some earlier fulfilled source operands down the pipeline until all the source operands are fulfilled and then finish execution of the instruction. It is noted that, in some software and hardware and mixed software/hardware embodiments, the steps 3360 data forwarding and 3370 execute instruction as well as other steps in FIG. 18 are suitably parallelized and performed for all the source operands and pipestages concurrently. FIGS. 3, 9A, 9B, 10, 11, 12A, 12B show an example of such parallelization. Other embodiments in hardware or software or mixed hardware and software do the steps serially as shown in FIG. 18, and issue steps serially as shown in FIG. 17. In addition various steps of instruction issue in FIG. 17 are parallelized with those of data forwarding in FIG. 18 as further shown by FIGS. 6, 7A, 7B, 7C along with the operations performed by the structures in FIGS. 3, 9A, 9B, 10, 11, 12A, 12B.

Operations go from step 3370 to a decision step 3375 to determine whether all pipestages have been serviced by the Data Forwarding process 3300. If not, operations loop back to step 3340 to increment the pipestage index m so that m=m+1 and then the instruction in the next pipestage of the pipeline is serviced by the process. When all pipestages have been serviced, operations proceed to a decision step 3380.

In decision 3380, the decision step 3380 checks for a pipeline flush or processor reset condition. If there is no flush or reset (NO), operations branch to a step 3385 to increment by one (1) the position value E(Ip) for each instruction Ip. Then a step 3390 shifts all instruction by one pipestage down the pipeline(s) in a hardware embodiment and otherwise the shift is already virtually completed by step 3385 or any further virtualization of the shift is completed in step 3390.

After step 3390, operations loop back to the step 3330 to execute the Instruction Issue Process therein so as to fill the otherwise-vacant first pipestage in the pipeline. Then the process of servicing all pipestages is repeated over and over.

If there is a flush or reset at decision step 3380, then operations proceed to a decision step 3395 that determines whether the process is to be ended. If the process is not to be ended, then operations go to a step 3405 to flush the pipeline(s) and loop back to step 3310 to reinitialize in steps 3310, 3315 and 3320 and start issuing instructions in step 3330 and service the pipestages of the pipeline anew. Otherwise, if step 3395 determines that the process ends, then operations go to a RETURN 3410.

A few preferred embodiments have been described in detail hereinabove. It is to be understood that the scope of the invention comprehends embodiments different from those described yet within the inventive scope. Microprocessor and microcomputer are synonymous herein. Processing circuitry comprehends digital, analog and mixed signal (digital/analog) integrated circuits, digital computer circuitry, ASIC circuits, PALs, PLAs, decoders, memories, non-software based processors, and other circuitry, and processing circuitry cores including microprocessors and microcomputers of any architecture, or combinations thereof. Internal and external couplings and connections can be ohmic, capacitive, direct or indirect via intervening circuits or otherwise as desirable. Implementation is contemplated in discrete components or fully integrated circuits in any materials family and combinations thereof. Various embodiments of the invention employ hardware, software or firmware. Process diagrams herein are representative of flow diagrams for operations of any embodiments whether of hardware, software, or firmware, and processes of manufacture thereof.

While this invention has been described with reference to illustrative embodiments, this description is not to be construed in a limiting sense. Various modifications and combinations of the illustrative embodiments, as well as other embodiments of the invention may be made. The terms “including”, “includes”, “having”, “has”, “with”, or variants thereof are used in either the detailed description and the claims to denote non-exhaustive inclusion in a manner similar to the term “comprising”. It is therefore contemplated that the appended claims and their equivalents cover any such embodiments, modifications, and embodiments as fall within the true scope of the invention.

What is claimed is:

1. A wireless communications unit comprising
a wireless antenna;
a wireless transmitter and receiver coupled to said wireless antenna;
a microprocessor coupled to at least one of the transmitter and receiver, the microprocessor having communications software including instructions, and the microprocessor further having execution pipestages and operable to execute a producer instruction Ip and issue a candidate instruction I0 having a source operand dependency on a destination operand of instruction Ip, wherein the instruction issue circuit is operable to issue the candidate instruction I0 as soon as when issuance will permit the instruction I0 to travel down the execution pipeline so that when the instruction I0 reaches an execution pipestage EN where an operand is needed, the producer instruction Ip will have reached a pipestage EA of first availability so that the operand will be available by data forwarding inside the pipeline itself; and
a user interface coupled to said microprocessor; whereby the wireless communication unit has increased instruction efficiency.

2. The wireless communications unit claimed in claim 44 wherein the instruction issue circuit is operable to issue or not issue the candidate instruction I0 as a function of a pipestage EN(I0) of first need by the candidate instruction for the source operand, a pipestage EA(Ip) of first availability of the destination operand from the producer instruction, and an execution pipestage E(Ip) currently associated with the producer instruction.

3. The wireless communications unit claimed in claim 44 wherein the microprocessor includes a scoreboard for issue control including
shift register circuitry operable for entering a series of bits including first identical bits of a first logic state followed by second identical bits which have a logical complement state representing a pipestage EA of availability of data from the producer instruction; and
read multiplexer circuitry operable to select an issue enablement bit from a bit position in the shift register corresponding to a pipestage EN of first need of the consumer operand of the candidate instruction.

4. The wireless communications unit claimed in claim 44 wherein the instruction issue circuit is operable to issue as many as a plurality of candidate instructions concurrently, whereby the instruction efficiency of the wireless communications unit is further increased.

5. The wireless communications unit claimed in claim 44 further comprising a second microprocessor and a camera interface, the second microprocessor including a second instruction issue circuit operable to issue or not issue a second candidate instruction as a function of a pipestage EN of first need by the second candidate instruction for the source operand, a pipestage EA of first availability of a destination operand from a second producer instruction, and an execution pipestage E currently associated with the second producer instruction.

6. The wireless communications unit claimed in claim 44 further comprising a second microprocessor and an additional wireless interface coupled to said second microprocessor, said second microprocessor including a scoreboard for issue control of a second candidate instruction including shift register circuitry operable for entering a series of bits including first identical bits of a first logic state followed by second identical bits which have a logical complement state representing a pipestage EA of availability of data from a second producer instruction, and read multiplexer circuitry operable to select an issue enablement bit from a bit position in the shift register corresponding to a pipestage EN of first need of the consumer operand of the second candidate instruction.

7. The wireless communications unit claimed in claim 44 wherein said microprocessor further includes security software including the candidate instruction issued into the pipeline.

8. The wireless communications unit of claim 44 further comprising user interfaces to provide functionality selected from the group consisting of 1) mobile phone handset, 2) personal digital assistant (PDA), 3) wireless local area network (WLAN) gateway, 4) personal computer (PC), 5) WLAN access point, 6) set top box, 7) internet appliance, 8) entertainment device, and 9) base station.

9. A method of instruction issue in a microprocessor with execution pipestages and that executes a producer instruction Ip and issues a candidate instruction I0 having a source operand dependency on a destination operand of instruction Ip, the method comprising issuing the candidate instruction I0 as a function of a pipestage EN(I0) of first need by the candidate instruction for the source operand, a pipestage EA(Ip) of first availability of the destination operand from the producer instruction, and an execution pipestage E(Ip) currently associated with the producer instruction.

10. The method of claim 52 wherein the function includes a function of the pipestage EA(Ip) of first availability less the one execution pipestage E(Ip) currently associated with the producer instruction less the pipestage EN(I0) of first need by the candidate instruction for the source operand.

11. The method of claim 52 further comprising enabling issuance depending on whether the function is less-than-or-equal to a threshold or not.

12. The method of claim 52 further comprising representing the function by a second function of the availability EA(Ip) less the pipestage E(Ip) and a third function based on the second function less the pipestage of first need EN(I0).

13. The method of claim 52 further comprising repeating the method every clock cycle to control instruction issuance based on the function.

14. The method of claim 52 wherein the issuing includes issuing the candidate instruction I0 as soon as when issuance will permit the instruction I0 to travel down the execution pipeline so that when the instruction I0 reaches the execution pipestage EN where an operand is needed, the producer instruction Ip will have reached the pipestage EA of first availability.

15. The method of claim 52 further comprising data forwarding the operand inside the pipeline itself when the operand is needed by instruction I0.

16. The method of claim 52 further comprising performing the function by entering a series of bits into a shift register, the series of bits including first identical bits of a first logic state followed by second identical bits which have a logical complement state representing a pipestage of availability EA(Ip) of data from the producer instruction.

17. The method of claim 59 further comprising selecting a bit from a bit position in the shift register corresponding to a pipestage of first need EN(I0) of the consumer operand of the candidate instruction.

18. The method of claim 60 wherein the bit selected represents issue disablement or not of the candidate instruction I0.

19. A wireless communications unit comprising
a wireless antenna;
a wireless transmitter and receiver coupled to said wireless antenna;
a microprocessor coupled to at least one of the transmitter and receiver, the microprocessor having communications software including instructions, and the microprocessor further including a pipeline having pipestages and operable to make data available in a said pipestage from executing a producer instruction, said pipeline further operable to execute a dependent instruction in a receiving pipestage, the dependent instruction being dependent on the data from the producer instruction, scoreboard circuitry having at least one register with register elements for holding information to represent a changing pipestage position for the producer instruction, and forwarding control circuitry coupled to said register to selectively forward the data available in the said pipestage to said receiving pipestage; and
a user interface coupled to said microprocessor; whereby the wireless communication unit has increased efficiency.

20. The wireless communications unit claimed in claim 123 wherein a plurality of pipestages of said pipeline have respective pipestage-related registers coupled to carry at least some of the bits from selected register elements of said scoreboard circuitry down said pipeline, one of the pipestage-related registers corresponding to said receiving pipestage, and said forwarding control circuitry has selector controls coupled to said pipestage-related register corresponding to said receiving pipestage.

21. The wireless communications unit of claim 123 wherein said receiving pipestage has control logic to enable said receiving pipestage to utilize data from said forwarding control circuitry.

22. The wireless communications unit of claim 123 further comprising a decoder circuit to decode a pipestage-of-need datum from the dependent instruction, wherein a plurality of pipestages of said pipeline have respective pipestage-related registers coupled to carry the pipestage-of-need datum down said pipeline, one of the pipestage-related registers corresponding to said receiving pipestage, and the receiving pipestage has control logic having an input active when the pipestage-of-need datum identifies said receiving pipestage and reaches the pipestage-related register corresponding to said receiving pipestage.

23. The wireless communications unit of claim 123 wherein said forwarding control circuitry includes data-wide inputs connected to the outputs of a plurality of pipestages, and said forwarding circuitry has outputs coupled to receiving pipestages pertaining to a plurality of consuming instructions.

24. The wireless communications unit of claim 123 wherein said scoreboard circuitry includes a plurality of registers and said scoreboard circuitry also includes write circuitry operable to enter information in parallel to selected ones of said registers about destination operands of at least one instruction.

25. The wireless communications unit of claim 123 further comprising a second pipeline having pipestages and operable to execute a second producer instruction, and wherein said forwarding control circuitry includes a first and a second data forwarding multiplexer coupled to a plurality of pipestages of said first-named pipeline and second pipeline respective to said multiplexers.

26. The wireless communications unit of claim 123 further comprising a second pipeline having pipestages and operable to execute a second producer instruction, wherein said forwarding control circuitry has inputs coupled to said first-named pipeline and said second pipeline, said register of said scoreboard circuitry including at least one pipeline type bit coupled to said forwarding control circuitry to identify which pipeline carries the producer instruction from which the dependent instruction consumes data.

27. The wireless communications unit of claim 123 wherein said pipestages include a first receiving pipestage and a second receiving pipestage that each execute respective consuming instructions, and said first receiving pipestage has a first pipestage-related register and said second receiving pipestage has a second pipestage-related register coupled to the first pipestage-related register to carry at least some of the scoreboard bits down said pipeline pertaining to respective producer instructions for the respective consuming instructions, and said forwarding control circuit has selector controls coupled to said first and second pipestage-related registers.

28. The wireless communications unit claimed in claim 123 further comprising an issue control circuit operable to issue the dependent instruction at a time prior to the forwarding of the data but sufficiently recently so that the data is actually available from the pipestage position pertaining to the producer instruction when the dependent instruction reaches said receiving pipestage.

29. The wireless communications unit claimed in claim 123 further comprising a second microprocessor and an application signal interface coupled to the second microprocessor, the second microprocessor having signal processing software including instructions, and an additional pipeline having additional pipestages and operable to make data available in a said additional pipestage from executing a signal processing producer instruction, said additional pipeline further operable to execute a signal processing dependent instruction in an additional receiving pipestage, the signal processing dependent instruction being dependent on the data from the signal processing producer instruction, second scoreboard circuitry having at least one second register with second register elements for holding information to represent a changing pipestage position for the signal processing producer instruction, and second forwarding control circuitry coupled to said second register to selectively forward the data available in said additional pipestage to said additional receiving pipestage.

30. The wireless communications unit claimed in claim 123 further comprising an additional wireless transmitter and receiver coupled to said microprocessor.

31. The wireless communications unit claimed in claim 123 wherein said microprocessor further includes security software including the producer instruction issued into said pipeline.

32. The wireless communications unit of claim 123 wherein the execution pipeline is selected from the group consisting of 1) reduced instruction set computing (RISC), 2) digital signal processing (DSP), 3) complex instruction set computing (CISC), 4) superscalar, 5) skewed pipelines, 6) in-order, 7) out-of-order, 8) very long instruction word (VLIW), 9) single instruction multiple data (SIMD), and 10) multiple instruction multiple data (MIMD).

33. The wireless communications unit of claim 123 further comprising user interfaces to provide functionality selected from the group consisting of 1) mobile phone handset, 2) personal digital assistant (PDA), 3) wireless local area network (WLAN) gateway, 4) personal computer (PC), 5) WLAN access point, 6) set top box, 7) internet appliance, 8) entertainment device, and 9) base station.
